(19) United States
(12) Patent Application Publication
(10) Pub. No.: US 2025/0153168 A1
(43) Pub. Date: May 15, 2025

(54) LIQUID HANDLING DEVICE

(71) Applicant: OSLER DIAGNOSTICS LIMITED, Oxford (GB)

(72) Inventors: Richard LUXTON, Oxford (GB); Barry LILLIS, Oxford (GB); Nuno REIS, Oxford (GB); Jimish PATEL, Oxford (GB); Mark HYLAND, Oxford (GB)

(21) Appl. No.: 18/723,310

(22) PCT Filed: Dec. 22, 2022
(86) PCT No.: PCT/EP2022/087659

§ 371 Date: Jun. 21, 2024

(30) Foreign Application Priority Data
Dec. 23, 2021 (GB) 2118919.6

(51) Int. Cl. B01L 3/00

(52) U.S. Cl. CPC B01L 3/502723; B01L 3/502738; B01L 2200/0684; B01L 2300/0809; B01L 2300/0861; B01L 2400/0694

(57) ABSTRACT

Embodiments described herein relate to a liquid handling device, comprising: a rigid layer comprising a first well and a second well; a vent arranged to provide a fluidic connection to an exterior of the liquid handling device, wherein the second well is in fluidic communication with the vent; and a plurality of grooves extending between the first well and the second well, wherein each of the plurality of grooves provides a fluidic connection between the first well and the second well.

### FIELD

The present disclosure relates to liquid handling devices, liquid handling systems and methods of moving liquids in liquid handling devices.

### BACKGROUND

Point-of-care diagnostic devices are typically used for carrying out diagnostic tests, such as immunoassays, on a biological sample (such as whole blood, blood serum or blood plasma). In order to carry out such diagnostic tests, the biological sample needs to be transferred to the diagnostic device. The diagnostic device is subsequently inserted into an analyser device (or instrument), which controls the movement of fluids (e.g. biological samples, reagents, buffer solutions, etc.) within the diagnostic device and conducts measurements of biomarkers, in order to conduct the diagnostic test.

Point-of-care detection brings a diagnostic test conveniently and immediately to a patient, allowing better and faster clinical decisions to be made. However, integration of diagnostic tests into a point-of-care device or system is challenging. Preparation of a sample for an immunoassay may require mixing of multiple solutions and reagents, with precise control of volumes and mixing times. Further, the device is ideally automated to obviate the need for a medical professional to be present.

Accordingly, there exists a need for improved liquid handling devices capable of performing liquid handling operations for use in point-of-care diagnostic tests.

### SUMMARY

This summary introduces concepts that are described in more detail in the detailed description. It should not be used to identify essential features of the claimed subject matter, nor to limit the scope of the claimed subject matter. The inclusion of multiple statements in the same paragraph of the summary does not imply that there is a structural or functional relationship between such statements.

According to a first aspect of the present disclosure, there is provided a liquid handling device, comprising: a first rigid layer and a second rigid layer; a fluidic layer disposed between the first rigid layer and the second rigid layer; wherein the fluidic layer is formed of an elastomer; and wherein the fluidic layer comprises a network of channels; and a fluidic network comprising a plurality of conduits, wherein the plurality of conduits are defined at least in part by the network of channels in the fluidic layer.

Using channels provided in an elastomeric layer provides improved sealing of the fluidic network, irrespective of the bonding process used to seal the network (e.g. pressure-sensitive adhesive (PSA) tape, laser welding, etc.). This is because the elastomer layer acts as a compliant layer when it is being sealed against another layer. In addition, providing channels in a compliant elastomeric layer allows the channels to be compressed in order to provide valves in the liquid handling device. Liquid flows in the liquid handling device can therefore be controlled by compressing the channels in the elastomeric layer, which closes valves of the liquid handling device. Using a single layer for the network of channels also simplifies the construction of the liquid handling device.

The liquid handling device may further comprise a plurality of valves. Each of the plurality of valves may be configured to close a corresponding one of the plurality of conduits. The valves allow liquid flow within the liquid handling device to be controlled.

Each of the plurality of valves may comprise a deformable valve region provided in the fluidic layer. Each deformable valve region may be deformable to a deformed state in which the corresponding one of the plurality of conduits is blocked. Providing deformable valve regions in the fluidic layer simplifies the construction of the liquid handling device, because the fluidic layer implements both the conduits of the device and the valves of the device.

The fluidic layer may comprise a first face configured to face the first rigid layer and a second face configured to face the second rigid layer. At least part of the network of channels may be provided in the second face. Each deformable valve region may comprise a depression in the first face of the fluidic layer. The depression may be aligned with a corresponding channel of the at least part of the network of channels provided in the second face. Providing depressions in the first face of the fluidic layer reduces the volume of material that needs to be deformed in order to close each valve of the liquid handling device. This reduces the force required to close each of the valves.

A subset of the network of channels may be provided in the first face. Providing channels in both faces of the fluidic layer means increases the available area for providing the channels with respective bonding areas around them, which is particularly important in view of the limited real estate available on the fluidic layer, resulting from the small size of point-of-care devices. Providing channels in the first face also allows the channels of the fluidic layer to cross over, meaning that more complex networks of channels may be implemented.

The first rigid layer may comprise a plurality of apertures. Each deformable valve region may be accessible through one of the plurality of apertures. Providing apertures in the rigid layer means that the liquid handling device has a rigid housing, while allowing the valves to be actuated by application of an external force (e.g. from an actuator of an analyser device).

The liquid handling device may further comprise a plurality of openings extending through at least part of the thickness of the fluidic layer. Each of the plurality of openings may be in fluidic communication with one of the plurality of conduits. The plurality of openings may comprise a first plurality of openings and a second plurality of openings. The second plurality of openings may be different to the first plurality of openings. The plurality of openings allows fluid (i.e. either liquid, or air supplied from a pneumatic supply system) in the fluidic layer to communicate with fluidic components in other layers.

The liquid handling device may further comprise a plurality of ports configured to provide a seal against a pneumatic interface. Each of the plurality of ports may comprise: a protrusion protruding from a surface of the fluidic layer; and a respective one of the first plurality of openings. The respective one of the first plurality of openings may extend through the protrusion. Implementing ports in an elastomeric fluidic layer allows the ports to form a seal with a pneumatic interface. This is because the fluidic layer acts as a compliant layer when a force is applied to the port by a pneumatic interface (e.g. a pneumatic actuator of a pneumatic supply system). Providing ports in the same fluidic layer as the network of channels also simplifies the construction of the liquid handling device. The fluidic communication between the ports and the conduits allows liquid to be moved within the conduits, by applying pneumatic pressures via the ports.

Each protrusion may have a frustoconical shape. The frustoconical shape of the protrusions helps formation of the seal between the port and a pneumatic interface. This is because the frustoconical shape results in a narrowing of the cross-section of the protrusion, with increasing height above the surface. Put another way, the frustoconical shape results in less material at the top of the protrusion than at the base of the protrusion, owing to the angled walls provided by the frustoconical shape. The reduced cross-section at the top of the protrusion means that less material is required to be deformed by a pneumatic interface, in order to provide a seal around the port. Deforming less material means that a lower amount of force needs to be applied to compress the port.

Each of the first plurality of openings may have a diameter that increases with increasing height above the surface of the fluidic layer. This further reduces the amount of material at the top of the protrusion, resulting in a lower force being required to deform the port.

Each protrusion may comprise an annular rim around an open end of the protrusion. The annular rim may define a region of minimum cross-sectional area of the protrusion. The annular rim provides a further reduction in the amount of material at the top of the protrusion, meaning that the force required to deform the protrusion is reduced.

One or more of the plurality of ports may further comprise: a plurality of support ribs. Each of the plurality of support ribs may extend between the protrusion and the surface of the fluidic layer from which the protrusion protrudes. The support ribs help to prevent excessive deformation of the ports when forces are applied to the ports by a pneumatic interface.

The first rigid layer may comprise a plurality of apertures. Each port may be accessible through one of the plurality of apertures. Providing apertures in the rigid layer means that the liquid handling device has a rigid housing, while allowing pneumatic pressure to be applied to the ports using an external pneumatic interface (e.g. a pneumatic actuator of an analyser device).

Each of the plurality of ports may be in fluidic communication with one of the plurality of conduits via a corresponding trough in the second rigid layer. The troughs prevent liquid from reaching the ports, which connect to pneumatic interfaces. Accordingly, the troughs prevent liquid from reaching the pneumatic interfaces, particularly during aspiration of liquid. Such liquid could potentially contaminate or damage the pneumatic interfaces (e.g. in an analyser device). In particular, any liquid drawn from the channels in the fluidic layer during aspiration pools in the bottom of the trough and does not reach the port. Therefore, any liquid drawn from the channels is not drawn into the pneumatic interface via the port.

The liquid handling device may further comprise at least one liquid storage capsule disposed over two of the second plurality of openings. Disposing a liquid storage capsule over the openings allows the fluidic network to interface with the liquid storage capsule. This also allows the capsule to be deformed into the openings, to create openings in the capsule.

The fluidic layer may comprise one or more chambers. Each of the one or more chambers is in fluidic communication with one of the plurality of conduits. Providing a chamber in the fluidic layer results in a simple construction of the liquid handling device. In particular, providing the one or more chambers in the fluidic layer extends the functionality of the fluidic layer.

The fluidic layer may comprise a projection extending from a face of the fluidic layer. The projection may comprise a plurality of cavities. Each of the one or more chambers may be defined at least in part by a corresponding one of the plurality of cavities. Providing a projection that extends from a face of the fluidic layer means that the volume of the chamber is not limited by the thickness of the fluidic layer. An increased chamber capacity can therefore be provided.

The liquid handling device may further comprise a sealing film. The plurality of conduits may be defined by the network of channels in the fluidic layer and the sealing film. The compliance of the elastomeric fluidic layer helps the channels to be sealed by the sealing film.

Each channel comprises a groove provided in a surface. Each channel therefore has an open cross-section. In other words, the cross-section of each channel is not sealed. Each conduit comprises: (i) a channel that is sealed (e.g. by a sealing layer), thereby providing a closed cross-section; or (ii) a hole or tunnel extending at least partially through a body.

According to a second aspect of the present disclosure, there is provided a liquid handling device, comprising: a first rigid layer and a second rigid layer; a fluidic network comprising a plurality of conduits; and a fluidic layer disposed between the first rigid layer and the second rigid layer, wherein the fluidic layer is formed of an elastomer, and wherein the fluidic layer comprises a plurality of ports configured to provide a seal against a pneumatic interface, wherein each of the plurality of ports comprises: a protrusion extending from a surface of the fluidic layer; and an opening extending through the protrusion and at least part of the thickness of the fluidic layer, wherein the opening is in fluidic communication with one or more of the plurality of conduits.

Each protrusion may have a frustoconical shape. The frustoconical shape of the protrusions helps formation of the seal between the port and a pneumatic interface. This is because the frustoconical shape results in a narrowing of the cross-section of the protrusion, with increasing height above the surface. Put another way, the frustoconical shape results in less material at the top of the protrusion than at the base of the protrusion, owing to the angled walls provided by the frustoconical shape. The reduced cross-section at the top of the protrusion means that less material is required to be deformed by a pneumatic interface, in order to provide a seal around the port. Deforming less material means that a lower amount of force needs to be applied to compress the port.

Each of the first plurality of openings may have a diameter that increases with increasing height above the surface of the fluidic layer. This further reduces the amount of material at the top of the protrusion, resulting in a lower force being required to deform the port.

Each protrusion may comprise an annular rim around an open end of the protrusion. The annular rim may define a region of minimum cross-sectional area of the protrusion. The annular rim provides a further reduction in the amount of material at the top of the protrusion, meaning that the force required to deform the protrusion is reduced.

One or more of the plurality of ports may further comprise: a plurality of support ribs. Each of the plurality of support ribs may extend between the protrusion and the surface of the fluidic layer from which the protrusion protrudes. The support ribs help to prevent excessive deformation of the ports when forces are applied to the ports by a pneumatic interface.

The first rigid layer may comprise a plurality of apertures. Each port may be accessible through one of the plurality of apertures. Providing apertures in the rigid layer means that the liquid handling device has a rigid housing, while allowing pneumatic pressure to be applied to the ports using an external pneumatic interface (e.g. a pneumatic actuator of an analyser device).

Each of the plurality of ports may be in fluidic communication with one of the plurality of conduits via a corresponding trough in the second rigid layer. The troughs prevent liquid from reaching the ports, which connect to pneumatic interfaces. Accordingly, the troughs prevent liquid from reaching the pneumatic interfaces, particularly during aspiration of liquid. Such liquid could potentially contaminate or damage the pneumatic interfaces (e.g. in an analyser device). In particular, any liquid drawn from the channels in the fluidic layer during aspiration pools in the bottom of the trough and does not reach the port. Therefore, any liquid drawn from the channels is not drawn into the pneumatic interface via the port.

The second rigid layer may comprise a plurality of supports. Each of the plurality of supports may be aligned with a corresponding one of the plurality of ports, such that each of the plurality of supports prevents deformation of the surface of the fluidic layer when a force is applied to the corresponding one of the plurality of ports. This helps the ports to form a seal with a pneumatic interface.

The fluidic layer may comprise a network of channels. Each of the plurality of conduits may be defined at least in part by the network of channels in the fluidic layer. Using channels provided in an elastomeric layer provides improved sealing of the fluidic network, irrespective of the bonding process used to seal the network (e.g. pressure-sensitive adhesive (PSA) tape, laser welding, etc.).

This is because the elastomer layer acts as a compliant layer when it is being sealed against another layer. In addition, providing channels in a compliant elastomeric layer allows the channels to be compressed in order to provide valves in the liquid handling device. Liquid flows in the liquid handling device can therefore be controlled by compressing the channels in the elastomeric layer, which closes valves of the liquid handling device. Using a single layer for the network of channels and the ports also simplifies the construction of the liquid handling device.

The fluidic layer of the liquid handling device according to the first aspect or the second aspect may be formed of a thermoplastic elastomer, wherein the thermoplastic elastomer is optionally a silicon-based thermoplastic elastomer or styrene-ethylene-butylene-styrene. Such materials should be selected (e.g, by selecting an appropriate grade) to have sufficient hardness to prevent excessive deformation of the fluidic layer, and sufficient relaxation time to allow the components of the fluidic layer (i.e. ports, channels) to return to their original form when an applied force is removed.

According to a third aspect of the present disclosure, there is provided a liquid handling device, comprising: a rigid layer; and a plurality of liquid storage capsules disposed within the liquid handling device; wherein the rigid layer comprises an actuatable portion that is actuatable from a first position, in which the actuatable portion does not deform the plurality of liquid storage capsules, to a second position, in which the actuatable portion deforms two or more of the plurality of liquid storage capsules.

Given that a single actuatable portion is capable of deforming two or more of the plurality of liquid storage capsules, actuation of the actuatable portion to the second position causes simultaneous deformation of each of the two or more capsules. Consequently, multiple capsules within the liquid handling device can be punctured using a single movement of the actuatable portion. Using a single actuatable portion to deform two or more liquid storage capsules also means that a number of different configurations of liquid storage capsules can be punctured by the actuatable portion. Accordingly, the rigid layer and actuatable portion can be used with fluidic networks that implement various configurations of liquid storage capsules.

The actuatable portion may comprise a plurality of protrusions. Each of the plurality of protrusions may extend towards one of the plurality of liquid storage capsules. Each of the plurality of protrusions may be configured to apply a force to a corresponding portion of the liquid storage capsule when the actuatable portion is in the second position. The protrusions provide a mechanism for deforming the liquid storage capsule in order to puncture the liquid storage capsule.

The plurality of protrusions may be configured to engage two different portions of each of the two or more of the plurality of liquid storage capsules when the actuatable portion is in the second position. This means that two different portions of a capsule can be deformed simultaneously, meaning that two openings (e.g. an inlet and an outlet) can be created in the liquid storage capsule simultaneously.

The actuatable portion may comprise a plurality of concave regions. Each of the plurality of concave regions may be located between two of the plurality of protrusions. Each concave region can be configured to accommodate a main chamber of a corresponding liquid storage capsule when the actuatable portion is in the second position. This means that the main chamber is not deformed by the actuatable portion when the actuatable portion is in the second position. The concave regions therefore maximise the capacity of the liquid storage capsule that may be provided.

The plurality of protrusions may be a first plurality of protrusions. The actuatable portion may further comprise a second plurality of protrusions. Each of the first plurality of protrusions may extend further from the actuatable portion than each of the second plurality of protrusions. Each of the second plurality of protrusions may extend towards one of the plurality of liquid storage capsules. Each of the second plurality of protrusions may be configured to apply a force to a corresponding portion of the liquid storage capsule when the actuatable portion is in a third position. The third position may be beyond the second position. This allows for puncture of the liquid storage capsules in two stages, meaning that liquid can be released from some capsules before other capsules are punctured.

The rigid layer may comprise one or more resiliently deformable members coupled to the actuatable portion. The one or more resiliently deformable members may be configured to bias the actuatable portion away from the second position. This means that the resiliently deformable members bring the actuatable portion away from engagement with the capsules, thereby allowing the actuatable portion to return towards its original position and preventing the actuatable portion from interfering with fluid flow into or out of the capsules.

Each of the one or more resiliently deformable members may be formed of the same material as the rigid layer. This allows the manufacture of the rigid part, including the actuatable portion and the resiliently deformable members, to be simplified (e.g. produced by injection moulding).

The rigid layer may comprise two or more resiliently deformable members. Providing a plurality of resiliently deformable members allows the actuatable portion to be actuated in a vertical direction, meaning that the actuatable portion is parallel to a base (i.e. a sealing layer) of each liquid storage capsule when the actuatable portion is in the first portion and when the actuatable portion is in the second position. Vertical movement of the actuatable portion allows a consistent force to be applied to the liquid storage capsules (e.g. via protrusions of the actuatable portion). A first one of the two or more resiliently deformable members may be connected to a first edge of the actuatable portion and a second one or the two or more resiliently deformable members may be connected to a second edge of the actuatable portion, wherein the second edge is different to the first edge. The second edge may be opposite the first edge.

The actuatable portion may comprise a plurality of flat regions provided on an exterior surface of the actuatable portion. The flat surface of the actuatable portion allows the actuatable portion to be easily moved from the first position to the second position (e.g. by an actuator of an analyser device), without requiring a particular shape of actuator to move the actuatable portion.

The liquid handling device may further comprise a fluidic layer comprising a plurality of openings extending through at least part of the thickness of the fluidic layer. Each of the plurality of liquid storage capsules may be positioned over a corresponding one of the plurality of openings. For each of the plurality of liquid storage capsules, the deformation of the liquid storage capsule by the actuatable portion may deform a portion of the liquid storage capsule into the corresponding one of the plurality of openings. Disposing a liquid storage capsule over the openings allows capsule to be deformed into the openings by the actuatable portion, in order to create openings in the capsule.

The rigid layer may be a first rigid layer. The fluidic layer may be disposed between the first rigid layer and a second rigid layer. The second rigid layer may comprise a plurality of capsule support regions arranged to contact the fluidic layer during actuation of the actuatable portion. Each of the plurality of capsule support regions may be aligned with a corresponding one of the plurality of openings. This means that, when a force is applied to the plurality of capsules by the actuatable portion, the fluidic layer is prevented from being deformed by the corresponding capsule support region.

The actuatable portion may be actuatable relative to a face of the rigid layer. The actuatable portion may be rigid. The actuatable portion may be actuatable in a direction normal to the face of the rigid layer. The actuatable portion may be parallel to a base of one or more of the plurality of liquid storage capsules when the actuatable portion is in the first position, and may be parallel to the base of the one or more of the plurality of liquid storage capsules when the actuatable portion is in the second position.

According to a fourth aspect of the present disclosure, there is provided a liquid handling system, comprising: a liquid handling device according to the third aspect of the present disclosure; an actuator configured to actuate the actuatable portion of the liquid handling device from the first position to the second position, thereby deforming the two or more liquid storage capsules; and a pneumatic supply system configured to supply a pneumatic pressure to at least one of the two or more liquid storage capsules. This means that a single liquid handling system can be used to both puncture the liquid storage capsules and to displace liquid from the liquid storage capsules.

According to a fifth aspect of the present disclosure, there is provided a liquid handling device, comprising: a fluidic layer comprising a network of channels; a sealing layer arranged to seal the network of channels to form a plurality of conduits, wherein the sealing layer comprises an aperture; and a measurement chamber in fluidic communication with at least one of the plurality of conduits, wherein the measurement chamber is defined in part by the aperture in the sealing layer.

Implementing a sealing layer that both seals a network of channels and has apertures that define, in part, a measurement chamber reduces the tendency for liquid to remain in the measurement chamber. This is because there is no constriction between the channels in the fluidic layer and the measurement chamber. The construction of the liquid handling device is also simplified, because the layer used to seal the network of channels is also utilised to provide a measurement chamber.

The sealing layer may be arranged to cover the fluidic layer. Covering the fluidic layer increases the bonding area surrounding the network of channels. The sealing layer may directly contact the fluidic layer.

The thickness of the sealing layer may define a height of the measurement chamber. This allows the volume of the measurement chamber to be defined by the sealing layer and the layers either side of the sealing layer.

The measurement chamber may comprise a first end and a second end opposite to the first end. A first one of the plurality of conduits may be in fluidic communication with the first end of the measurement chamber. A second one of the plurality of conduits may be in fluidic communication with the second end of the measurement chamber. This allows liquid to be transported through the measurement chamber (e.g. to a waste chamber).

The measurement chamber may comprise a first tapering portion extending between the first end and a central portion of the measurement chamber. The measurement chamber may further comprise a second tapering portion extending between the central portion and the second end. In the first tapering portion, the angle between a wall of the measurement chamber and a longitudinal centreline running through the measurement chamber may be less than 30 degrees. Likewise, in the second tapering portion, the angle between a wall of the measurement chamber and a longitudinal centreline running through the measurement chamber may be less than 30 degrees. A taper angle of less than 30 degrees reduces the tendency for air bubbles to form during filling or emptying of the measurement chamber. A taper angle of less than 30 degrees also reduces the tendency for residual liquid to remain in the measurement chamber after emptying of the measurement chamber.

In the first tapering portion, the angle between the wall of the measurement chamber and the longitudinal centreline may be between about 15 degrees and about 25 degrees. Likewise, in the second tapering portion, the angle between the wall of the measurement chamber and the longitudinal centreline may be between about 15 and about 25 degrees. A taper angle in this region reduces the tendency for air bubbles to form during filling or emptying, and the tendency for residual liquid to remain after emptying, while still providing a useful contact area between the interior of the measurement chamber and a sensor surface in fluidic communication with the interior of the measurement chamber.

The second one of the plurality of conduits may be aligned with a longitudinal centreline running through the measurement chamber. Aligning the second one of the plurality of conduits with the longitudinal centreline minimises the volume of liquid remaining in the measurement chamber following emptying of the measurement chamber, while also reducing the loss of particles in flow suspensions (e.g. blood or functionalised beads) that flow through the measurement chamber.

An angle between the second one of the plurality of conduits and the longitudinal centreline may be greater than or equal to 150 degrees, and more preferably about 180 degrees. An angle of greater than or equal to 150 degrees minimises the volume of liquid remaining in the measurement chamber following emptying of the measurement chamber. An angle of 180 degrees provides a low volume of liquid remaining in the measurement chamber following emptying of the measurement chamber, while also reducing the loss of particles in flow suspensions (e.g. blood or functionalised beads) that flow through the measurement chamber.

The liquid handling device may comprise a plurality of measurement chambers. The sealing layer may comprise a plurality of apertures. Each of the plurality of measurement chambers may be defined in part by a corresponding one of the plurality of apertures in the sealing layer.

According to a sixth aspect of the present disclosure, there is provided liquid handling device, comprising: a fluidic layer comprising a network of channels; a sealing layer arranged to seal the network of channels to form a plurality of conduits, wherein the sealing layer comprises a plurality of holes; a flow cell layer comprising an aperture, wherein the sealing layer is disposed between the fluidic layer and the flow cell layer; and a measurement chamber in fluidic communication with at least one of the plurality of conduits via one of the plurality of holes, wherein the measurement chamber is defined in part by the aperture in the flow cell layer.

Each of the plurality of holes may be aligned with one end of a respective one of the network of channels. This means that the holes provide a fluidic connection between the channels in the fluidic layer and the measurement chamber defined in part by the aperture in the flow cell layer.

The thickness of the flow cell layer may define a height of the measurement chamber. This allows the volume of the measurement chamber to be defined by the flow cell layer and the layers either side of the sealing layer.

The measurement chamber may comprise a first end and a second end opposite to the first end. A first one of the plurality of conduits may be in fluidic communication with the first end of the measurement chamber via a first one of the plurality of holes. A second one of the plurality of conduits may be in fluidic communication with the second end of the measurement chamber via a second one of the plurality of holes. This allows liquid to be transported through the measurement chamber (e.g. to a waste chamber).

The measurement chamber may comprise a first tapering portion extending between the first end and a central portion of the measurement chamber. The measurement chamber may further comprise a second tapering portion extending between the central portion and the second end. In the first tapering portion, the angle between a wall of the measurement chamber and a longitudinal centreline running through the measurement chamber may be less than 30 degrees. Likewise, in the second tapering portion, the angle between a wall of the measurement chamber and a longitudinal centreline running through the measurement chamber may be less than 30 degrees. A taper angle of less than 30 degrees reduces the tendency for air bubbles to form during filling or emptying of the measurement chamber. A taper angle of less than 30 degrees also reduces the tendency for residual liquid to remain in the measurement chamber after emptying of the measurement chamber.

In the first tapering portion, the angle between the wall of the measurement chamber and the longitudinal centreline may be between about 15 degrees and about 25 degrees. Likewise, in the second tapering portion, the angle between the wall of the measurement chamber and the longitudinal centreline may be between about 15 and about 25 degrees. A taper angle in this region reduces the tendency for air bubbles to form during filling or emptying, and the tendency for residual liquid to remain after emptying, while still providing a useful contact area between the interior of the measurement chamber and a sensor surface in fluidic communication with the interior of the measurement chamber.

The second one of the plurality of conduits may be aligned with a longitudinal centreline running through the measurement chamber. Aligning the second one of the plurality of conduits with the longitudinal centreline minimises the volume of liquid remaining in the measurement chamber following emptying of the measurement chamber, while also reducing the loss of particles in flow suspensions (e.g. blood or functionalised beads) that flow through the measurement chamber.

An angle between the second one of the plurality of conduits and the longitudinal centreline may be greater than or equal to 150 degrees. An angle of greater than or equal to 150 degrees minimises the volume of liquid remaining in the measurement chamber following emptying of the measurement chamber. The angle between the second one of the plurality of conduits and the longitudinal centreline may be about 180 degrees. An angle of 180 degrees provides a low volume of liquid remaining in the measurement chamber following emptying of the measurement chamber, while also reducing the loss of particles in flow suspensions (e.g. blood or functionalised beads) that flow through the measurement chamber.

The first end may be a first rounded end with a first constant curvature. The second end may be a second rounded end with a second constant curvature. A radius of the first one of the plurality of holes may be equal to a radius of the first constant curvature. A radius of the second one of the plurality of holes may be equal to a radius of the second constant curvature. Matching the radius of the holes to the radius of the curvatures minimises the combined volume of liquid remaining in the measurement chamber and the holes following emptying of the measurement chamber. Matching the radius of the holes to the radius of the curvatures also increases the tolerance to any misalignments during assembly of the layers of the liquid handling device.

An origin of the first one of the plurality of holes may be coincident with an origin of the first constant curvature. An origin of the second one of the plurality of holes may be coincident with an origin of the second constant curvature. Aligning the origins of the holes and the curvatures minimises the combined volume of liquid remaining in the measurement chamber and the holes following emptying of the measurement chamber.

The liquid handling device may comprise a plurality of measurement chambers. The flow cell layer may comprise a plurality of apertures. Each of the plurality of measurement chambers may be defined in part by a corresponding one of the plurality of apertures in the flow cell layer.

According to a seventh aspect of the present disclosure, there is provided a liquid handling device, comprising: a rigid layer comprising a first well and a second well; a vent arranged to provide a fluidic connection to an exterior of the liquid handling device, wherein the second well is in fluidic communication with the vent; and a plurality of grooves extending between the first well and the second well, wherein each of the plurality of grooves provides a fluidic connection between the first well and the second well.

By providing more than one path for liquid flow between the first well and the second well, the likelihood of a liquid blockage between the first well and the second well is reduced. Avoiding liquid blockage between the first well and the second well allows the first and second wells to be used as part of a fluidic circuit for aspiration of a liquid. This is because air can be drawn in from the permanent vent to the first well via the second well, during aspiration of a liquid from a fluidic component that is in fluidic communication with the first well.

One or more of the plurality of grooves may be disposed above a base of the first well. The depth of the first well may be greater than the maximum depth of the one or more of the plurality of grooves. This means that liquid is required to flow over a step between the base of the first well and the base of the one or more grooves, which discourages liquid flow into the one or more grooves.

The one or more of the plurality of grooves may be disposed above a base of the second well. The depth of the second well may be greater than the maximum depth of the one or more of the plurality of grooves. This means that any liquid in the second well would be required to flow over a step between the base of the second well and the base of the one or more grooves, which discourages liquid flow into the one or more grooves.

One or more of the plurality of grooves may comprises: a first end adjacent to the first well; and a second end adjacent to the second well. The second end may be disposed above the first end. The depth of the first end may be greater than the depth of the second end. The one or more of the plurality of grooves may comprise an angled base extending between the first end and the second end. The effect of the angled base means that even if liquid flows into the one or more grooves, the pressure required to clear liquid from the one or more grooves is reduced. This is because the angled base of the one or more grooves causes liquid to flow towards the first well under gravity. In other words, the grooves are easier to empty when a negative pressure is applied to the first well. The angled shape also acts as a capillary stop and helps prevent liquid progressing to the second well.

The liquid handling device may further comprise: a third well in fluidic communication with the second well and the vent. The second well may be in fluidic communication with the vent via the third well. The liquid handling device may further comprise a connector channel extending between the second well and the third well. The third well and connector channel provide further fluidic components between the second well and the vent, which provide additional resistance to liquid flow between the second well and the vent. This reduces the likelihood of liquid escaping from within the liquid handling device through the vent.

The connector channel may be disposed above a base of the second well. The depth of the second well may be greater than the depth of the connector channel. The connector channel may comprise a plurality of grooves extending between the second well and the third well. Providing the connector channel above the base of the second well means that any liquid in the second well would be required to flow over a step between the base of the second well and the base of the connector channel, which discourages liquid flow into the connector channel. Providing the connector channel in the form of a plurality of grooves provides multiple fluid flow paths between the second well and the third well, which reduces the likelihood of a liquid blockage between the second well and the third well.

The liquid handling device may further comprise a vent channel extending from the third well. The third well may be in fluidic communication with the vent via the vent channel. The vent channel may comprise: a first end in fluidic communication with the third well; and a second end in fluidic communication with the vent. The vent may comprise a hole in the rigid layer. The vent channel may extend from the third well in a first direction. The hole may extend in a second direction through the rigid layer to an exterior surface of the rigid layer, wherein the second direction is different to the first direction. The second direction may be perpendicular to the first direction.

The liquid handling device may further comprise a vent channel extending between the third well and the vent. The vent channel may comprise: a first end in fluidic communication with the third well; and a second end in fluidic communication with the vent. The vent may comprise a hole in the rigid layer at the second end of the vent channel.

The plurality of grooves may be a first plurality of grooves. The liquid handling device may further comprise: a fourth well in fluidic communication with the first well; and a second plurality of grooves extending between the fourth well and the first well. Each of the second plurality of grooves may provide a fluidic connection between the fourth well and the first well. The connector channel may be a first connector channel. The liquid handling device may further comprise: a second connector channel extending between the fourth well and the third well. The second connector channel provides an alternative flow path between the first well and the vent. If there is a blockage within the first well, then air can still be drawn in through the vent via whichever flow path is not blocked. Likewise, the second connector channel provides an alternative flow path in the event that each of the first plurality of grooves is blocked. The second plurality of grooves provides more than one path for liquid flow between the first well and the fourth well, which reduces the likelihood of a liquid blockage between the first well and the fourth well.

According to an eighth aspect of the present disclosure, there is provided a liquid handling device, comprising: a fluidic network comprising a plurality of conduits and a chamber; and a plurality of pneumatic ports, wherein: a first one of the plurality of pneumatic ports is in fluidic communication with the chamber; and a second one of the plurality of pneumatic ports in fluidic communication with a conduit of the plurality of conduits, wherein the conduit is in fluidic communication with the chamber; wherein the second one of the plurality of pneumatic ports is configured to receive a positive pneumatic pressure or a negative pneumatic pressure while the first one of the plurality of pneumatic ports is vented.

By using multiple pneumatic ports, the need for permanent vents in the liquid handling device is reduced. Accordingly, the potential for liquids to escape from the liquid handling device is reduced.

The first one of the plurality of pneumatic ports may be further configured to receive a positive pneumatic pressure or a negative pneumatic pressure while the second one of the plurality of pneumatic ports is vented. This increases the range of fluidic operations that can be carried out using the liquid handling device.

Each of the first one of the plurality of pneumatic ports and the second one of the plurality of pneumatic ports may be configured to selectively: receive a positive pneumatic pressure or a negative pneumatic pressure; and be connected to a vent. This further increases the range of fluidic operations that can be carried out using the liquid handling device.

The liquid handling device may further comprise a fluidic layer disposed between a first rigid layer and a second rigid layer, wherein, in use, the second rigid layer is disposed beneath the fluidic layer. The fluidic layer may comprise a network of channels. The plurality of conduits may be defined at least in part by the network of channels in the fluidic layer. The fluidic layer may comprise the plurality of pneumatic ports. Providing ports and channels in the same fluidic layer simplifies the construction of the liquid handling device.

The second rigid layer may comprise a plurality of troughs. Each of the plurality of pneumatic ports may be in fluidic communication with the fluidic network via one of the plurality of troughs in the second rigid layer. The troughs prevent liquid from reaching the pneumatic ports, which connect to pneumatic interfaces. Accordingly, the troughs prevent liquid from reaching the pneumatic interfaces, particularly during aspiration of liquid. Such liquid could potentially contaminate or damage the pneumatic interfaces (e.g. in an analyser device). In particular, any liquid drawn from the channels in the fluidic layer during aspiration pools in the bottom of the trough and does not reach the pneumatic port. Therefore, any liquid drawn from the channels is not drawn into the pneumatic interface via the pneumatic port.

The chamber may be a waste chamber. Accordingly, the venting state of the waste chamber can be controlled. The second rigid layer may comprise the waste chamber. The liquid handling device therefore allows fluidic operations in different layers of the liquid handling device to be controlled.

The fluidic network may further comprise a measurement chamber in fluidic communication with the conduit. The waste chamber may be configured to receive waste liquid from the measurement chamber. The venting state of the measurement chamber can therefore be controlled.

The chamber may be a first mixing chamber. The venting state of the first mixing chamber can therefore be controlled.

The fluidic layer may comprise a projection extending from a face of the fluidic layer. The projection may comprise a cavity. The first mixing chamber may be defined at least in part by the cavity in the projection. Providing a projection that extends from a face of the fluidic layer means that the volume of the first mixing chamber is not limited by the thickness of the fluidic layer.

The fluidic network may further comprise a second mixing chamber in fluidic communication with the conduit and the first mixing chamber. Providing a second mixing chamber means that solutions can be mixed by transferring the solution back and forth between the two mixing chambers.

A third one of the plurality of pneumatic ports may be in fluidic communication with the fluidic network. The third one of the plurality of pneumatic ports may be configured to selectively: receive a positive pneumatic pressure or a negative pneumatic pressure; and be connected to a vent. Providing a third pneumatic port further increases the complexity of the fluidic network that may be implemented.

The liquid handling device may further comprise a liquid storage capsule. The liquid handling device may be configured to transfer a positive pneumatic pressure from one of the plurality of pneumatic ports to the liquid storage capsule once the liquid storage capsule has been opened.

The liquid handling device according to the first, second, third, fifth, sixth, seventh or eighth aspect of the present disclosure may be a diagnostic cartridge. The diagnostic cartridge may be a microfluidic cartridge.

According to a ninth aspect of the present disclosure, there is provided a liquid handling system, comprising: a liquid handling device according to the eighth aspect of the present disclosure; and a pneumatic pressure supply system, comprising: a variable pressure source; a first pneumatic supply conduit configured to: connect the first one of the plurality of pneumatic ports of the liquid handling device to a vent in the pneumatic pressure supply system; and a second pneumatic supply conduit configured to: supply a positive pressure or a negative pressure from the variable pressure source to the second one of the plurality of pneumatic ports of the liquid handling device while the first pneumatic supply conduit connects the first one of the plurality of pneumatic ports to the vent.

The second pneumatic supply conduit may be further configured to connect the second one of the plurality of pneumatic ports to the vent. The first pneumatic supply conduit may be further configured to supply a positive pressure or a negative pressure from the variable pressure source to the first one of the plurality of pneumatic ports while the second pneumatic supply conduit connects the second one of the plurality of pneumatic ports to the vent. This increases the range of fluidic operations that can be carried out using the liquid handling device.

Each of the first pneumatic supply conduit and the second pneumatic supply conduit may be configured to selectively: supply a positive or negative pressure from the variable pressure source to its respective pneumatic port; and connect its respective pneumatic port to the vent. This further increases the range of fluidic operations that can be carried out using the liquid handling device.

The chamber of the liquid handling device may be a waste chamber. The pneumatic supply system may be configured to: supply a positive pressure from the variable pressure source to the second one of the plurality of pneumatic ports while connecting the first one of the plurality of pneumatic ports to the vent, to dispense liquid from the conduit to the waste chamber. Accordingly, the venting state of the waste chamber can be controlled.

The fluidic network of the liquid handling device may further comprise a measurement chamber in fluidic communication with the conduit. The waste chamber of the liquid handling device may be configured to receive waste liquid from the measurement chamber. The pneumatic supply system may be configured to: supply a positive pressure from the variable pressure source to the second one of the plurality of pneumatic ports while connecting the first one of the plurality of pneumatic ports to the vent, to dispense liquid from the measurement chamber to the waste chamber. The venting state of the measurement chamber can therefore be controlled.

The liquid handling device may comprise a vented sample inlet chamber in fluidic communication with the fluidic network. The pneumatic supply system may be configured to: supply a negative pressure from the variable pressure source to one of the plurality of pneumatic ports, to aspirate liquid from the sample inlet chamber to the fluidic network.

The chamber of the liquid handling device may be a first mixing chamber. The pneumatic supply system may be configured to: supply a positive pressure from the variable pressure source to the second one of the plurality of pneumatic ports while connecting the first one of the plurality of pneumatic ports to the vent, to dispense liquid into the first mixing chamber. The venting state of the first mixing chamber can therefore be controlled.

The fluidic network of the liquid handling device may further comprise a second mixing chamber in fluidic communication with the conduit and the first mixing chamber. The pneumatic supply system may be configured to: supply a positive pressure from the variable pressure source to the second one of the plurality of pneumatic ports while connecting the first one of the plurality of pneumatic ports to the vent, to dispense liquid from the second mixing chamber to the first mixing chamber; and/or supply a negative pressure from the variable pressure source to the second one of the plurality of pneumatic ports while connecting the first one of the plurality of pneumatic ports to the vent, to aspirate liquid from the first mixing chamber to the second mixing chamber. Accordingly, solutions can be mixed by transferring the solution back and forth between the two mixing chambers.

A third one of the plurality of pneumatic ports of the liquid handling device may be in fluidic communication with the fluidic network. The third one of the plurality of pneumatic ports may be configured to selectively: receive a positive pneumatic pressure or a negative pneumatic pressure; and be connected to a vent. The pneumatic supply system may be configured to: supply a positive pressure from the variable pressure source to the third one of the plurality of pneumatic ports while connecting the first one of the plurality of pneumatic ports to the vent; and/or supply a negative pressure from the variable pressure source to the third one of the plurality of pneumatic ports while connecting the second one of the plurality of pneumatic ports to the vent. Providing a third pneumatic port further increases the complexity of the fluidic network that may be implemented.

The liquid handling device may further comprise a liquid storage capsule. The liquid handling device may be configured to transfer a positive pneumatic pressure from one of the plurality of pneumatic ports to the liquid storage capsule once the liquid storage capsule has been opened. The liquid handling device may further comprise an actuatable portion that is actuatable from a first position, in which the actuatable portion does not deform the liquid storage capsule, to a second position, in which the actuatable portion deforms the liquid storage capsule. The liquid handling system may be configured to actuate the actuatable portion of the liquid handling device, thereby deforming the liquid storage capsule.

According to a tenth aspect of the present disclosure, there is provided a method of moving liquid in a liquid handling device comprising a fluidic network, the fluidic network comprising a plurality of conduits and a chamber, the method comprising: venting a first one of a plurality of pneumatic ports of the liquid handling device, wherein the first one of the plurality of pneumatic ports is in fluidic communication with the chamber; and during venting of the first one of the plurality of pneumatic ports, supplying a positive pneumatic pressure to a second one of the plurality of pneumatic ports of the liquid handling device, wherein the second one of the plurality of pneumatic ports is in fluidic communication with a conduit of the plurality of conduits, wherein the conduit is in fluidic communication with the chamber; wherein supplying the positive pneumatic pressure to the second one of the plurality of pneumatic ports during venting of the first one of the plurality of pneumatic ports dispenses liquid from the conduit to the chamber.

The method may further comprise: venting the first one of the plurality of pneumatic ports; and during venting of the first one of the plurality of pneumatic ports, supplying a negative pneumatic pressure to the second one of the plurality of pneumatic ports to aspirate liquid out of the chamber.

The chamber may be a waste chamber. The method may further comprise supplying a positive pneumatic pressure to the second one of the plurality of pneumatic ports during venting of the first one of the plurality of pneumatic ports to dispense liquid into the waste chamber.

The fluidic network may further comprise a measurement chamber. The method may further comprise supplying a positive pneumatic pressure to the second one of the plurality of pneumatic ports during venting of the first one of the plurality of pneumatic ports to dispense liquid from the measurement chamber to the waste chamber.

The liquid handling device may comprise a vented sample inlet chamber in fluidic communication with the fluidic network. The method may further comprise supplying a negative pneumatic pressure to one of the plurality of pneumatic ports to aspirate liquid from the sample inlet chamber into the fluidic network.

The chamber may be a mixing chamber. The method may further comprise supplying a positive pneumatic pressure to the second one of the plurality of pneumatic ports during venting of the first one of the plurality of pneumatic ports to dispense liquid from the conduit to the mixing chamber.

The mixing chamber may be a first mixing chamber. The fluidic network may further comprise a second mixing chamber in fluidic communication with the conduit and the first mixing chamber. The method may further comprise supplying a positive pressure from the variable pressure source to the second one of the plurality of pneumatic ports during venting of the first one of the plurality of pneumatic ports, to dispense liquid from the second mixing chamber to the first mixing chamber.

The method may further comprise supplying a negative pressure from the variable pressure source to the second one of the plurality of pneumatic ports during venting of the first one of the plurality of pneumatic ports, to aspirate liquid from the first mixing chamber to the second mixing chamber.

The method may further comprise: during venting of the first one of the plurality of pneumatic ports, supplying a positive pressure from the variable pressure source to a third one of the plurality of pneumatic ports in fluidic communication with the fluidic network.

The method may further comprise: during venting of the first one of the plurality of pneumatic ports, supplying a negative pressure from the variable pressure source to a third one of the plurality of pneumatic ports in fluidic communication with the fluidic network.

The method may further comprise: actuating an actuatable portion of the liquid handling device to deform a liquid storage capsule housed in the liquid handling device.

According to an eleventh aspect of the present disclosure, there is provided a computer-readable medium comprising instructions that, when executed by a processor of a pneumatic pressure supply system as defined in the ninth aspect, cause the pneumatic pressure supply system to carry out the method of the tenth aspect.

It will be appreciated that the features of the aspects described above may be combined between different aspects. As one example, the features of the liquid handling devices according to any one of the first, second, third, fifth, sixth, seventh and eighth aspects may be combined with one or more features described in relation to any other of these aspects. As another example, the features of the liquid handling systems according to one of the fourth and ninth aspects may be combined with one or more features described in relation to the other aspect.

### BRIEF DESCRIPTION OF FIGURES

Specific embodiments are described below by way of example only and with reference to the accompanying drawings, in which:

FIG. 1 is an isometric view of a liquid handling device.

FIG. 2 is an exploded view showing the components of the liquid handling device in FIG. 1.

FIG. 3 is a top sectional view through the liquid handling device shown in FIG. 1.

FIG. 4 is an isometric underside view of a first rigid layer of the liquid handling device shown in FIG. 1.

FIG. 5 is a top view of the first rigid layer shown in FIG. 4.

FIG. 6A is a bottom view of the first rigid layer shown in FIG. 4.

FIG. 6B is a section view through line A-A in FIG. 6A.

FIG. 7 is a side section view showing the engagement of an actuatable portion of the first rigid layer shown in FIG. 4 with a liquid storage capsule.

FIG. 8 is an end section view showing the engagement of the actuatable portion of the first rigid layer shown in FIG. 4 with a liquid storage capsule.

FIG. 9A is an isometric view of the first rigid layer shown in FIG. 4, showing the actuatable portion in an actuated position.

FIG. 9B is a section view through the first rigid layer shown in FIG. 4, showing the actuatable portion in the actuated position.

FIG. 10 is an isometric view of a second rigid layer of the liquid handling device shown in FIG. 1.

FIG. 11 is a top view of the second rigid layer shown in FIG. 10.

FIG. 12 is a top view of a portion of the second rigid layer shown in FIG. 10, with close-up isometric views of a first plurality of grooves and a second plurality of grooves of the second rigid layer.

FIG. 13 is an isometric view of a fluidic assembly, comprising a fluidic layer of the liquid handling device shown in FIG. 1, and a sealing layer of the liquid handling device shown in FIG. 1.

FIG. 14A shows how the liquid volume remaining in a flow cell of a fluidic assembly, in which the flow cell is accessed via holes in a sealing layer, varies as the angle of the outlet conduit from the flow cell is varied.

FIG. 14B shows how the liquid volume remaining in a flow cell of a fluidic assembly, in which the flow cell is accessed via holes in a sealing layer, varies with misalignment of the holes in the sealing layer and the flow cell.

FIG. 14C shows how the liquid volume remaining in a flow cell of a fluidic assembly, in which the flow cell is accessed via holes in a sealing layer, varies with the size of the holes in the sealing layer.

FIG. 15 is an isometric view of an alternative fluidic assembly, comprising the fluidic layer of the liquid handling device shown in FIG. 1, and an alternative sealing layer.

FIG. 16 shows simulations of liquid flows in flow cells of a fluidic assembly, in which the flow cells are provided in a sealing layer.

FIGS. 17A and 17B are a bottom views of the fluidic layer of the liquid handling device shown in FIG. 1.

FIG. 17C is a top view of the fluidic layer shown in FIGS. 17A and 17B.

FIG. 18A is a top view of an alternative fluidic layer that may be implemented in the liquid handling device shown in FIG. 1.

FIG. 18B is a bottom view of the alternative fluidic layer shown in FIG. 18A.

FIG. 19A is a section view through line A-A in FIG. 17C.

FIG. 19B is a section view through line B-B in FIG. 17C.

FIG. 19C is a section view through line C-C in FIG. 17C.

FIG. 19D is a section view through line D-D in FIG. 17C.

FIG. 19E is a section view of detail E shown in FIG. 19D.

FIG. 20 is a section view through a chamber of the fluidic layer shown in FIGS. 17A to 17C, showing a solid reagent within the chamber.

FIG. 21 is a section view through a valve region of the fluidic layer shown in FIGS. 17A to 17C, showing the valve region being engaged by an external valve actuator.

FIG. 22A is a simulation of engagement of the external valve actuator and the valve region shown in FIG. 21, in which the external valve actuator is in a non-engaged position with the valve region.

FIG. 22B is a simulation of engagement of the external valve actuator and the valve region shown in FIG. 21, in which the external valve actuator is in a partially engaged position with the valve region.

FIG. 22C is a simulation of engagement of the external valve actuator and the valve region shown in FIG. 21, in which the external valve actuator is in an engaged position with the valve region.

FIG. 23A is a section view through a pneumatic port of the fluidic layer shown in FIGS. 17A to 17C and an external pneumatic actuator.

FIG. 23B is a simulation of engagement of the external pneumatic actuator and the pneumatic port shown in FIG. 23A.

FIG. 24A is a section view through an alternative pneumatic port of a fluidic layer.

FIG. 24B is a simulation of engagement of the external pneumatic actuator and the alternative pneumatic port shown in FIG. 24A.

FIG. 25 is a schematic diagram indicating the effects of different pneumatic port shapes on deformation of the pneumatic port during engagement by the external pneumatic actuator.

FIG. 26 is a schematic diagram of a fluidic circuit that may be implemented using the fluidic layer shown in FIGS. 17A to 17C.

FIG. 27 is a schematic diagram of an additional fluidic circuit that may be implemented using the fluidic layer shown in FIGS. 17A to 17C.

FIG. 28 is a schematic diagram of a further fluidic circuit that may be implemented using the fluidic layer shown in FIGS. 17A to 17C.

FIG. 29 is a flowchart of fluidic operations that may be implemented using the fluidic layer shown in FIGS. 17A to 17C.

### DETAILED DESCRIPTION

Implementations of the present disclosure are explained below with particular reference to microfluidic cartridges that are used for carrying out diagnostic tests. It will be appreciated, however, that the implementations described herein are applicable to microfluidic cartridges that are used for other purposes. It will further be appreciated that the implementations described herein are not limited to microfluidics, and are applicable to liquid handling devices, of various sizes, that are used for various purposes.

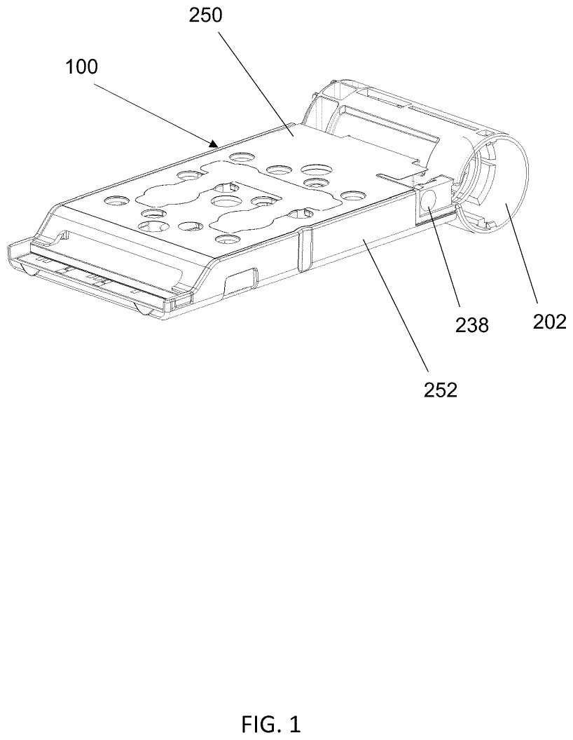

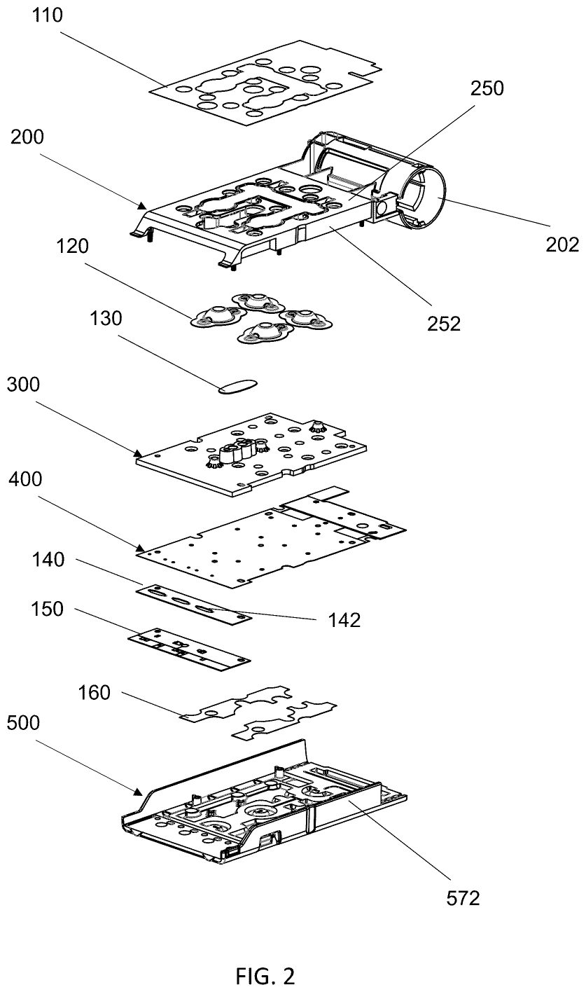

FIG. 1 is an isometric view of a liquid handling device in the form of a diagnostic cartridge 100 (e.g. a microfluidic cartridge). The cartridge 100 comprises a number of components, as seen from the exploded view shown in FIG. 2.

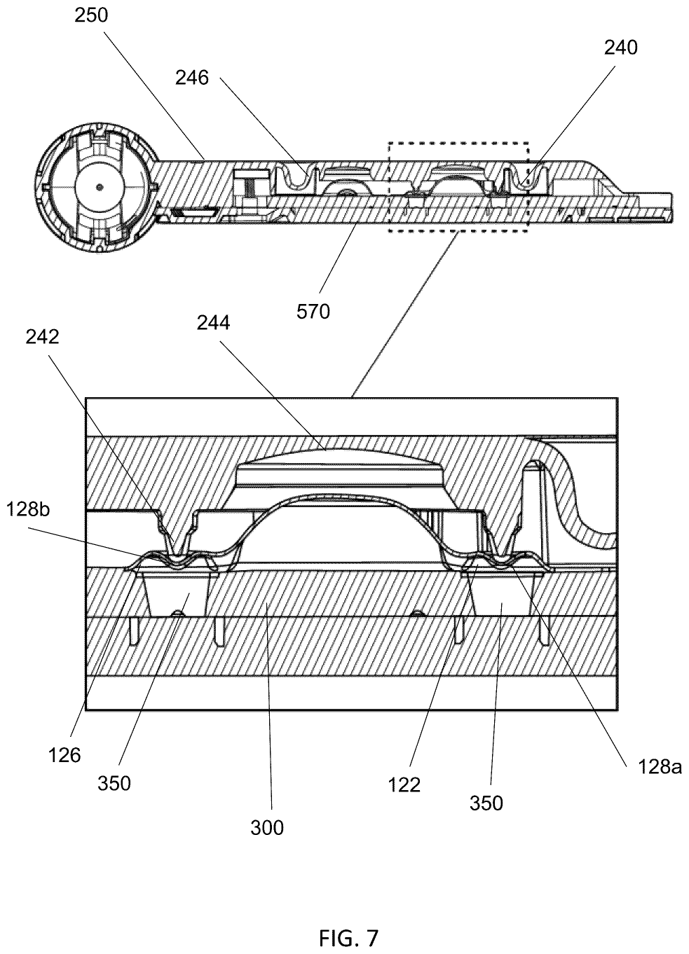

Specifically, the cartridge 100 comprises a first part 200 and a second part 500, each of which is formed of a rigid material. In use (i.e. when the cartridge 100 is in the orientation shown in FIG. 1), the first part 200 is an upper part and the second part 500 is a lower part. Together, the first part 200 and the second part 500 define a housing of the cartridge 100. Specifically, the first part 200 comprises a rigid face 250 that defines an upper surface of the cartridge 100. Likewise, the second part 500 comprises a rigid face 570 (as best shown in FIG. 7) that defines a lower surface of the cartridge 100. Returning to FIG. 2, it can be seen that the first part 200 further comprises side walls 252 that are joined to the rigid face 250, while the second part 500 further comprises side walls 572 joined to the rigid face 570. Together, the side walls 252 of the first part 200 and the side walls 572 of the second part 500 cooperate to define the side walls of the cartridge 100.

The cartridge 100 further comprises a fluidic layer 300 disposed within the housing defined by the first part 200 and the second part 500. Specifically, the fluidic layer 300 is disposed between the rigid face 250 of the first part 200 and the rigid face 570 of the second part 500. Therefore, the fluidic layer 300 is disposed between a first rigid layer in the form of the rigid face 250, and a second rigid layer in the form of the rigid face 570. The fluidic layer 300 is formed of an elastomeric material, such as a thermoplastic elastomer (TPE), for example, a silicon-based TPE or styrene-ethylene-butylene-styrene (SEBS); polydimethylsiloxane (PDMS); or liquid silicone rubber (LSR).

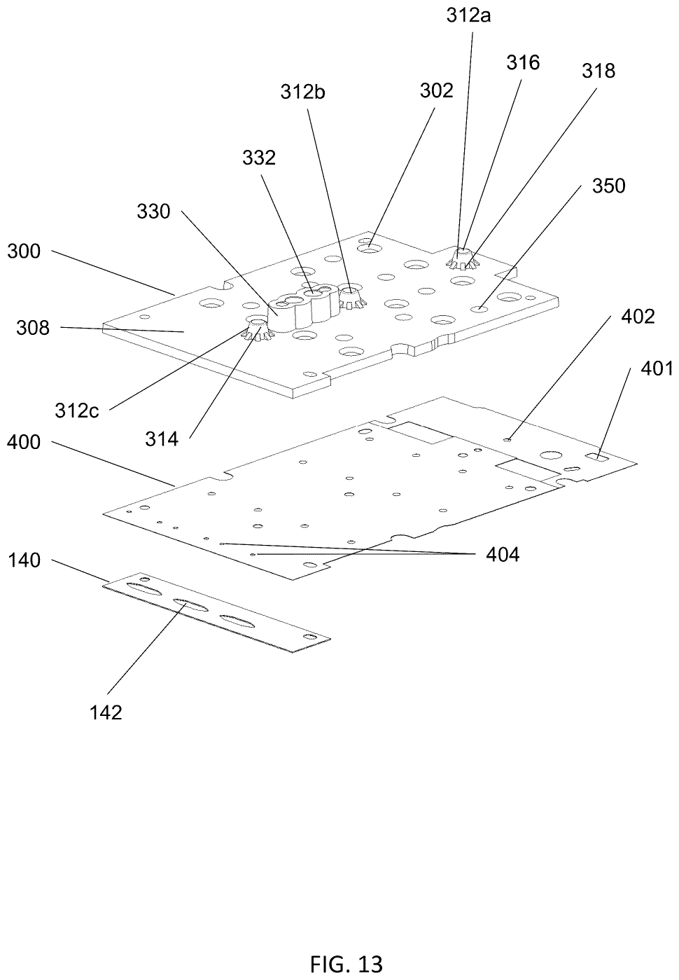

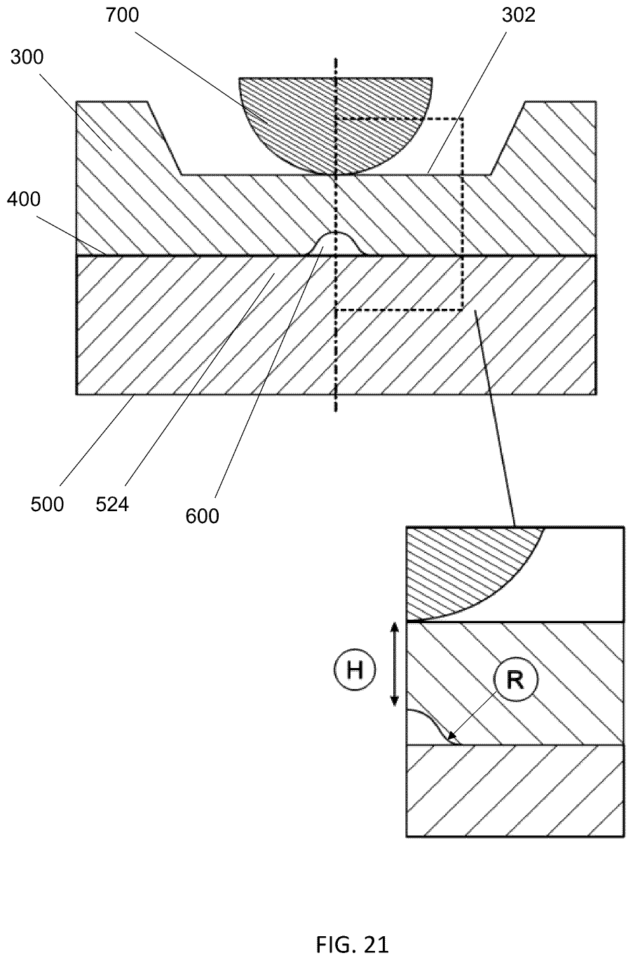

As described in more detail below, a first surface 308 of the fluidic layer 300 comprises a plurality of valve regions 302 (shown, for example, in FIG. 13). The cartridge 100 is received in an analyser device that comprises actuators 700 that apply forces to the valve regions 302 of the fluidic layer 300, to close one or more conduits 600 (shown in FIG. 21) within the cartridge 100. The properties of the material used for the fluidic layer 300 are dependent on the available force that can be applied to the valve regions 302 of the fluidic layer 300 by the actuators 700. Two properties of importance are the hardness of the material, and the relaxation time of the material (i.e. the time for the material to return to its original form following deformation). Examples of suitable materials include the elastomeric materials listed above. In some implementations, the fluidic layer 300 may be a medical-grade material, to prevent reaction of the fluidic layer 300 with the reagents used in the diagnostic test or assay.

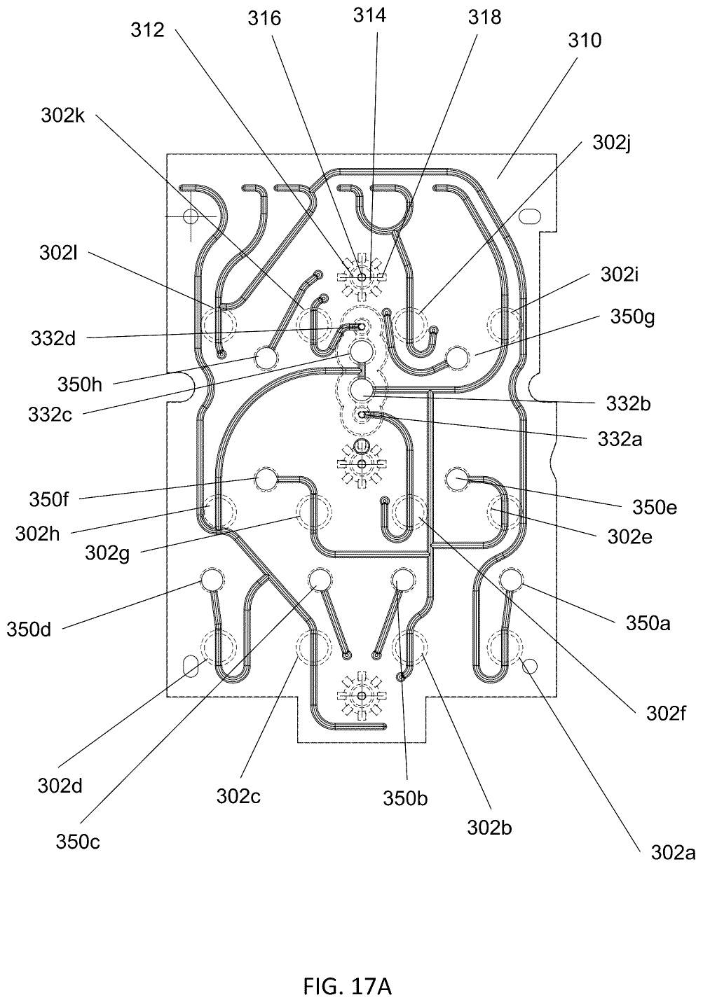

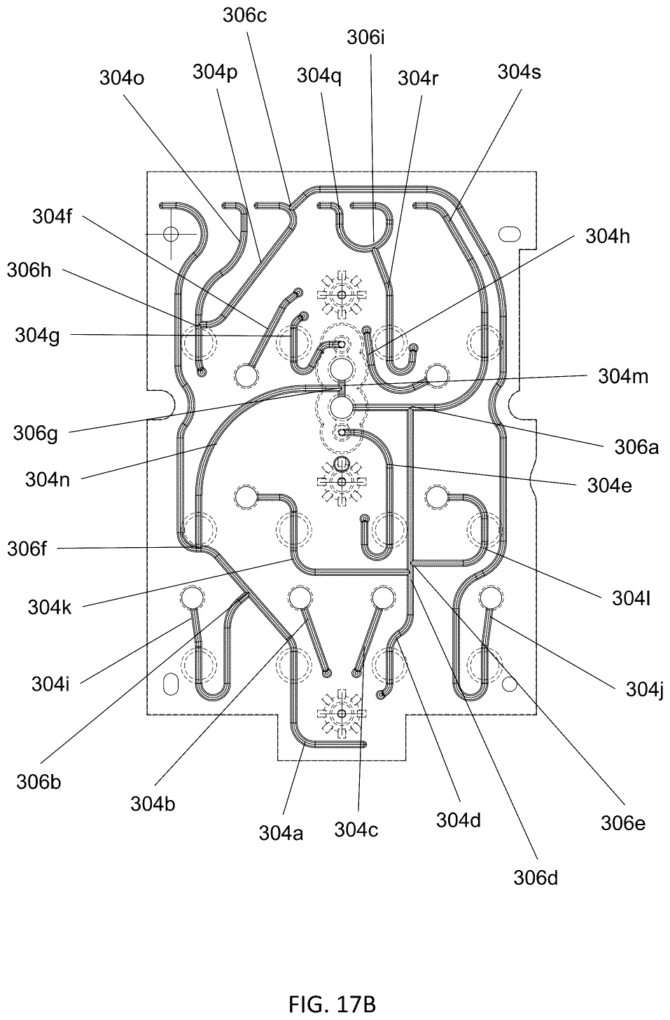

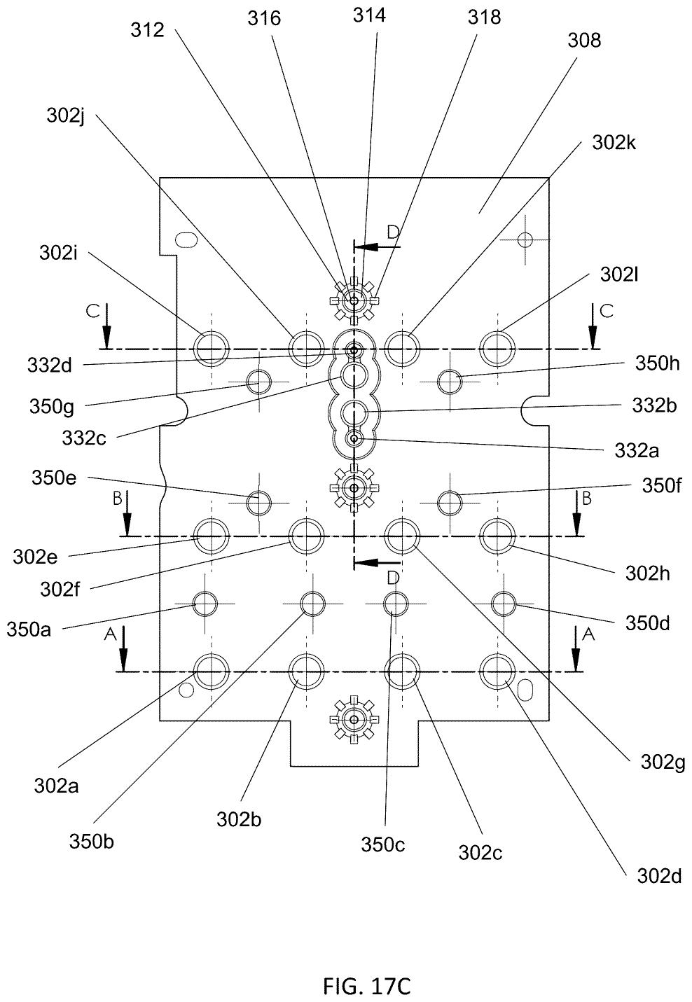

As described in more detail below, the fluidic layer 300 comprises a network of channels 304 (shown in FIG. 17B) provided (at least partly) in a second surface 310 of the fluidic layer 300 that is opposite to the first surface 308. The cartridge 100 also comprises a fluidic network comprising a plurality of conduits 600, which are defined at least in part by the network of channels 304 in the fluidic layer 300. Specifically, the conduits 600 are defined by: (i) the network of channels 304 in the fluidic layer 300; (ii) a sealing layer 400 (shown in FIG. 2) that is configured to seal the channels 304 in the second surface 310 of the fluidic layer 300; and optionally (iii) a sealing layer (not shown) configured to seal any channels 304 of the network that are provided in the first surface 308.

Providing channels 304 in an elastomeric fluidic layer 300 provides improved sealing of the fluidic layer, irrespective of the bonding process used to seal the network of channels 304 (e.g. pressure-sensitive adhesive tape, laser welding, etc.). This is because the elastomeric fluidic layer 300 acts as a compliant layer when it is being sealed against another layer (e.g. sealing layer 400). In addition, using an elastomeric material for the fluidic layer 300 means that the channels 304 can be compressed in order to close respective conduits 600. This means that a single layer can be utilised to implement the channels 304 and valves (i.e. valve regions 302), thereby providing a simple cartridge construction.

Returning to the exploded view shown in FIG. 2, it can be seen that the cartridge 100 further comprises: a label 110 arranged to cover at least a portion of the rigid face 250 of the first part 200; a plurality of liquid storage capsules 120 that are disposed within the cartridge 100 between the fluidic layer 300 and the first face 250; and a sealing tape 130 arranged to seal one or more chambers 332 (best shown in FIG. 13) in the fluidic layer 300.

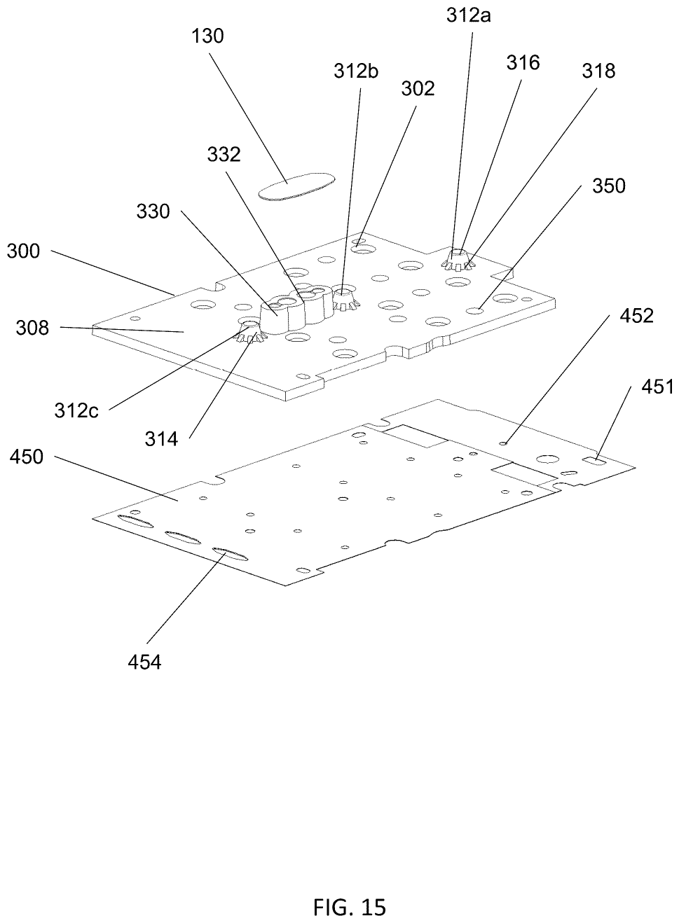

FIG. 2 also shows that the cartridge 100 further comprises: a flow cell strip 140 comprising a plurality of apertures 142, each of which defines, in part, a corresponding measurement chamber 610 of the cartridge 100; a sensor strip 150 comprising a plurality of sensors, each sensor in fluidic communication with a respective one or the measurement chambers 610; and a pair of absorbent waste pads 160, each arranged to fit within a corresponding waste chamber 508a, 508b provided in the second part 500. In some implementations (e.g. as shown in FIG. 15), the flow cell strip 140 is not present, and apertures 454 that define in part the measurement chambers 610 are instead provided in an alternative sealing layer 450.

As shown in FIGS. 1 and 2, the first part 200 comprises a receptacle in the form of a cylinder 202, which is configured to receive a portion of a liquid storage container such as a blood collection tube (e.g. a Vacutainer® blood collection tube manufactured by Becton, Dickinson and Company of Franklin Lakes, NJ, USA). A blood collection tube typically contains a volume of liquid (e.g. blood), and a headspace that includes a volume of gas.

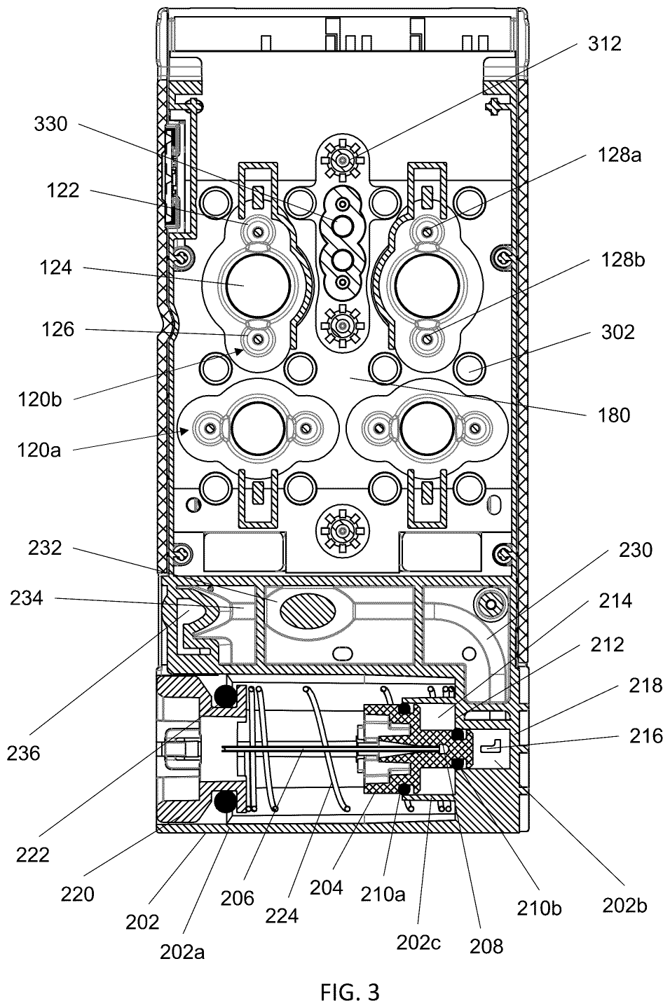

As shown in the section view of FIG. 3, the cartridge 100 further comprises an actuatable liquid extraction mechanism in the form of a piston 204 that is actuatable within the cylinder 202 from a first liquid extraction mechanism configuration (shown in FIG. 3) to a second liquid extraction mechanism configuration.

The cylinder 202 comprises a first cylinder portion 202a that defines a first cylindrical interior volume, and a second cylinder portion 202b that defines a second cylindrical interior volume. The second cylindrical interior volume extends from the first cylindrical interior volume. The cross-sectional area of the second cylindrical interior volume is smaller than the cross-sectional area of the first cylindrical interior volume, such that the second cylindrical interior volume is narrower than the first cylindrical interior volume. An annular flange 212 is disposed within the cylinder 202 and joins the first cylindrical interior volume to the second cylindrical interior volume. The annular flange 212 acts as an end wall for the first cylindrical interior volume.

The cylinder 202 also comprises a third cylinder portion 202c that is disposed within the first cylindrical interior volume. The third cylinder portion 202c defines a third cylindrical interior volume. The cross-sectional area of the third cylindrical interior volume is in between the cross-sectional areas of the first and second cylindrical interior volumes. The third cylinder portion 202c protrudes from the annular flange 212 in a direction opposite to the direction in which the second cylinder portion 202b extends. The diameter of the third cylinder portion 202c is smaller than the diameter of the first cylindrical interior volume, meaning that there is an annular gap between the first cylinder portion 202a and the third cylinder portion 202c. The height of the third cylinder portion 202c is smaller than the height of the first cylinder portion 202a, meaning that the third cylinder portion 202c protrudes part way into the first cylindrical interior volume.

The piston 204 includes two sealing elements in the form of first and second annular (e.g. O-ring) seals 210a, 210b. The first O-ring seal 210a is configured to provide a seal between the piston 204 and an interior wall of the third cylinder portion 202c. The second O-ring seal 210b is configured to provide a seal between the piston 204 and an interior wall of the second cylinder portion 202b. Together, the piston 204, the annular flange 212, and the interior walls of the second and third cylinder portions 202b, 202c define a chamber 214 that is sealed by the first and second O-ring seals 210a, 210b. The cylinder includes a cylinder outlet 216 that is configured to compromise the sealing provided by the second O-ring seal 210b by allowing air to flow around the second O-ring seal 210b, when the piston 204 is in the second configuration. The cylinder outlet 216 also allows liquid to be removed from within the cylinder 202 once it has been extracted from the blood collection tube. The cylinder outlet 216 is in fluidic communication with a sample inlet channel 230 (described further below) that provides a connection to a vented fluidic arrangement within the cartridge 100. The cylinder outlet 216 thereby allows liquid to be transferred from the components within the cylinder 202 to the other fluidic components of the cartridge 100.

The piston 204 comprises a liquid storage container interface, such as a blood collection tube interface in the form of a piercing element. A piercing element is shown in FIG. 3 in the form of a needle 206. The needle 206 is configured to provide a fluidic connection to a volume of liquid within the liquid storage container (e.g. to a volume of blood within a blood collection tube) when the liquid storage container is connected to the needle 206. The needle 206 is fixedly attached to the piston 204 such that the needle 206 moves within the cylinder 202 as the piston 204 is actuated from the first liquid extraction mechanism configuration to the second liquid extraction mechanism configuration. The needle 206 comprises a liquid extraction outlet 208 through which the liquid extracted from the blood collection tube can flow. The liquid extraction outlet 208 provides a fluidic connection between the needle 206 and the cylinder outlet 216 when the piston 204 is in the second configuration.

In the first liquid extraction mechanism configuration (shown in FIG. 3), the piston 204 is located above the cylinder outlet 216 in the cylinder 202 (i.e. there is a gap between the second O-ring seal 210b and an end wall 218 of the cylinder 202).

After connection of a blood collection tube to the needle 206, the volume of the chamber 214 is reduced as the piston 204 is actuated from the first liquid extraction mechanism configuration to the second liquid extraction mechanism configuration. The reduction in volume of the chamber 214 results in an increase in pressure of the air within the chamber 214, because the chamber 214 is sealed by the O-ring seals 210a, 210b. The increase in air pressure within the chamber 214 forces air through the needle 206 and into the blood collection tube, which increases the pressure of the volume of gas within the blood collection tube. The increase in the pressure of air within the chamber 214 and the blood collection tube continues as the piston 204 is actuated towards the second configuration.

Once the piston 204 is in the second configuration, the second O-ring seal 210b is aligned with the cylinder outlet 216 and is consequently compromised, meaning that the pressurised air within the chamber 214 can flow through the cylinder outlet 216. This reduces the pressure at the liquid extraction outlet 208, which is in fluidic communication with the chamber 214, thereby providing a pressure difference between the volume of gas within the blood collection tube, and the liquid extraction outlet 208. This difference in pressure forces liquid out of the blood collection tube via the needle 206, and into the sample inlet channel 230 via the liquid extraction outlet 208 aligned with the cylinder outlet 216.

The cartridge 100 further comprises an actuatable safety mechanism 220 that is actuatable within the cylinder 202 from a first safety mechanism configuration (shown in FIG. 3) to a second safety mechanism configuration. The safety mechanism 220 is configured to conceal the liquid storage container interface (i.e. needle 206) when the safety mechanism 220 is in the first safety mechanism configuration, and to reveal the liquid storage container interface when the safety mechanism 220 is in the second safety mechanism configuration.

The safety mechanism 220 comprises at least one spherical blocking element 222 (two spherical blocking elements 222 are shown in FIG. 3). At least one of the blocking elements 222 prevents actuation of the safety mechanism 220 from the first safety mechanism configuration to the second safety mechanism configuration when the cylinder 202 is in a first orientation (such as a horizontal orientation). The at least one of the blocking elements 222 also permits actuation of the safety mechanism 220 from the first safety mechanism configuration to the second safety mechanism configuration when the cylinder 202 is in a second orientation (such as a vertical orientation).

The cartridge 100 further comprises a resiliently deformable element, shown in FIG. 3 in the form of a spring 224. The spring 224 is deformed when the safety mechanism 220 is moved towards the piston 204 (i.e. when the safety mechanism 220 is actuated from the first safety mechanism configuration to the second safety mechanism configuration). The spring 224 is configured to bias the safety mechanism 220 away from the piston 204 when a force applied to compress the spring 224 is released. The spring 224 therefore biases the safety mechanism 220 away from the second safety mechanism configuration towards the first safety mechanism, thereby re-concealing the needle 206 following extraction of liquid from the liquid storage container.

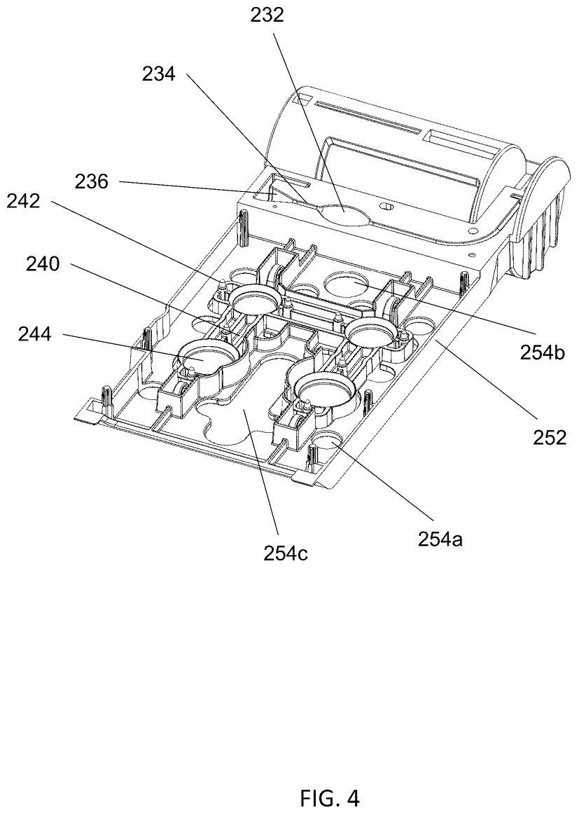

The cartridge 100 further comprises a sample adequacy control chamber 236 (shown more clearly in FIG. 4) that provides a visual indication to a user that a sufficient amount of liquid has been extracted from the liquid storage container (e.g. blood collection tube). In particular, the sample adequacy control chamber 236 may provide a visual indication that a volume of liquid sufficient for a particular diagnostic test has been extracted. As shown, for example, in FIG. 1, the sample adequacy control chamber 236 is configured to provide the visual indication through an optically clear window 238 in a side wall of the cartridge 100 that is disposed upwards when the cylinder 202 is in a vertical orientation (i.e. when the cartridge 100 is used for extracting liquid from the liquid storage container).

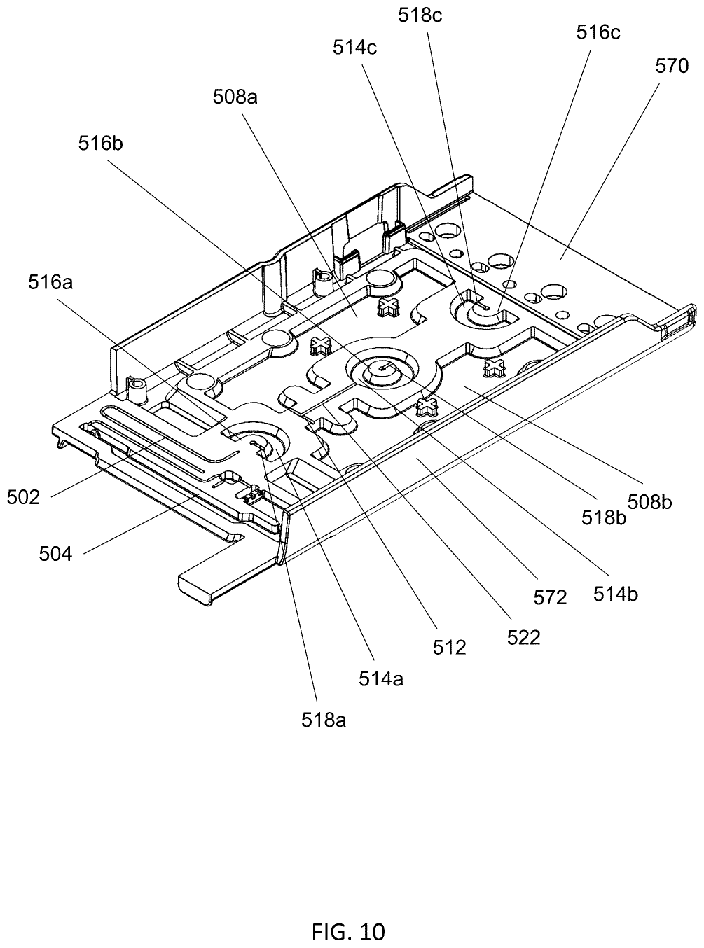

The sample adequacy control chamber 236 shown in FIG. 3 forms part of a first flow path that is in fluidic communication with the sample inlet channel 230. As shown in FIGS. 3 and 4, the cartridge 100 also includes a metering chamber 232 configured to store a specific volume of liquid. For example, the metering chamber 232 may store a volume of liquid required for a particular diagnostic test. The first flow path includes the metering chamber 232, a connector channel 234 providing a fluidic connection between the metering chamber 232 and the sample adequacy control chamber 236, the sample adequacy control chamber 236, and a sample waste chamber in fluidic communication with the sample adequacy control chamber 236 via a waste outlet 401 in the sealing layer 400 (shown in FIG. 13). The sample waste chamber is provided in the form of a first well 504 in the second part 500 and is best shown in FIGS. 10 to 12. The sample waste chamber defined by the first well 504 is vented, as described in more detail below.

The cartridge 100 further comprises a second flow path comprising a metering chamber outlet channel 502 (also best shown in FIGS. 10 to 12) extending from an outlet port (not shown) in the metering chamber 232. The metering chamber outlet channel 502 is in fluidic communication with the metering chamber 232 via a hole 402 (shown in FIG. 13) in the sealing layer 400. The metering chamber outlet channel 502 allows liquid to be aspirated into other fluidic components of the cartridge 100. Alternative implementations may not include the metering chamber 232 or the connector channel 234, in which case the metering chamber outlet channel 502 extends from an outlet port in a sample adequacy control chamber that is configured to meter a specific volume of liquid.

The second flow path (which includes the metering chamber outlet channel 502) provides a higher hydraulic resistance than the first flow path (which includes the sample adequacy control chamber 236, and optionally the metering chamber 232 and the connector channel 234). This means that the flow rate of liquid through the first flow path is higher than the flow rate through the second flow path. The higher flow rate through the first flow path means that liquid flows into the sample adequacy control chamber 236 to provide the visual indication that a sufficient volume of liquid has been received, without completely filling the metering chamber outlet channel 502.

When the cartridge is assembled, each of the sample inlet channel 230, the connector channel 234 and the metering chamber outlet channel 502 defines a corresponding conduit that is sealed by the sealing layer 400.

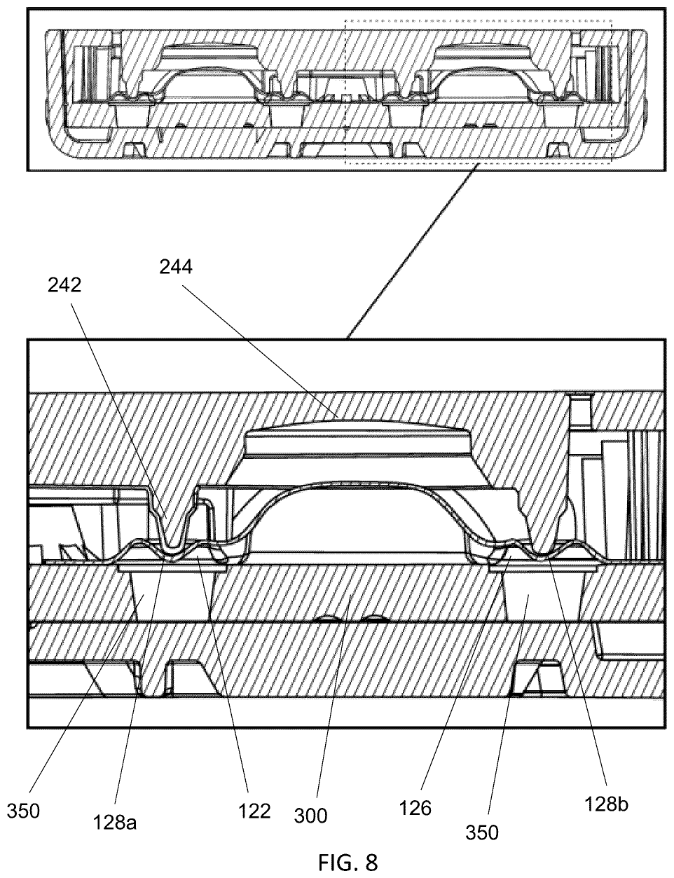

FIG. 3 also shows the arrangement of the plurality of liquid storage capsules 120 within the cartridge 100. In particular, the liquid storage capsules 120 are sealed to the fluidic layer 300 using a sealing tape 180. FIG. 3 shows that the sealing tape 180 includes apertures that allow the upwardly protruding features of the fluidic layer 300 (i.e. pneumatic ports 312 and a projection 330 that defines the chambers 332, described in further detail with reference to FIG. 13). As shown in FIG. 3, each liquid storage capsule 120 comprises an inlet chamber 122, a main chamber 124 storing a liquid such as a liquid reagent, and an outlet chamber 126. A sealing layer (e.g. a sealing foil) is used to seal the chambers 122, 124, 126 of each liquid storage capsule 120. The inlet chamber 122 and the outlet chamber 126 each comprise a corresponding recess 128a, 128b in a top surface of the chamber (as best shown in FIGS. 7 and 8).

The liquid storage capsules 120 shown in FIG. 3 comprise two smaller liquid storage capsules 120a, and two larger liquid storage capsules 120b. The smaller liquid storage capsules 120a are aligned such that the recesses 128a, 128b of the smaller storage capsules 120a are all in a straight line. Each of the larger liquid storage capsules 120b is arranged perpendicular to a corresponding smaller liquid storage capsule 120a, such that the larger liquid storage capsules 120b are parallel to each other.

As explained in more detail below, each of the liquid storage capsules 120 is positioned over two openings 350 in the fluidic layer 300. Specifically, the inlet chamber 122 of a liquid storage capsule 120 covers a first one of the openings 350, while the outlet chamber 126 of the liquid storage capsule 120 covers a second one of the openings 350. When forces are applied to the recesses 128a, 128b of the liquid storage capsule 120, the material of the liquid storage capsule 120 is deformed into each of the openings 350. When sufficient force is applied, the deformation of the liquid storage capsule 120 into the openings 350 causes rupture of the sealing layer (e.g. foil) used to seal the capsule 120.

In an alternative implementation, the inlet chamber 122 and the outlet chamber 126 may not comprise recesses 128. Instead, forces may be applied directly to a portion of the inlet chamber 122 and the outlet chamber 126 to deform the liquid storage capsule 120.

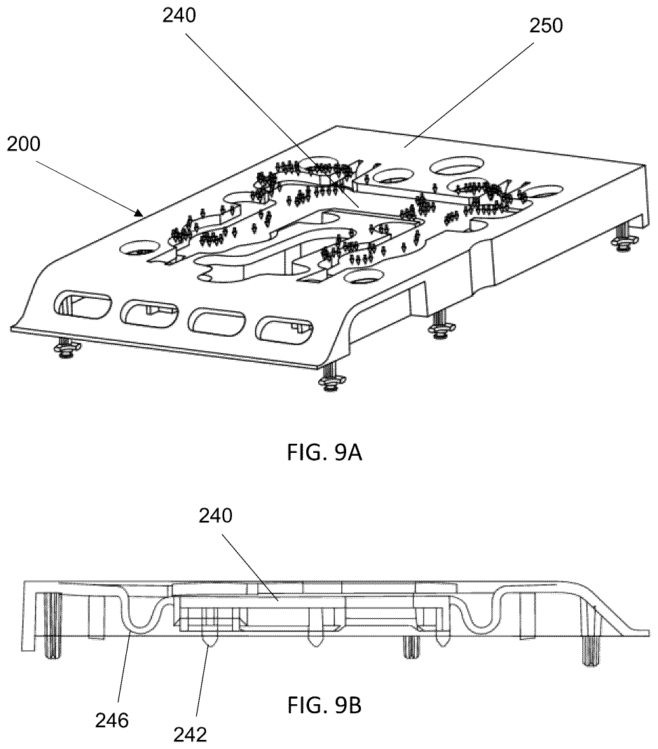

FIG. 4 is an isometric underside view of the first part 200. As shown in FIGS. 4 to 6, the first part 200 comprises an actuatable portion 240 (e.g. an actuatable platform) that is actuatable from a first position, in which the actuatable portion 240 does not deform the liquid storage capsules 120, to a second position, in which the actuatable portion 240 deforms the liquid storage capsules 120. The actuatable portion 240 is actuatable relative to the rigid face 250 of the first part 200, and is actuatable in a direction normal to the rigid face 250 of the first part 200 (as best shown in FIGS. 9A and 9B). The actuatable portion 240 is rigid.

The actuatable portion 240 is U-shaped, such that it can be deformed towards each of the liquid storage capsules 120. The U-shape of the actuatable portion 240 also allows the actuatable portion 240 to pass around a projection 330 (shown in FIG. 13) that extends from the first surface 308 of the fluidic layer 300.

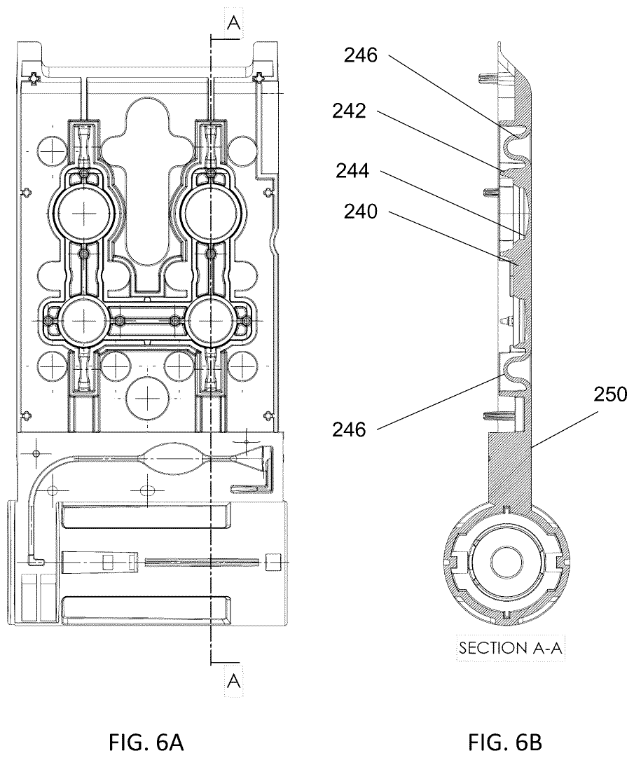

As shown in FIG. 4, the underside of the actuatable portion 240 comprises four pairs of protrusions 242 (shown in section view in FIG. 6B). Each pair of protrusions 242 extends towards the liquid storage capsules 120 and is aligned with the recesses 128a, 128b of one of the liquid storage capsules 120. Therefore, when the actuatable portion 240 is moved to the second position, the protrusions 242 engage the recesses 128a, 128b of the capsules 120. In an alternative implementation, the liquid storage capsules 120 may not include recesses 128a, 128b, in which case the protrusions 242 may engage a portion of the inlet and outlet chambers 122, 126 (e.g. a flat or domed upper surface of the inlet and outlet chambers 122, 126) of each liquid storage capsule 120.

As shown in FIG. 6B, the underside of the actuatable portion 240 also includes four concave regions 244. Each concave region 244 is located between two of the protrusions 242. Each concave region 244 is configured to accommodate the main chamber 124 of its corresponding liquid storage capsule 120 when the actuatable portion 240 is in the second position. This means that the main chamber 124 is not deformed by the actuatable portion 240 when the actuatable portion 240 is in the second position.

Given that the protrusions 242 extend from a single actuatable portion 240, actuation of the actuatable portion 242 to the second position causes simultaneous deformation of each of the plurality of capsules 120. Consequently, all capsules 120 within the cartridge 100 can be punctured using a single movement of the actuatable portion 240.

In an alternative implementation, the actuatable portion 240 may comprise two sets of protrusions 242: a first set of protrusions, each extending a first distance towards the recesses 128 of the liquid storage capsules 120; and a second set of protrusions, each extending a second distance towards the recesses 128 of the liquid storage capsules 120, wherein the second distance is less than the first distance.

This alternative implementation allows for puncture of the liquid storage capsules 120 in two stages. The capsules 120 aligned with the first set of protrusions are punctured first, when the actuatable portion 240 is moved to the second position (as described above). However, to puncture the capsules 120 aligned with the second set of protrusions, the actuatable portion 240 is actuated beyond the second position, to a third position (because the second set of protrusions are shorter). This alternative implementation therefore allows for liquid (e.g. liquid reagent) to be released from some capsules before other capsules are punctured.

Therefore, fluidic workflow steps involving, for example, liquid reagents stored in first and second capsules may be completed prior to release of liquid reagent from third and fourth capsules (e.g. if the liquid reagents in the third and fourth capsules are required at a later stage of the fluidic workflow). Additional sets of protrusions extending different distances from the actuatable portion 240 may be implemented in order to further stagger the release of liquids from the capsules 120.

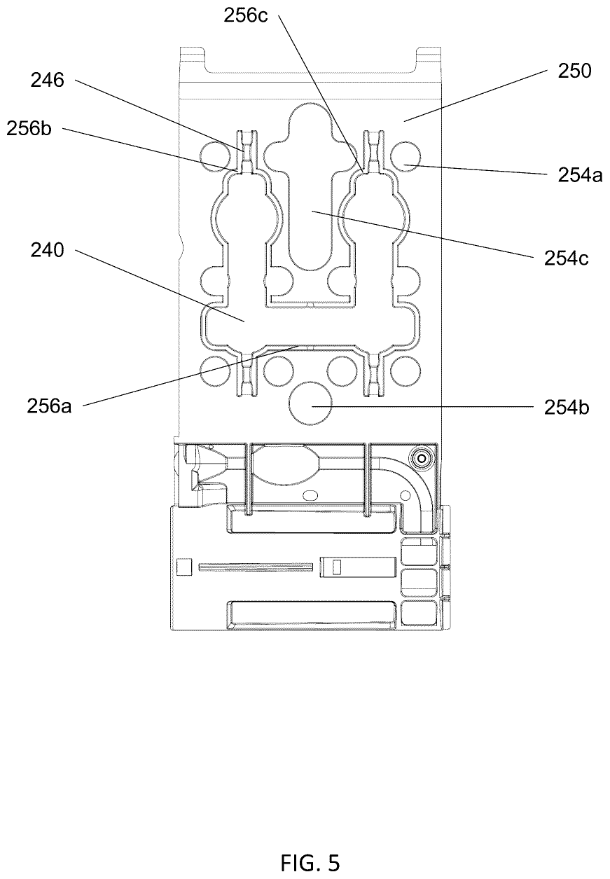

As shown in FIG. 5 and FIG. 6B, the top surface (i.e. exterior surface) of the actuatable portion 240 is flat (or includes a plurality of flat regions). The flat surface of the actuatable portion 240 allows the actuatable portion 240 to be easily moved from the first position to the second position, without requiring a particular shape of actuator to move the actuatable portion 240.

FIGS. 4 and 5 also show that the rigid face 250 includes a plurality of apertures 254. The plurality of apertures 254 includes apertures 254a that are aligned with the valve regions 302 of the fluidic layer 300, an aperture 254b aligned with a first pneumatic port 312a of the fluidic layer 300, and an aperture 254c that provides an opening for a second pneumatic port 312b and a third pneumatic port 312c of the fluidic layer 300, along with the projection 330 extending from the first surface 308 of the fluidic layer 300. The ports 312 and projection 330 are described with reference to FIG. 13.

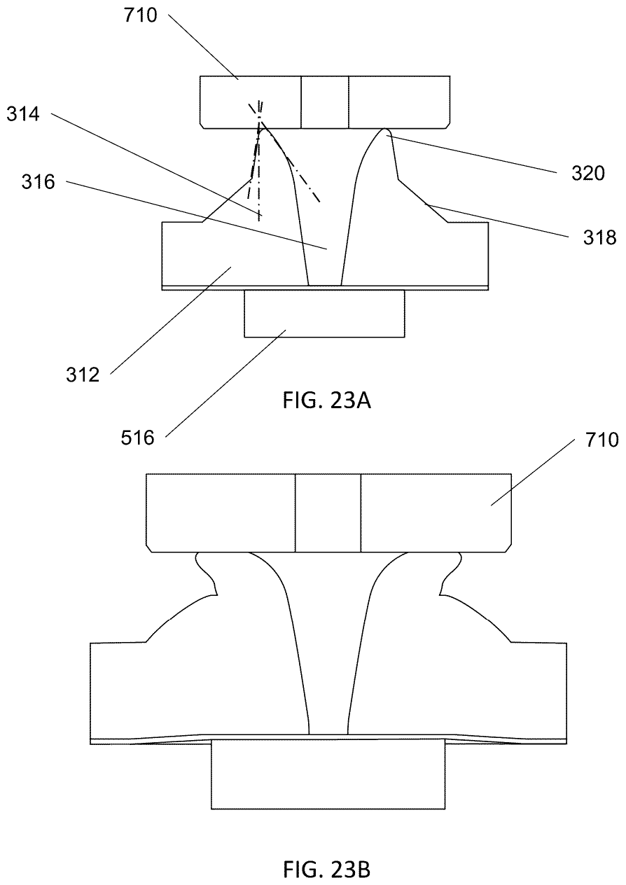

The apertures 254a in the rigid face 250 allow the valve regions 302 of the fluidic layer 300 to be accessed by an external valve actuator (e.g. as shown in FIG. 21). Likewise, the apertures 254b and 254c allow the pneumatic ports 312 of the fluidic layer 300 to be accessed by an external pneumatic actuator (e.g. as shown in FIG. 23A).

FIG. 6B and FIG. 7 also show the resiliently deformable members 246 that couple the actuatable portion 240 to the first part 200. The resiliently deformable members 246 are configured to bias the actuatable portion 240 away from the second position (i.e. towards the first position). The resiliently deformable members 246 therefore force the actuatable portion away from engagement with the recesses 128a, 128b of the liquid storage capsules 120.

Each resiliently deformable member 246 has a curved (specifically, U-shaped) profile, which allows the resiliently deformable member 246 to undergo elastic deformation during movement of the actuatable portion 240 to the second position. FIG. 9B shows the deformation of the resiliently deformable members 246 when the actuatable portion 240 is in the second position, while FIG. 9A shows the position of the actuatable portion 240 relative to the first part 200 when the actuatable portion 240 is in the second position.

The resiliently deformable members 246 are formed of the same material as the actuatable portion 240 and the first part 200. In other words, the resiliently deformable members 246 are integral with the first part 200 and the actuatable portion 240, and are each provided in the form of a resilient living hinge. This allows the manufacture of the first part 200, including the actuatable portion 240 and the resiliently deformable members 246, to be simplified (e.g. produced by injection moulding).

As shown in FIGS. 4 to 6A, the first part 200 includes a plurality of resiliently deformable members 246 (in the example shown in FIGS. 4 to 6A, four resiliently deformable members 246 are shown). Providing a plurality of resiliently deformable members 246 allows the actuatable portion 240 to be actuated in a vertical direction, meaning that the actuatable portion 240 is parallel to a base (i.e. the sealing layer) of each liquid storage capsule 120 when the actuatable portion 240 is in the first portion and when the actuatable portion 240 is in the second position. Vertical movement of the actuatable portion 240 allows the same force to be applied to the recesses 128 of a particular liquid storage capsule 120.

In particular, as shown in FIG. 5, a first one of the resiliently deformable members 246 is connected to a first edge 256a of the actuatable portion 240; a second one of the resiliently deformable members 246 is connected to a second edge 256b of the actuatable portion 240 that is opposite to the first edge 256a; a third one of the resiliently deformable members 246 is also connected to the first edge 256a of the actuatable portion 240, but spaced apart from the connection point of the first one of the resiliently deformable members 246; and a fourth one of the resiliently deformable members 246 is connected to a third edge 256c of the actuatable portion 240 that is also opposite to the first edge 256a.

FIG. 7 and FIG. 8 show the alignment of the protrusions 242 with the recesses 128a, 128b of a liquid storage capsule 120, when the actuatable portion 240 is in the first position. It will be appreciated that when a force is applied to the actuatable portion 240 to move the actuatable portion 240 towards its second position, the protrusions 242 engage the recesses 128a, 128b and cause deformation of the inlet chamber 122 and the outlet chamber 126 of the liquid storage capsule 120. Specifically, the sealing layer at the underside of the inlet chamber 122 is deformed into the first one of the openings 350, and the sealing layer at the underside of the outlet chamber 126 is deformed into the second one of the openings 350. The deformation of the inlet chamber 122 and the outlet chamber 126 causes rupturing of the material at the underside of the inlet chamber 122 and the outlet chamber 126, meaning that an opening is created in each of the inlet chamber 122 and the outlet chamber 126.

The rupture of the material at the underside of the inlet chamber 122 and the outlet chamber 126 is achieved by applying forces to the recesses 128a, 128b, which forces the recesses 128 into contact with the material at the underside of the inlet chamber 122 and the outlet chamber 126. This, in turn, deforms the material at the underside of the inlet chamber 122 and the outlet chamber 122 into the openings 350. The top surface of the capsules 120 is formed of a material that is capable of plastic deformation, in order to allow for deformation of the recesses 128.

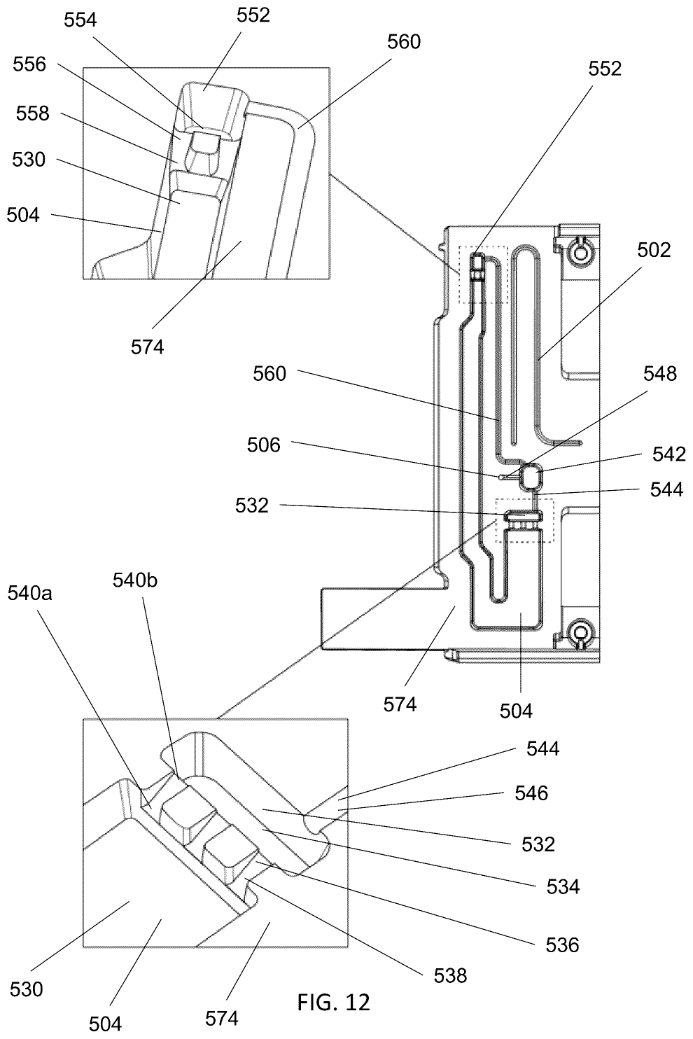

FIG. 10 shows the second part 500. As described above, the second part 500 includes the metering chamber outlet channel 502, which provides a fluidic connection between the metering chamber 232 and the fluidic layer 300. The second part 500 also includes the sample waste chamber defined by the first well 504. The sample waste chamber receives excess sample that overflows from the sample adequacy control chamber 236 in the first part 200 during receipt of the sample in the cartridge 100. The sample waste chamber is in fluidic communication with a permanent vent 506 (best shown in FIG. 12), provided in the form of a hole in the second part 500. The sample waste chamber and permanent vent 506 are described in more detail below with reference to FIG. 12.

The second part 500 further comprises two further waste chambers (first waste chamber 508a and second waste chamber 508b), each of which is provided in the form of two elongate recesses in the interior surface of the rigid face 570. The two waste chambers 508a, 508b are in fluidic communication with one another via a transverse channel 512 extending between the first waste chamber 508a and the second waste chamber 508b.

The second part 500 further comprises a first trough 514a in the form of a half-annular groove in the interior surface of the rigid face 570, a second trough 514b in the form of an annular groove in the interior surface of the rigid face 570, and a third trough 514c in the form of an additional half-annular groove in the interior surface of the rigid face 570. Each of the troughs 514 provides a fluidic connection between a pneumatic port 312 in the fluidic layer 300 and one or more channels 304 of the fluidic layer 300, as described in more detail below. Specifically, as described with reference to FIGS. 17A and 17B, a number of the channels 304 are fluidically connected to the troughs 514, via holes in the sealing layer 400.

The second part 500 further comprises a first pneumatic port support 516a, provided at the origin of the half-annular groove forming the first trough 514a, a second pneumatic port support 516b, provided at the origin of the annular groove forming the second trough 514b, and a third pneumatic port support 516c, provided at the origin of the half-annular groove forming the third trough 514c. Each of the pneumatic port supports 516 has a truncated cone (or truncated half-cone) shape, with a flat upper surface. Each of the pneumatic port supports 516 is disposed beneath a corresponding pneumatic port 312 of the fluidic layer 300, when the cartridge 100 is assembled.

The first pneumatic port support 516a comprises a channel 518a in its flat upper surface. The channel 518a extends from the centre of the first pneumatic port support 516a to the first trough 514a. Likewise, the second pneumatic port support 516b comprises a channel 518b in its flat upper surface. The channel 518b extends from the centre of the second pneumatic port support 516b to the second trough 514b. Further, the third pneumatic port support 516c comprises a channel 518c in its flat upper surface. The channel 518c extends from the centre of the third pneumatic port support 516c to the third trough 514c . . . . When the cartridge 100 is assembled, there is a fluidic connection between an opening 316 of each pneumatic port 312 and a channel 518 of a corresponding pneumatic port support 516 (via the sealing layer 400).

The port supports 516 are in contact with the underside of the sealing layer 400 used to seal the channels 304 in the second surface 310 of the fluidic layer 300. This means that, when a force is applied to the pneumatic ports 312 of the fluidic layer 300 (described with reference to FIG. 13), the contact between the sealing layer 400 and the port supports 516 provides a reaction force against the applied force, thereby preventing downward deformation of the sealing layer 400. This helps the pneumatic ports 312 to form a seal with a pneumatic actuator.

The troughs 514 in the second part 500 prevent liquid from reaching the pneumatic ports 312, which connect to pneumatic actuators 712 of the analyser device. Accordingly, the troughs 514 prevent liquid from reaching the analyser device, particularly during aspiration of liquid. Such liquid could potentially contaminate or damage the analyser device. The pneumatic pressure is supplied via the channel 518 on the flat upper surface of the port support 516. Given that the channel 518 is disposed above the base of the trough 514, any liquid drawn from the channels 304 in the fluidic layer 300 pools in the bottom of the trough 514 and does not reach the channel 518. Therefore, any liquid drawn from the channels 304 in the fluidic layer 300 is not drawn through the channel 518 and into the pneumatic actuator 710 via the pneumatic port 312.

The second part 500 further comprises a longitudinal channel 522 that extends between the second trough 514b and the transverse channel 512 that connects the two waste chambers 508a, 508b. The second trough 514b and channel 518b are therefore in fluidic communication with the two waste chambers 508a, 508b via the longitudinal channel 522 and the transverse channel 512.

The transverse and longitudinal channels 512, 522 allow the two waste chambers 508 to be in fluidic communication with a pneumatic port 312 (specifically, the second pneumatic port 312b). The fluidic communication is provided by the second trough 514b and the channel 518b in the second port support 516b. The fluidic communication between the waste chambers 508 and the second pneumatic port 312b allows the venting state of the waste chambers 508 to be controlled. This is because the second pneumatic port 312b can be vented, as described in more detail below.

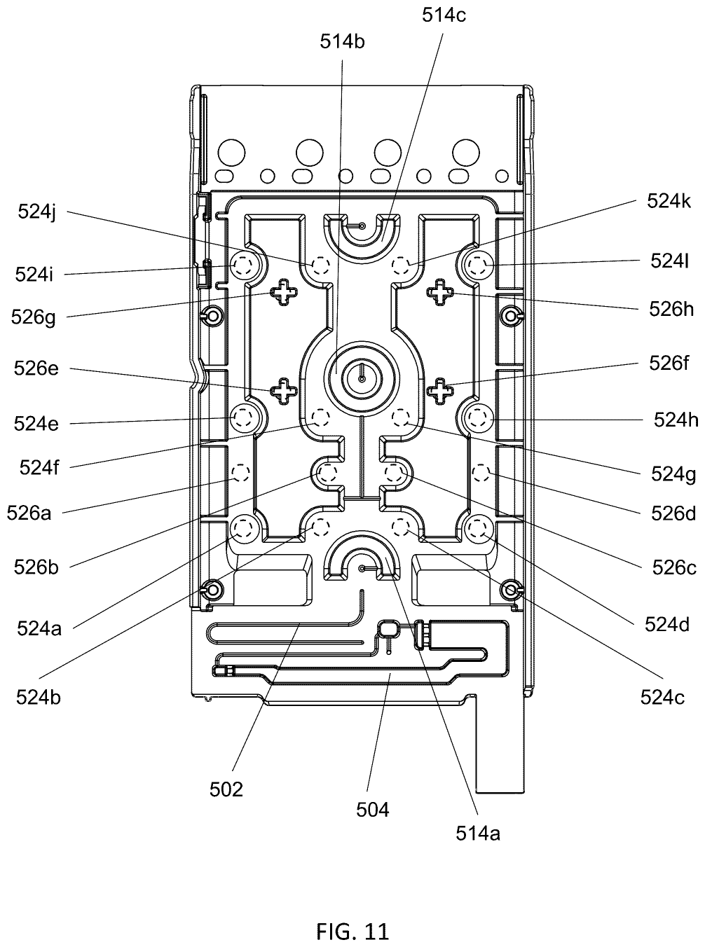

The second part 500 also comprises a plurality of valve support regions 524a to 524l (indicated by dashed lines in FIG. 11). In the example shown in FIGS. 10 and 11, twelve valve support regions 524 are shown. Each of the valve support regions 524 is aligned with a corresponding valve region 302 in the fluidic layer 300. Each of the valve support regions 524 contacts the underside of the sealing layer 400 used to seal the channels 304 in the second surface 310 of the fluidic layer 300. This means that, when a force is applied to a valve region 302 of the fluidic layer 300 by an actuator 700 (shown in FIG. 21), the valve region 302 is compressed between the actuator 700 and the corresponding valve support region 524. This means that the waste chambers 508a, 508b do not extend beneath the valve regions 302 of the fluidic layer 300.

The second part 500 further comprises a plurality of capsule support regions 526a to 526h (again indicated by dashed lines in FIG. 11). In the example shown in FIGS. 10 and 11, eight capsule support regions 526 are shown. Each of the capsule support regions 526 is aligned with a corresponding opening 350 in the fluidic layer 300 that is aligned with an inlet chamber 122 or outlet chamber 126 of one of the plurality of capsules 120. Each of the capsule support regions 526 contacts the underside of the sealing layer 400 used to seal the channels 304 in the second surface 310 of the fluidic layer 300. This means that, when a force is applied to a recess 128 of one of the plurality of capsules 120 by a corresponding protrusion 242 of the actuatable portion 240, the fluidic layer 300 is prevented from being deformed by the corresponding capsule support region 526. This means that the waste chambers 508a, 508b do not extend beneath the openings 350 in the fluidic layer 300.

As shown in FIG. 12, the sample waste chamber is provided in the form of a first well 504 provided in the rigid face 570 of the first part 500. The first well 504 has a depth defined by a distance between a base 530 of the first well 504 and a sealing surface 574 of the rigid face 570, that contacts the sealing layer 400 when the cartridge 100 is assembled.

The rigid face 570 also includes a second well 532 with a depth defined by a distance between a base 534 of the second well 532 and the sealing surface 574. As explained in more detail below, the second well 532 is in fluidic communication with the permanent vent 506. In particular, the second well 532 is disposed between the first well 504 and the permanent vent 506, such that the first well 504 is in fluidic communication with the permanent vent 506 via the second well 532.

A first plurality of grooves 536 (e.g. three grooves 536, as shown in FIG. 12) are provided between the first well 504 and the second well 532. Each of the grooves 536 has an angled base 538. Each groove 536 has a depth defined by a distance between the angled base 538 and the sealing surface 574. The base 538 of the grooves 536 is angled between: a maximum depth of the groove 536 at a first end 540a of the groove 536 adjacent to the first well 504; and a minimum depth of the groove 536 at a second end 540b of the groove 536 adjacent to the second well 532. In other words, the second end 540b of each groove 536 is disposed above the first end 540a of each groove 536. This means that the depth of the first end 540a of each groove 536 is greater than the depth of the second end 540b of each groove 536.

By more than one path for liquid flow between the first well 504 and the second well 532, the likelihood of a liquid blockage between the first well 504 and the second well 532 is reduced.

The angled base 538 of the groove 536 is disposed above the base 530 of the first well 504 and above the base 534 of the second well 532. This means that the depth of the sample waste chamber (defined by the first well 504) is greater than the maximum depth of each groove 536. Likewise, the depth of the second well 532 is also greater than the maximum depth of each groove 536.

The effect of the angled base 538 means that even if liquid flows into one of the grooves 536, the pressure required to clear liquid from the groove 536 is reduced. This is because the angled base 538 of the groove 536 causes liquid to flow towards the first well 504 under gravity. In other words, the grooves 536 are easier to empty when a negative pressure is applied to the sample waste chamber defined by the first well 504. The angled shape also acts as a capillary stop and helps prevent liquid progressing to the second well 532.

The second well 532 is in fluidic communication with a third well 542 via a first connector channel 544 that extends between the second well 532 and the third well 542. The third well 542 is disposed between the second well 532 and the permanent vent 506. The first connector channel 544 has a depth defined by a distance between a base 546 of the first connector channel 544 and the sealing surface 574. The base 546 of the first connector channel 544 is disposed above the base 534 of the second well 532, meaning that the depth of the second well 532 is greater than the depth of the first connector channel 544.

As shown in FIG. 12, the connector channel 544 may be a single channel. In an alternative implementation, the connector channel 544 may comprise a plurality of grooves extending between the second well 532 and the third well 542. The plurality of grooves may be similar in construction as the plurality of grooves 536 extending between the first well 504 and the second well 532.

The third well 542 is in fluidic communication with a vent channel 548 that extends from the third well 542. The third well 542 is in fluidic communication with the permanent vent 506 via the vent channel 548. Specifically, the vent channel 548 extends between the third well 542 and the permanent vent 506. The vent channel 548 has a first end adjacent to (i.e. in fluidic communication with) the third well 542, and a second end adjacent to (i.e. in fluidic communication with) the permanent vent 506. As explained above, the permanent vent 506 is provided in the form of a hole in the second part 500, that extends through the rigid face 570.

FIG. 12 shows that the vent channel 548 extends from the third well 542 in a first direction (i.e. parallel to the sealing surface 574), while the hole extends through the rigid face 570 in a second direction (i.e. extending away from the sealing surface 574, more particularly normal to the sealing surface 574 such that the second direction is perpendicular to the first direction). The hole extends to an exterior surface of the rigid face 570.

The second part 500 also includes a fourth well 552. The fourth well 552 is in fluidic communication with the first well 504, and is located at an opposite end of the first well 504 to the second well 532.

The fourth well 552 has a depth defined by a distance between a base 554 of the fourth well 552 and the sealing surface 574. A second plurality of grooves 556 (e.g. two grooves 556, as shown in FIG. 12) extends between the first well 504 and the fourth well 552. As with the first plurality of grooves 536, each of the second plurality of grooves 556 has an angled base 558 that is disposed above the base 530 of the first well 504 and above the base 554 of the fourth well 552. This means that a maximum depth of each groove 556 is less than the depth of the first well 504 and also less than the depth of the fourth well 552.

The fourth well 552 is in fluidic communication with the third well 542 via a second connector channel 560 that extends from the fourth well 552. The fourth well 552 is in fluidic communication with the permanent vent 506 via the second connector channel 560. Specifically, the second connector channel 560 extends between the fourth well 552 and the third well 542. Accordingly, a fluidic circuit is comprised of the first well 504 (defining the sample waste chamber), the first plurality of grooves 536, the second well 532, the first connector channel 544, the third well 542, the second connector channel 560, the fourth well 552, and the second plurality of grooves 556.

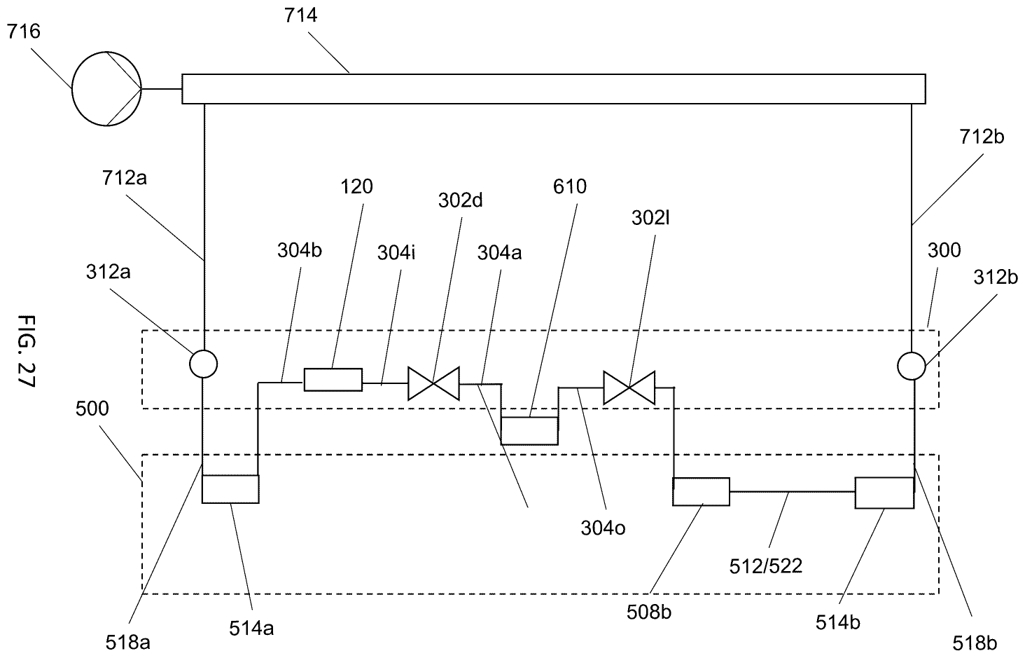

The effects of the first plurality of grooves 536 and the second plurality of grooves 556 on fluid movement are described in more detail with reference to the fluidic circuit shown in FIG. 26.

FIG. 13 is an exploded view showing the fluidic layer 300, sealing layer 400, and flow cell strip 140, in a first implementation of the flow cells (i.e. measurement chambers 610) of the cartridge 100. The sealing layer 400 is arranged to seal the channels 304 in the second surface 310 of the fluidic layer 300. For example, the sealing layer 400 may be arranged to cover the second surface 310 of the fluidic layer 300, thereby providing direct contact between the sealing layer 400 and the second surface 310 of the fluidic layer 300.

FIG. 13 shows the plurality of valve regions 302 of the cartridge, each of which is provided in the form of a depression in the fluidic layer 300. This means that the fluidic layer 300 has a reduced thickness in each of the valve regions 302. By providing regions of reduced thickness that are aligned with corresponding channels 304, the force required to deform the valve regions 302 and close a corresponding channel 304 is reduced.

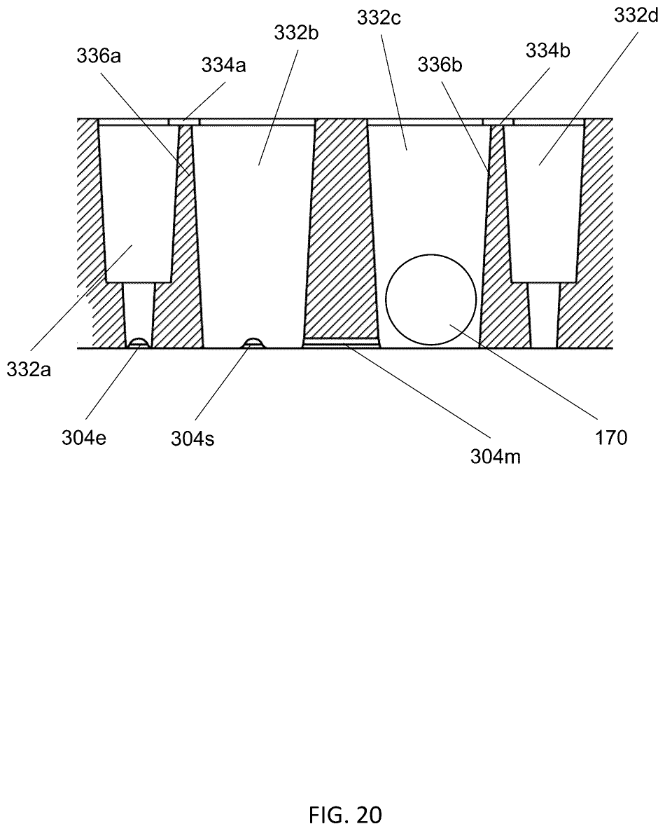

Also shown in FIG. 13 is the projection 330 extending from the first surface 308 of the fluidic layer 300. The projection 330 includes cavities that define a plurality of chambers 332, as described in more detail with reference to FIG. 20. Implementing a projection 330 that extends from the first surface 308 of the fluidic layer 300 means that the volume of the chambers 332 defined by the projection 330 is not limited by the thickness of the fluidic layer 300 between its first and second surfaces 308, 310. The fluidic layer 300 further comprises the plurality of openings 350 that extend through the thickness of the fluidic layer 300.

As shown in FIG. 13, the fluidic layer 300 further comprises the plurality of pneumatic ports 312 (for example, three pneumatic ports 312a, 312b and 312c as shown in FIG. 13). Each pneumatic port 312 comprises a protrusion 314 extending from the first surface 308. As described in more detail below, each protrusion 314 has a frustoconical shape (i.e. truncated cone shape).

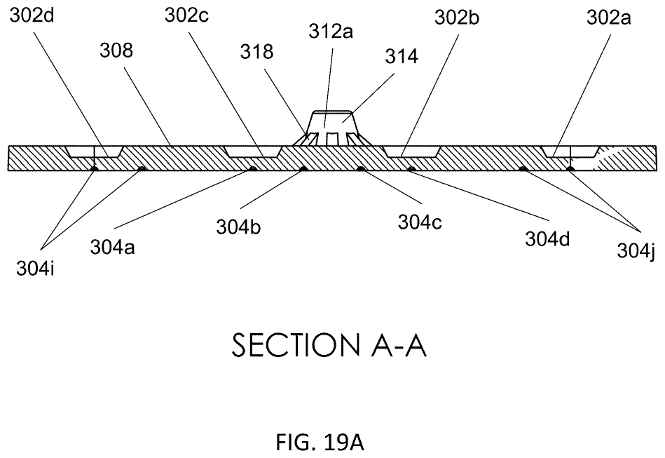

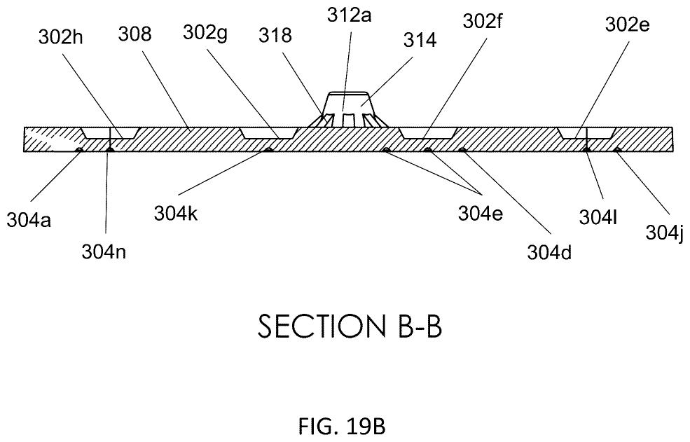

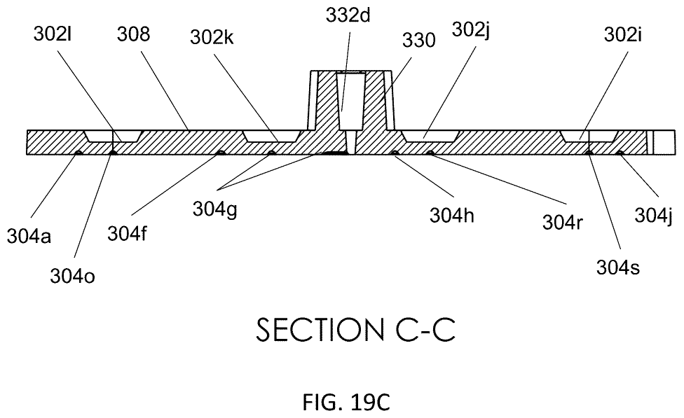

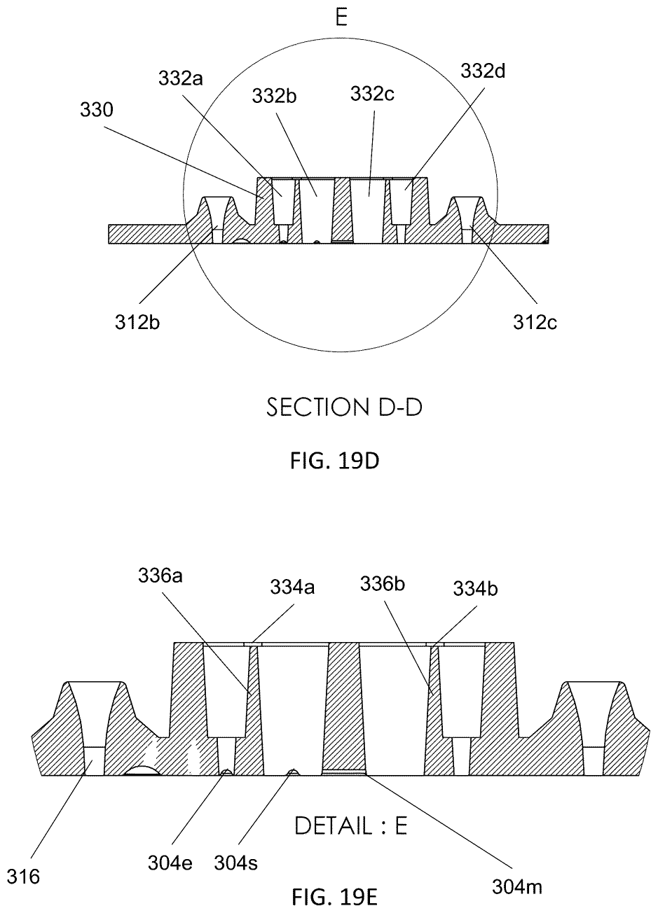

Each port 312 further comprises an opening 316 extending through the protrusion 314 and at least part of the thickness of the fluidic layer (as best shown in FIGS. 19D and 19E). In the example shown in FIG. 13, the opening 316 extends through the whole thickness of the fluidic layer 300.

The fluidic layer 300 therefore comprises two sets of openings: a first plurality of openings 350, that are disposed directly below the liquid storage capsules 120 and are aligned with the protrusions 242 on the actuatable portion 240; and a second plurality of openings 316, each of which extends through a corresponding protrusion 314 of a pneumatic port 312. These sets of openings allow for communication between the network of channels 304 in the fluidic layer 300 and other fluidic components of the cartridge 100 (e.g. the capsules 120 and the pneumatic ports 312).

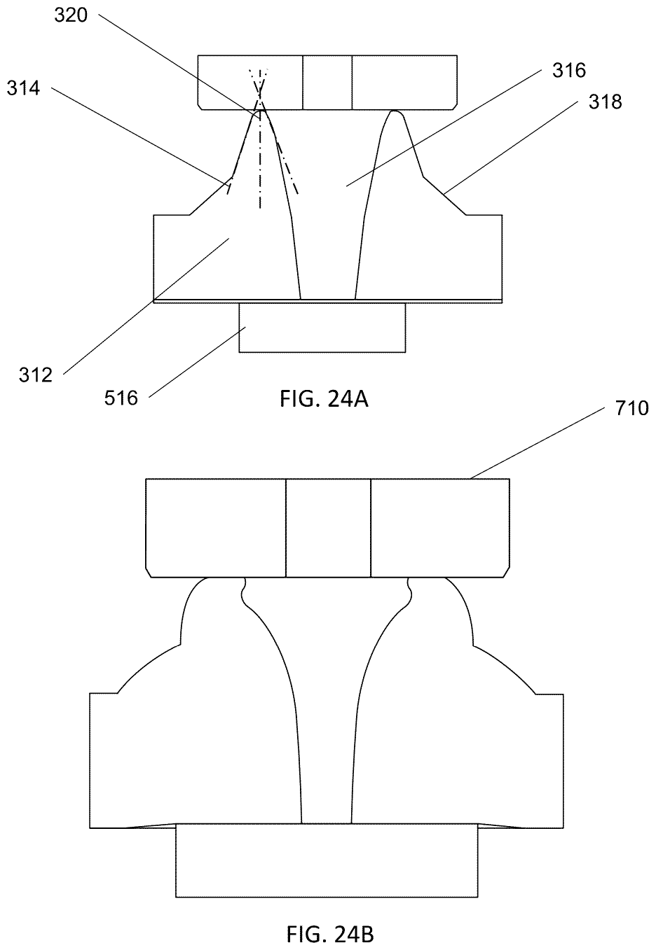

Each pneumatic port 312 further comprises a plurality of support ribs 318 (e.g. eight support ribs 318, as shown in FIG. 17C). Each support rib 318 extends between the first surface 308 and one of the protrusions 314. The support ribs 318 help to prevent excessive deformation of the pneumatic ports 312 when forces are applied to the pneumatic ports 312 by a pneumatic actuator 710 (e.g. as shown in FIGS. 23B and 24B). The pneumatic actuator 710 may be a component of the analyser device in which the cartridge 100 is received.

In addition, each protrusion 314 comprises an annular rim 320 (best shown in FIGS. 23A to 25) at an open end of the protrusion 314 (i.e. the end of the protrusion furthest from the first surface 308). As described further below, the shape of the annular rim 320 determines in part whether the annular rim 320 is deformed inwardly or outwardly when a force is applied to the pneumatic port 312 by a pneumatic actuator 710 (shown in FIGS. 23B and 24B).

All components of the fluidic layer 300 described above are integral with the fluidic layer 300, meaning that they are all formed of the same elastomeric material as the fluidic layer 300. More specifically, the projection 330, protrusions 314, support ribs 318 and annular rims 320 are all integral with the fluidic layer 300 and formed of the same elastomeric material as the fluidic layer 300.

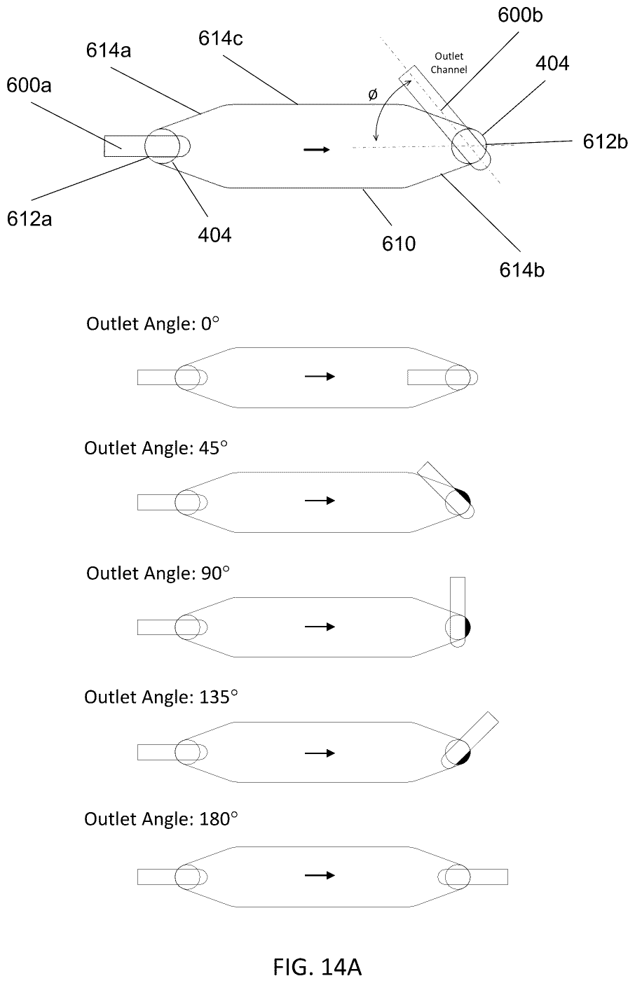

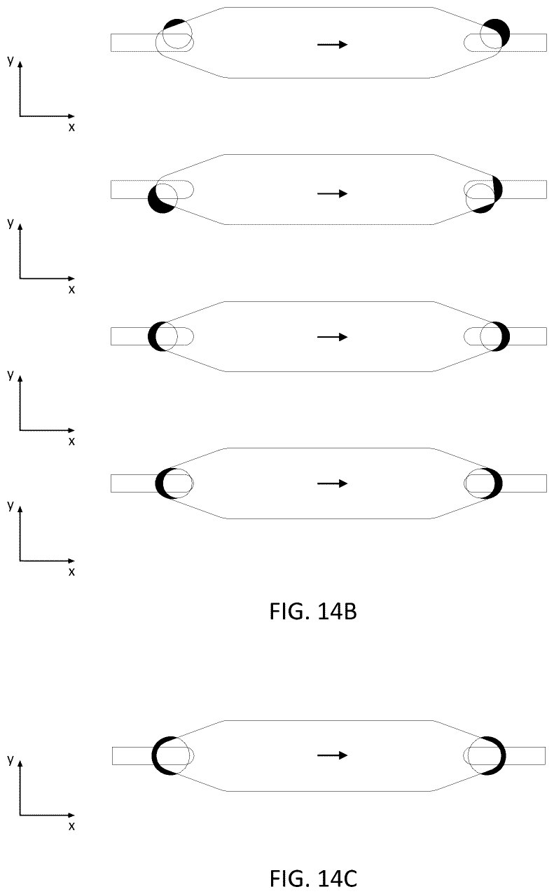

Each aperture 142 in the flow cell strip 140 partially defines a corresponding measurement chamber 610 (shown schematically in FIG. 14A) of the cartridge 100. In particular, each aperture 142 defines the interior walls of the measurement chamber 610. The height of the measurement chamber 610 is therefore defined by the thickness of the flow cell strip 140. The upper interior surface of each measurement chamber 610 is provided by the sealing layer 400. The lower interior surface of each measurement chamber 610 is provided by a sensor surface comprising one or more electrodes (not shown) and a dielectric layer (not shown) of the sensor strip 150 (as shown in FIG. 2). The boundary of each aperture 142 therefore provides the perimeter of a corresponding measurement chamber 610, meaning that the apertures 142 define the areas of the measurement chambers 610.

As shown in FIG. 13, each aperture 142 of the flow cell strip 140 is accessible from the channels 304 in the fluidic layer 300 (shown in FIG. 17) through a corresponding pair of vias (i.e. holes) 404 in the sealing layer 400. Each of the corresponding pair of vias 404 is aligned with one end of a corresponding channel 304 in the fluidic layer 300. This means that each pair of vias 404 is provided in the upper interior surface of a corresponding measurement chamber 610.

FIG. 13 further shows that the sealing layer 400 comprises a plurality of adhesive-free regions 406 (i.e. the twelve circles underlying each of the valve regions 302). By providing adhesive-free regions 406 on the top side of the sealing layer 400, beneath the valve regions 302, the channels 304 do not adhere to the sealing layer 400 when forces are applied to the valve regions 302. Consequently, the adhesive-free regions 406 prevent the valves from remaining closed once the forces are removed, or from opening slowly once the forces are removed.

It will be appreciated that the sealing layer 400 also includes waste holes (not shown) that are aligned with the channels 304 in the fluidic layer 300 that provide a fluidic connection to the waste chambers 508 in the second part. For example, with reference to FIG. 17B, the sealing layer 400 may include waste holes that are aligned with the end of the fifteenth channel 304o and the end of the eighteenth channel 304r.

FIGS. 14A to 14C show how the amount of liquid remaining after emptying of a measurement chamber varies with (i) varying the angle of an outlet conduit; (ii) misalignment of vias with the ends of the measurement chamber; and (iii) varying the size of the vias.

The measurement chambers 610 in FIGS. 14A to 14C include three portions, as shown schematically in FIG. 14A: a first tapering portion 614a, extending from the rounded first end 612a; a second tapering portion 614b, that tapers to the rounded second end 612b; and a non-tapering central portion 612c of constant cross-section, that extends between the first tapering portion 614a and the second tapering portion 614b.

The first tapering portion 614a has a taper angle defined between a wall of the measurement chamber 610 (i.e. the perimeter of the corresponding aperture 142) and a longitudinal centreline through the measurement chamber 610. Likewise, the second tapering portion 614b has a taper angle defined between a wall of the measurement chamber 610 and a longitudinal centreline through the measurement chamber 610. The taper angles of the first and second tapering portions 614a, 614b are preferably less than 30 degrees, as higher taper angles result in the formation of air bubbles during filling or emptying of the measurement chamber 610, and result in residual liquid remaining after emptying of the measurement chamber 610. Taper angles of less than 30 degrees are also preferred because there is no expansion of the flow in the fluidic layer 300. As shown in FIG. 14A, the conduits 600 in the fluidic layer 300 are of fixed width, meaning that there is no expansion of the flow in the fluidic layer 300. Instead, the fluid flow expands outwardly once the fluid reaches the measurement chamber 610. Taper angles of less than 30 degrees reduce the likelihood of bubble formation occurring as a result of the flow expansion in the measurement chamber 610 (which may occur, for example, at higher taper angles such as 45 degrees). It will be appreciated that very low taper angles are not desirable, because these result in a smaller footprint of the measurement chamber 610 (for a given length of measurement chamber), resulting in a smaller contact area with the electrodes of the sensor strip 150. In light of these considerations, a preferred range of taper angles for the first and second tapering portions 614a, 614b is between 15 and 25 degrees. Taper angles of less than 25 degrees further reduce the likelihood of bubble formation occurring as a result of the flow expansion in the measurement chamber 610.

The rounded ends 612 of the measurement chamber 610 each have a constant curvature. The curvature of each of the rounded ends 612 can therefore be defined in terms of an origin of curvature and a constant radius of curvature. In other words, each rounded end 612 of the measurement chamber 610 is provided in the form of an arc of a circle, with a particular radius. In one exemplary implementation, the radius of the rounded first end 612a is 0.5 mm and the radius of the rounded second end is 0.5 mm.

FIG. 14A also schematically shows an inlet conduit 600a and the outlet conduit 600b, each defined by corresponding channels 304 in the second surface 310 that are sealed by the sealing layer 400. In addition, FIG. 14A schematically shows the pairs of vias 404 that permit liquid flow into and out of the measurement chamber 610. One of each pair of vias 404 is aligned with the rounded first end 612a of the measurement chamber 610, while the other one of the pair of vias 404 is aligned with the rounded second end 612b of the measurement chamber 610. Therefore, the inlet conduit 600a is in fluidic communication with the rounded first end 612a and the outlet conduit 600b is in fluidic communication with the rounded second end 612b. In the examples shown in FIG. 14A, the conduits 600 have a smaller width than the vias 404, and the vias 404 are aligned with the rounded ends 612 of the measurement chamber 610.

The outlet conduit angles in FIG. 14A are defined between a centreline through the outlet conduit 600b and a centreline through the measurement chamber 610. FIG. 14A shows how varying the outlet angle affects emptying of the measurement chamber 610. Reducing the volume of liquid remaining in the measurement chamber 610 is desirable because any remaining liquid in the measurement chamber 610 may affect measurements carried out on liquids that are subsequently introduced into the measurement chamber 610. For example, the remaining liquid may react with the subsequent liquid, or may otherwise contaminate the subsequent liquid. In one implementation, air is supplied to the measurement chamber 610 (e.g. via the pneumatic actuator 710), in order to force liquid out of the measurement chamber 610.

Five outlet conduit angles are shown in FIG. 14A: 0 degrees, 45 degrees, 90 degrees, 135 degrees, and 180 degrees. With an angle of 0 degrees, liquid flows through the measurement chamber 610, enters the outlet conduit 600b through the corresponding via 404, and subsequently flows in a direction opposite to the direction of flow through the measurement chamber 610. With an angle of 180 degrees, liquid flows through the measurement chamber 610, enters the outlet conduit 600b through the corresponding via 404, and subsequently flows in the same direction as the direction of flow through the measurement chamber 610.

With outlet conduit angles of 45 degrees, 90 degrees, or 135 degrees, the angle of the outlet conduit 600b results in a stagnation region (indicated in black in FIG. 14A), where the footprint of the measurement chamber 610 extends beyond the footprint of the outlet conduit 600b. The stagnation region occurs as a result of the smaller size of the outlet conduit 600b compared with the vias 404. The stagnation region results in liquid becoming trapped within the measurement chamber 610 (i.e. trapped in the flow cell layer 140), because any liquid in the stagnation region cannot be pushed out through the outlet conduit 600b under pressure. In contrast, with outlet conduit angles of 0 degrees and 180 degrees, the end points of the measurement chamber 610 in the x-direction overlap with the footprint of the outlet conduit 600b. This means that no part of the measurement chamber 610 extends beyond the footprint of the outlet conduit 600b, allowing a greater proportion of the liquid to be pushed out through the outlet conduit 600b under pressure. Therefore, of the five outlet conduit angles shown in FIG. 14A, outlet conduit angles of 0 degrees and 180 degrees result in the lowest volume of liquid remaining in the measurement chamber 610 after clearing the measurement chamber 610 with air.

Experimental data has been shown to verify the improved performance at outlet conduit angles of 0 degrees and 180 degrees, while also showing that lower remaining volumes of liquid are achieved with outlet conduit angles of at least 150 degrees. Accordingly, it is preferable for the outlet conduit 600b to be aligned with the measurement chamber 610 (i.e. aligned with a longitudinal centreline through the measurement chamber 610). In particular, it is preferable for the outlet conduit angle to be greater than or equal to 150 degrees, to minimise the volume of liquid remaining in the measurement chamber 610. More preferably, the outlet conduit angle is approximately 180 degrees, in order to reduce the loss of particles in flow suspensions (e.g. blood or functionalised particles/beads) that flow through the measurement chambers 610. Alternatively, an outlet conduit angle of 0 degrees can be implemented, to reduce the volume of liquid remaining in the measurement chamber 610 and vias 404.

FIG. 14B shows how misalignment of the measurement chamber 610 and the vias 404 affects the volume of liquid remaining in the measurement chamber 610. For the measurement chambers shown in FIG. 14B, the diameter of the vias 404 is 1 mm and each rounded end 612 has a constant curvature with a diameter of 1 mm (0.5 mm radius). Misalignment of the vias 404 and the rounded ends 612 results in liquid becoming trapped within the vias 404 (i.e. within the sealing layer 400).

The liquid remaining in the measurement chambers 610 and vias 404 is illustrated as areas filled in black.

The uppermost measurement chamber in FIG. 14B shows the effect of a +0.25 mm misalignment of the vias 404 in each of the x- and y-directions. The second measurement chamber in FIG. 14B shows the effect of a −0.25 mm misalignment of the vias 404 in each of the x- and y-directions. The third measurement chamber in FIG. 14B shows the effect of a 0.25 mm misalignment of the vias 404 in the x-direction outwards from the measurement chamber (i.e. a −0.25 mm misalignment of the inlet via in the x-direction, and a +0.25 mm misalignment of the outlet via in the x-direction). The lowermost measurement chamber in FIG. 14B shows the effect of a −0.25 mm misalignment of the vias 404 in the x-direction inwards towards the measurement chamber (i.e. a +0.25 mm misalignment of the inlet via in the x-direction, and a −0.25 mm misalignment of the outlet via in the x-direction).

The uppermost measurement chamber in FIG. 14B shows that, as a result of the misalignment of the vias 404 and the rounded ends 612 of the measurement chamber 610, there are stagnation regions within the vias 404 (specifically, in the regions of the vias 404 that do not overlap the footprint of the measurement chamber 610).

A similar effect is shown in the second measurement chamber in FIG. 14B. However, the negative misalignment of the outlet via in the x-direction results in an additional stagnation region within the measurement chamber 610 (i.e. within the flow cell layer 140). This additional stagnation region arises because the footprint of the measurement chamber 610 extends beyond the outlet via in the x-direction. As a result of the additional stagnation region, more liquid remains within the second measurement chamber in FIG. 14B than the uppermost measurement chamber in FIG. 14B.

The third measurement chamber in FIG. 14B results in stagnation regions within the vias 404, because the vias 404 extend beyond the footprint of the measurement chamber 610 (as with the uppermost measurement chamber in FIG. 14B).

The fourth measurement chamber in FIG. 14B does not result in stagnation regions within the vias 404, because the vias 404 fall within the measurement chamber footprint. However, as the measurement chamber footprint extends beyond both vias 404 in the x-direction, two stagnation regions form within the measurement chamber 610 (i.e. at both ends of the measurement chamber 610).

Each of the hypothetical misalignments shown in FIG. 14B illustrates that any misalignment of the vias 404 and the measurement chamber 610 results in liquid remaining in the measurement chamber 610 and/or vias 404 after clearing the flow cell using air. The misalignments shown in FIG. 14B also result in steps for liquid to flow out of the measurement chamber 610 (i.e. a first step between the measurement chamber 610 and the outlet via, and a second step between the outlet via and the outlet conduit 600b). The steps can result in liquid breakage when clearing the measurement chamber 610, which leads to liquid falling back into the measurement chamber 610. Any liquid retained at the exit from the measurement chamber 610 is problematic because it can result in bubble formation when the measurement chamber 610 (which is now a wetted surface) is subsequently filled with a different liquid. This occurs when the meniscus of the subsequent liquid joins to the liquid retained in the measurement chamber 610, trapping an air bubble. The air bubble can interfere with measurements carried out on the solution in the measurement chamber 610. For example, an electrochemical measurement may provide an incorrect reading if an air bubble is positioned on one of the electrodes within the measurement chamber 610.

Preferably, therefore, one or both of the vias 404 is aligned with the curvature of the corresponding rounded end(s) 612 of the measurement chamber 610, such that there is no misalignment between the via(s) 404 and the measurement chamber 610. In other words, the origin of the one or both of the vias 404 is preferably coincident with the origin of the curvature of the corresponding rounded end(s) 612.

FIG. 14C shows the effect of varying the diameter of the vias 404 in the case where the vias 404 have a diameter (or radius) larger than the diameter (or radius) of the curvature of the corresponding rounded end(s) 612 of the measurement chamber 610. For the measurement chamber shown in FIG. 14C, each rounded end 612 has a constant curvature with a diameter of 1 mm and the vias 404 have a diameter of 1.3 mm.

FIG. 14C shows that the larger diameter of the vias 404 results in stagnation regions (indicated in black) where the vias 404 extend beyond the footprint of the measurement chamber 610. This is similar to the effect shown in the third measurement chamber in FIG. 14B. It will be appreciated that decreasing the diameter of the vias 404 relative to the curvatures of the rounded ends 612 may also result in stagnation regions (within the measurement chamber 610), if the footprint of the measurement chamber 610 extends beyond the vias 404 in the x-direction (i.e. similar to the effect shown in the lowermost measurement chamber in FIG. 14B).

Accordingly, it can be seen from FIG. 14C that increasing the diameter of the vias 404 relative to the curvature diameter of the rounded ends 612 of the measurement chamber 610 increases the volume of liquid remaining in the vias 404 (as a result of the stagnation regions within the vias 404). Decreasing the diameter of the vias 404 relative to the curvature diameter of the rounded ends 612 of the measurement chamber 610 has a similar effect (as a result of stagnation regions within the measurement chamber 610). It is therefore preferable for the diameter (or radius) of one of both of the vias 404 to be equal to the diameter (or radius) of the curvature of the corresponding rounded end(s) 612 of the measurement chamber 610.

FIG. 15 is an exploded view showing the fluidic layer 300 and an alternative sealing layer 450. The sealing tape 130 that seals the chambers 332 in the fluidic layer 300 can also be seen in FIG. 15.

As with the sealing layer 400 shown in FIG. 13, the sealing layer 450 includes a hole 452 that provides for fluidic communication between the metering chamber 232 (provided in the first part 200) and the metering chamber outlet channel 502 (provided in the second part 500). In addition, the sealing layer 450 includes a waste outlet 451 that provides for fluidic communication between the sample adequacy control chamber 236 and the first well 504 (defining the sample waste chamber). The sealing layer 450 also includes a plurality of apertures 454, each of which defines in part a corresponding measurement chamber 610 of the cartridge 100. The apertures 454 provide the same function as the apertures 142 in the sealing strip 140, except that the apertures 454 are provided in the sealing layer 450. Accordingly, in the implementation shown in FIG. 15, the sealing layer 450 does not include vias for fluidic communication with the measurement chambers 610, and no separate flow cell strip is required.

Implementing vias 404 between the inlet and outlet conduits 600a, 600b and the measurement chamber 610 can cause flow impedances in the event of any misalignment between the vias 404 and the measurement chamber 610. The flow impedances result in back pressures, which provide regions where residual liquid remains. As explained above, residual liquid in the measurement chamber 610 is undesirable because it causes contamination.

The flow impedances provided by the vias are caused by step-like effects between the measurement chamber 610, the thickness of the sealing layer 400 (in which the vias 404 are provided), and the conduits 600a, 600b. These step-like effects result in non-smooth flow, which causes liquid to remain in the measurement chamber 610.

The implementation of a sealing layer 450 without vias reduces the tendency for liquid to remain in the measurement chamber 610, by removing the constriction provided by the vias and reducing the step-like effects between the measurement chamber 610 and the conduits 600a, 600b.

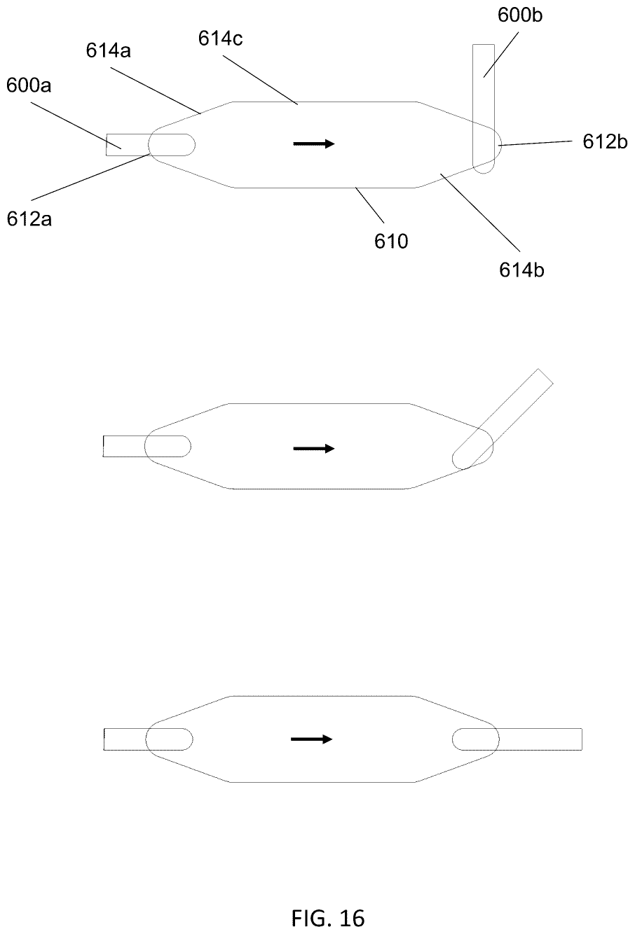

FIG. 16 schematically shows an implementation of measurement chambers 610 without vias. In this implementation, the inlet conduit 600a (provided by one of the channels 304 in the second surface 310 of the fluidic layer 300 and sealed by the sealing layer 450) overlaps the first end 612a of the measurement chamber 610, while the outlet conduit 600b overlaps the second end 612b of the measurement chamber 610. As the aperture 454 is provided in the sealing layer 450, the area of the aperture 454 defines a region in which the conduits 600a, 600b are not sealed. This means that the inlet and outlet conduits 600a, 600b are in direct fluidic communication with the measurement chamber 610.

FIG. 16 also shows three possible outlet conduit angles: 90 degrees, 135 degrees, and 180 degrees. A preferred configuration of the measurement chambers 610 shown in FIG. 16 is for the inlet and outlet conduits 600a, 600b to be aligned with the flow direction (i.e. an outlet conduit angle of preferably at least 150 degrees, and more preferably approximately 180 degrees). In other words, it is preferable for the inlet and outlet conduits 600a to be aligned with a longitudinal centreline through the measurement chamber 610. This reduces the loss of particles in flow suspensions (e.g. blood or functionalised particles/beads) that flow through the measurement chambers 610.

In addition, FIG. 16 shows the first tapering portion 614a, second tapering portion 614b, and central portion 614c of the measurement chamber 610. Preferred angles of the tapering portions 614a, 614b are the same as described with reference to FIG. 14.

FIGS. 17A and 17B depict an underside view of the fluidic layer 300, showing the second surface 310 of the fluidic layer 300 that is opposite to the first surface 308. The valve regions 302, pneumatic ports 312 (including projections 314 and support ribs 318) and projection 330 on the first surface 308 are all indicated in dashed lines in FIG. 17A. FIG. 17A also shows the openings 316 of the ports 312 and the openings 350, each of which extends through the thickness of the fluidic layer 300. FIG. 17B identifies the specific conduits 304 in the second surface 310 and junctions 306 between the conduits 304.

Each of the valve regions 302 allows the flow of fluid through one of the conduits 600 of the cartridge 100 to be controlled. Each valve is defined by one of the valve regions 302 (each of which is disposed above a corresponding channel 304) and the sealing layer 400 that seals the corresponding channel 304. To close a valve, a force is applied to the valve region 302 (e.g. as shown in FIG. 21) to compress the corresponding channel 304 against the sealing layer 400. Closing a valve prevents fluid flow through the corresponding conduit 600. To open a valve, the force applied to the valve region 302 to close the valve is withdrawn. Opening a valve permits fluid flow through the corresponding conduit 600.

Fluid flow through the conduits 600 is controlled by application of variable pressure to the pneumatic ports 312. As described in more detail below, each of the pneumatic ports 312 can either: (i) receive a positive pressure via a corresponding pneumatic actuator 710; (ii) receive a negative pressure via the corresponding pneumatic actuator 710; (iii) be vented (i.e. opened to atmospheric pressure) via the corresponding pneumatic actuator 710; or (iv) be closed (i.e. unvented), meaning that the pneumatic port 312 is disconnected from the pneumatic actuator 710. In case (iv), there is no air flow through the pneumatic port 312.

As described below, a number of the channels 304 in the fluidic layer extend from a point in the fluidic layer that overlies one of the troughs 514 in the second part 500. This means that, for example, a positive pneumatic pressure is applied to the first pneumatic port 312a by a pneumatic actuator 710. The pressurised air flows through the corresponding opening 316 in the first pneumatic port 312a, through a corresponding hole in the sealing layer 400, through the channel 518a in the first port support 516a, through the trough 514a, and into one of the channels 304 (specifically, the second channel 304b, the third channel 304c or the fourth channel 304d, using the channel numbering shown in FIG. 17B). A negative pressure is applied in the same way, but with opposite air flow.

This arrangement reduces the risk of liquid being drawn into a pneumatic actuator 710 (e.g. during application of a negative pressure to aspirate liquid). This is because any liquid that is drawn through the channel 304 falls to the bottom of the trough 514a under gravity. As shown in FIG. 10, the channel 518a is on the flat upper surface of the port support 516a, meaning that the channel 518a is disposed above the base of the trough 514a. Therefore, any pooled liquid in the trough 514a is not drawn through the channel 518a and into the pneumatic actuator 710 via the first pneumatic port 312a.

The fluidic layer 300 includes the following channels 304 described in the paragraphs below, with reference to FIGS. 17A and 17B.

A first channel 304a extends from a point overlying the hole 402 in the sealing layer 400 (or the hole 452 in the sealing layer 450). Accordingly, the first channel 304a provides a fluidic connection to the metering chamber outlet channel 502 in the second part (via the hole 402/452). The first channel 304a extends from this point to a point overlying a first measurement chamber. The first channel 304a provides an inlet to the first measurement chamber. Fluid flow through the first channel 304a is controlled by a third valve region 302c.

A second channel 304b extends from a point overlying the first trough 514a to a third opening 350c. The third opening 350c provides an inlet to a liquid storage capsule 120 overlying openings 350c and 350d.

A third channel 304c extends from a point overlying the first trough 514a to a second opening 350b. The second opening 350b provides an inlet to a liquid storage capsule 120 overlying openings 350a and 350b.

A fourth channel 304d extends from a point overlying the first trough 514a to a first junction 306a with a nineteenth channel 304s (described below). Fluid flow through the fourth channel 304d is controlled by a second valve region 302b.

A fifth channel 304e extends from a point overlying the second trough 514b to a first chamber 332a defined by the projection 330. Fluid flow through the fifth channel 304e is controlled by a sixth valve region 302f.

A sixth channel 304f extends from a point overlying the third trough 514c to an eighth opening 350h. The sixth channel 304f provides an inlet to a liquid storage capsule overlying a sixth opening 350f and the eighth opening 350h.

A seventh channel 304g extends from a point overlying the third trough 514c to a fourth chamber 332d defined by the projection 330. Fluid flow through the seventh channel 304g is controlled by an eleventh valve region 302k.

An eighth channel 304h extends from a point overlying the third trough 514c to a seventh opening 350g. The eighth channel 304h provides an inlet to a liquid storage capsule 120 overlying a fifth opening 350e and the seventh opening 350g.

A ninth channel 304i extends from a fourth opening 350d to a second junction 306b with the first channel 304a. Liquid expelled from a liquid storage capsule 120 overlying openings 350c and 350d flows through the conduit 600 defined by the ninth channel 304i. Fluid flow through the ninth channel 304i is controlled by a fourth valve region 302d.

A tenth channel 304j extends from a first opening 350a to a third junction 306c with a sixteenth channel 304p (described below). Liquid expelled from a liquid storage capsule 120 overlying openings 350a and 350b flows through the conduit 600 defined by the tenth channel 304j. Fluid flow through the tenth channel 304j is controlled by a first valve region 302a.

An eleventh channel 304k extends from a sixth opening 350f to a fourth junction 306d with the fourth channel 304d. Liquid expelled from a liquid storage capsule 120 overlying openings 350f and 350h flows through the conduit 600 defined by the eleventh channel 304k. Fluid flow through the eleventh channel 304k is controlled by a seventh valve region 302g.

A twelfth channel 304l extends from a fifth opening 350e to a fifth junction 306e with the fourth channel 304d. Liquid expelled from a liquid storage capsule 120 overlying openings 350e and 350g flows through the conduit 600 defined by the twelfth channel 304l. Fluid flow through the twelfth channel 304l is controlled by a fifth valve region 302e.

A thirteenth channel 304m extends between a second chamber 332b defined by the projection 330 and a third chamber 332c defined by the projection 330.

A fourteenth channel 304n extends from a sixth junction 306f with the first channel 304a to a seventh junction 306g with the thirteenth channel 304m. Fluid flow through the fourteenth channel 304n is controlled by an eighth valve region 302h.

A fifteenth channel 304o extends from a point overlying the first measurement chamber to a point overlying the second waste chamber 508b. The fifteenth channel 304o provides an outlet from the first measurement chamber, and an inlet to the second waste chamber 508b. Fluid flow through the fifteenth channel 304o is controlled by a twelfth valve region 302l.

A sixteenth channel 304p extends from a point overlying a second measurement chamber to an eighth junction 306h with the fifteenth channel 304o. The sixteenth channel 304p provides an outlet from the second measurement chamber.

A seventeenth channel 304q extends from a point overlying a third measurement chamber to a point overlying the second measurement chamber. The seventeenth channel 304q provides an outlet from the third measurement chamber and an inlet to the second measurement chamber.

An eighteenth channel 304r extends from a ninth junction 306i with the seventeenth channel 304q to a point overlying the first waste chamber 508a. The eighteenth channel 304r provides an inlet to the first waste chamber 508a. Fluid flow through the eighteenth channel 304r is controlled by a tenth valve region 302j.

A nineteenth channel 304s extends from the second chamber 332b defined by the projection 330 to a point overlying the third measurement chamber. The nineteenth channel 304s provides an inlet to the third measurement chamber. Fluid flow through the nineteenth channel 304s is controlled by a ninth valve region 302i.

FIG. 17C is a top view of the fluidic layer 300, showing the first surface 308. FIG. 17C shows the locations of the valve regions 302, ports 312 (including protrusions 314, openings 316 and support ribs 318), projection 330 (including chambers 332a to 332d) and openings 350. It will be appreciated that the lateral order of the valve regions 302 and openings 350 in FIG. 17C is reversed when compared with FIG. 17A, because FIG. 17C shows a top view of the first surface 308, whereas FIG. 17A shows an underside view of the second surface 310. As explained above, openings 350 and openings 316 extend through the thickness of the fluidic layer 300.

The junctions 306 can provide known locations for liquid fronts within the fluidic layer 300. For example, by aspirating liquid to the second waste chamber 508b (via the first channel 304a and the fifteenth channel 304o), there is a known liquid front at the sixth junction 306f. With knowledge of the liquid front, liquid can be metered (e.g. into one of the chambers 332). For example, a known pressure difference can be implemented via the pneumatic ports 312, in order to meter the liquid from the sixth junction 306f to a predetermined fill level within the second chamber 332b or the third chamber 332c. The pressure difference can be calculated based on the desired fill level (i.e. the volume to be metered), and the volume of the conduit 600 defined by the channel 304 between the junction 306 and the chamber (in this example, the volume of the fourteenth channel 304n).

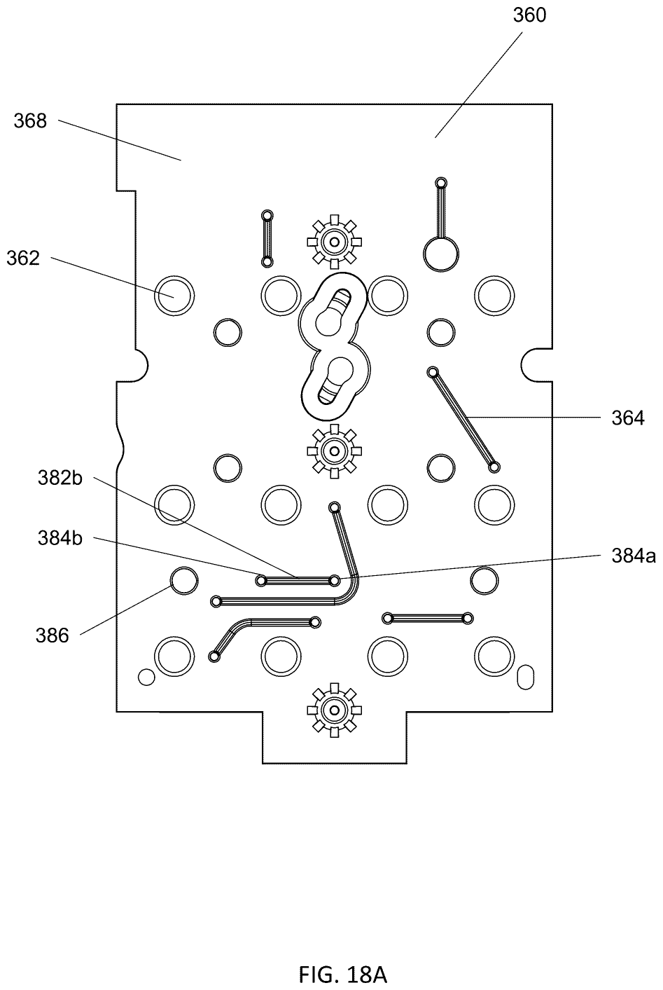

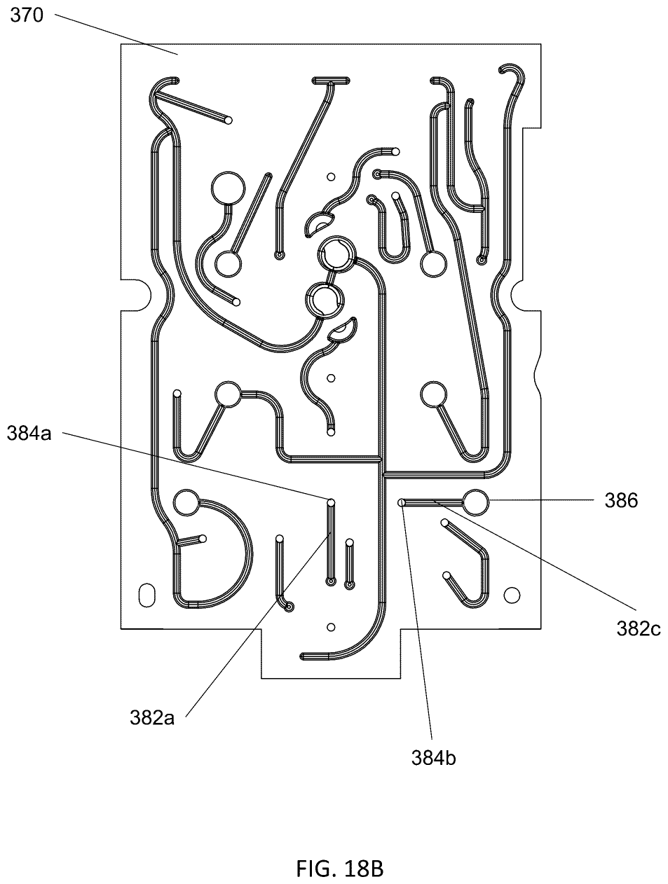

In an alternative implementation of the fluidic layer, shown in FIGS. 18A and 18B, channels 364 are provided in both a first surface 368 and a second surface 370 of an alternative fluidic layer 360. Configuring a network of fluidic channels in a limited amount of space is challenging. Point-of-care devices are designed to be small, which limits the real estate available on the fluidic layer 300 for laying down the channels with respective bonding areas around them (i.e. for bonding to the sealing layer 400). Implementing channels 364 on both surfaces 368, 370 of the fluidic layer 360 allows, for example, channels 364 used for transporting air (e.g. for clearing the measurement chambers, or for displacing liquid from liquid storage capsules 120) to be moved to the first surface 368, without affecting liquid flow. Providing channels 364 in the first surface 368 also allows the channels 364 of the fluidic layer 360 to cross over, meaning that more complex networks of channels 364 may be implemented.

In the alternative implementation of the fluidic layer 360, valve regions 362 are still provided in the first surface 368 of the fluidic layer 360. Accordingly, the channels 364 in the first surface 368 are either channels 364 that do not pass under a valve region 362 (e.g. channels 304b, 304c, 304f, 304h in FIG. 17B), or channels 364 that have a first portion in the first surface 368 and a second portion in the second surface 370. For example, the second portion of the channel 364 may be a portion of the channel 364 that passes under a valve region 362. The two portions of these channels 364 may be connected by vertical or angled conduits running through the thickness of the fluidic layer 360.

Referring to the example shown in FIG. 17B, the second channel 304b, third channel 304c, sixth channel 304f, and eighth channel 304h are all examples of channels 304 that may be moved to the second surface 310 of the fluidic layer 300. This is because each of these channels 304 does not pass under a valve region 302 and is used for transporting air. The fifth channel 304e and the seventh channel 304g are both examples of channels that may have a first portion in the first surface 308 and a second portion in the second surface 310. For example, the portion of the fifth channel 304e between the point overlying the second trough 514b and a point downstream of the sixth valve region 302f could be provided in the second surface 310, allowing fluid flow through this portion to be controlled by the sixth valve region 302f. The remaining portion of the fifth channel 304e, between the point downstream of the sixth valve region 302f and the first chamber 332a, could be provided in the first surface 308. Of course, in such an implementation, the fifth channel 304e would include conduit sections through the fluidic layer 300, in order to connect the two portions of the fifth channel 304e.

Referring back to FIGS. 18A and 18B, various examples of channels 364 with portions in both surfaces 368, 370 are shown. For example, channel 364a in FIGS. 18A and 18B includes a first portion 382a provided in the second surface 370, a second portion 382b provided in the first surface 368, and a third portion 382c provided in the second surface 370. The first portion 382a extends between a point overlying the first trough 514a to a first through-hole 384a in the fluidic layer 360. The second portion 382b extends between the first though-hole 384a and a second through-hole 384b in the fluidic layer 360. The third portion 382c extends between the second through-hole 384b and an opening 386 over which a liquid storage capsule 120 may be disposed, when a cartridge 100 comprising the fluidic layer 360 is assembled. By providing portions of the channel 364a in both surfaces 368, 370, the channel 364b can cross over the channel 364a (as shown in FIG. 18B).

FIG. 19A is a cross-section through the fluidic layer 300 along line A-A in FIG. 17C. FIG. 19A shows that the valve regions 302 are provided as circular depressions in the first surface 308 of the fluidic layer 300. In other words, the fluidic layer 300 has a reduced thickness in each of the valve regions 302. As shown in FIG. 19A, a chamfered annular surface is provided between the thickness of the fluidic layer 300 and the valve regions 302 of reduced thickness. The protrusions 314 and support ribs 318 of the first pneumatic port 312a can also be seen from FIG. 19A.

As described above, fluid flow through conduits 600 defined by the channels 304 is controlled by applying a force to the valve regions 302. To allow fluid flow to be controlled, the valve regions 302 are provided directly above the channels 304 that they control fluid flow through. Specifically, FIG. 19A shows the fourth valve region 302d provided directly above the ninth channel 304i, the third valve region 302c provided directly above the first channel 304a, the second valve region 302b provided directly above the fourth channel 304d, and the first valve region 302a provided directly above the tenth channel 304j. FIG. 19A also shows cross-sections through channels 304b and 304c, which are not compressed when forces are applied to the valve regions 302a, 302b, 302c and 302d.

FIG. 19B is a cross-section through the fluidic layer 300 along line B-B in FIG. 17C. Specifically, FIG. 19B shows the eighth valve region 302h provided directly above the fourteenth channel 304n, the seventh valve region 302g provided directly above the eleventh channel 304k, the sixth valve region 302f provided directly above the fifth channel 304e, and the fifth valve region 302e provided directly above the twelfth channel 304l. FIG. 19B also shows cross-sections through channels 304a, 304d and 304j, which are not compressed when forces are applied to the valve regions 302e, 302f, 302g and 302h.

FIG. 19C is a cross-section through the fluidic layer 300 along line C-C in FIG. 17C. This cross-section passes through the fourth chamber 332d defined by the projection 330 extending from the first surface 308 of the fluidic layer 300. The seventh channel 304g, which extends between a point above the third trough 514c to the fourth chamber 332d, can also be seen in FIG. 19C. FIG. 19C also shows the twelfth valve region 302l provided directly above the fifteenth channel 304o, the eleventh valve region 302k provided directly above the seventh channel 304g, the tenth valve region 302j provided directly above the eighteenth channel 304r, and the ninth valve region 302i provided directly above the nineteenth channel 304s. In addition, FIG. 19C shows cross-sections through channels 304a, 304f, 304h and 304j, which are not compressed when forces are applied to the valve regions 302i, 302j, 302k and 302l.

FIG. 19D is a cross-section through the fluidic layer 300 along line D-D in FIG. 17C. FIG. 19E shows the circled portion of the cross-section in FIG. 19D in greater detail. Specifically, FIGS. 19D and 19E show cross-sections through the projection 330 that extends from the first surface 308 of the fluidic layer 300. FIGS. 19D and 19E also show cross-sections through the second pneumatic port 312b and the third pneumatic port 312c. The openings 316 that extend through these ports 312 and through the thickness of the fluidic layer 300 can also be seen in these figures, as indicated specifically in FIG. 19E.

The projection 330 defines four chambers 332. As described in the following paragraphs, each of the chambers 332 is in fluidic communication with a conduit 600 of the cartridge 100. The chambers 332 allow for mixing of fluids, which is controlled by application of pneumatic pressures to the chambers 332 via the channels 304.

A first chamber 332a is in selective fluidic communication with the second pneumatic port 312b via: the fifth channel 304e, which connects to the first chamber 332a, the second trough 514b, the second channel 518b in the second port support 516b, and the opening 316 extending through the second pneumatic port 312b. The fluidic communication between the first chamber 332a and the second pneumatic port 312b is selective because it is controlled by application of force to the sixth valve region 302f.

A second chamber 332b is in selective fluidic communication with the third measurement chamber via the nineteenth channel 304s. The fluidic communication between the second chamber 332b and the third measurement chamber is selective because it is controlled by application of force to the ninth valve region 302i. The second chamber 332b is also in selective fluidic communication with: (i) the first pneumatic port 312a, via the fourth channel 304d (controlled by the second valve region 302b); (ii) the fifth opening 350e, via the twelfth channel 304| (controlled by the fifth valve region 302e); and (iii) the sixth opening 350f, via the eleventh channel 304k (controlled by the seventh valve region 302g).

A third chamber 332c is in fluidic communication with the second chamber 332b via the thirteenth channel 304m. The thirteenth channel 304m allows liquid to be transferred between the second and third chambers 332b, 332c (for example, to allow mixing of liquids).

A fourth chamber 332d is in selective fluidic communication with the third pneumatic port 312c via: the seventh channel 304g, which connects to the fourth chamber 332d, the third trough 514c, the third channel 518c in the third port support 516c, and the opening 316 extending through the third pneumatic port 312c. The fluidic communication between the fourth chamber 332d and the third pneumatic port 312c is selective because it is controlled by application of force to the eleventh valve region 302k.

The first chamber 332a is in fluidic communication with the second chamber 332b via a first opening 334a at the top of the wall 336a separating the first chamber 332a from the second chamber 332b. The fluidic communication provided by the first opening 334a allows fluid to be moved into the second chamber 332b (e.g. from the third chamber 332c) by, for example, application of a negative pressure from the second pneumatic port 312b via the first chamber 332a. Likewise, the fluidic communication provided by the first opening 334a allows fluid to be moved out of the second chamber 332b (e.g. to the third chamber 332c) by, for example, application of a positive pressure from the second pneumatic port 312b via the first chamber 332a. The first opening 334a is located at the top of the wall 336a in order to maximise the volume of liquid that can be held within the second chamber 332b, thereby reducing the likelihood of liquid flowing through the first opening 334a and into the first chamber 332a.

Similarly, the fourth chamber 332d is in fluidic communication with the third chamber 332c via a second opening 334b at the top of the wall 336b separating the third chamber 332c from the fourth chamber 332d. This allows fluid to be moved into or out of the third chamber 332c by application of a variable pressure from the third pneumatic port 312c via the fourth chamber 332d.

FIG. 20 is a further cross-section through the protrusion 330, showing a solid reagent 170 disposed within the third chamber 332c. The solid reagent 170 may be a lyophilised reagent. The solid reagent 170 may be suspended in a liquid solution by moving liquid into the third chamber 332c. Given that the outlet from the third chamber 332c (i.e. thirteenth channel 304m) is provided in the second surface 310 of the fluidic layer 330, the outlet from the third chamber 332c is provided at the base of the third chamber 332c. Providing the outlet from the third chamber 332c at the base of the chamber maximises the amount of resuspended or dissolved reagent that can be extracted from the third chamber 332c, because any undissolved solid reagent falls to the base of the third chamber 332c under gravity and is subsequently suspended or dissolved. Consequently, a significant proportion of the solid reagent 170 (e.g. substantially all of the solid reagent 170) can be utilised. Liquid may be repeatedly transferred between the second chamber 332b and the third chamber 332c via thirteenth channel 304m in order to resuspend and homogenise the solid reagent 170.

In other words, disposing the solid reagent 170 in a chamber with an outlet at its base minimises the likelihood of unsuspended solid reagent being trapped within the fluidic network and consequently unutilised. As a high proportion of the solid reagent 170 can be utilised, smaller solid reagents can be utilised, compared with prior point-of-care devices that incorporate solid reagents.

FIG. 21 is a section view through one of the valve regions 302 of the fluidic layer 300. FIG. 21 shows the fluidic layer 300, the sealing layer 400 that seals the channels 304 in the second surface 310 of the fluidic layer 300 to form conduits 600, and the second part 500 (specifically, a valve support region 524 of the second part 500).

FIG. 21 shows the reduced thickness of the valve region 302 compared with the thickness of the remainder of the fluidic layer 300. The chamfered annular surface between the thickness of the fluidic layer 300 and the valve regions 302 of reduced thickness can also be seen. The reduced thickness of the fluidic layer 300 in the valve region 302 means that the valve region 302 can be more easily compressed in order to close the corresponding conduit 600 disposed beneath the valve region 302.

FIG. 21 also shows that the distance between the top of the channel 304 and the valve region 302 is defined by a height, H. The height, H, is dependent on the properties (e.g. hardness) of the material used for the fluidic layer 300 and the available force from a valve actuator 700. In addition, the channel 304 includes a radius, R, which provides a fillet between the channel 304 and the second surface 310 of the fluidic layer 300. By providing a fillet radius, R, the force required to close the valve defined by the valve region 302 is reduced.

As shown in FIG. 21, a force is applied to the valve region 302 by a valve actuator 700, in order to close the conduit 600. The elastomeric properties of the fluidic layer 300 allow for deformation of the fluidic layer 300 in the valve regions 302, in order to close the conduits 600. The elastomeric properties of the fluidic layer 300 also allow the valve regions 302 to return to their original form when the force applied by the valve actuator 700 is removed, thereby allowing the conduit 600 to re-open.

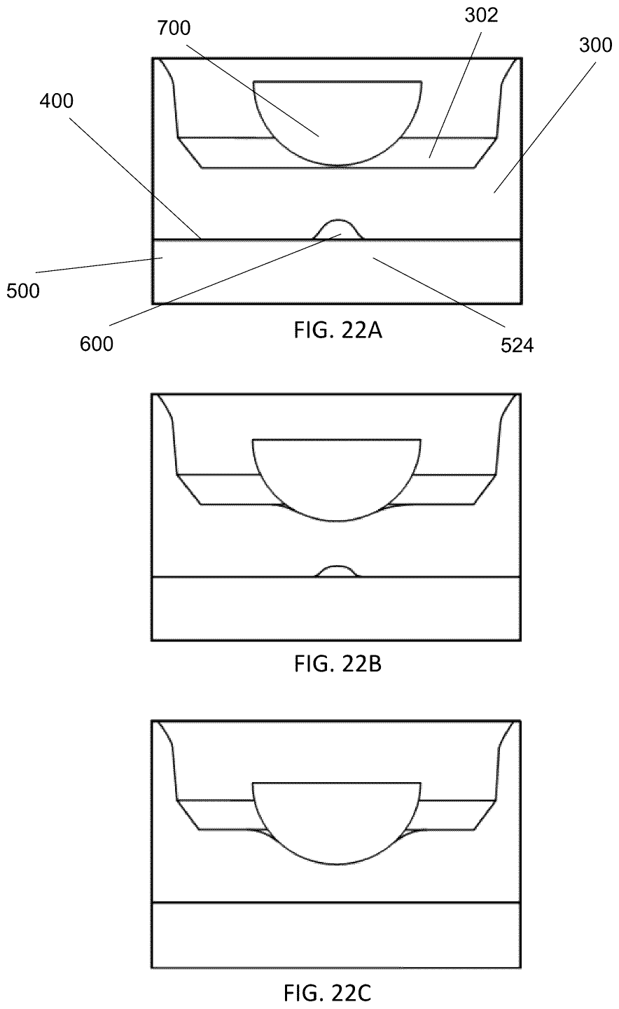

FIGS. 22A to 22C show the process of applying a force to a valve region 302 to close a corresponding conduit 600. As shown in FIG. 22A, a valve actuator 700 is initially brought into contact with the valve region 302. In the position shown in FIG. 22A, the valve actuator 700 is in a non-engaged position, in which the valve actuator 700 does not apply a force to the valve region 302 to close the corresponding conduit 600. To increase the ease of deforming the fluidic layer, the valve actuator 700 may have a rounded (e.g. hemispherical) end.

A force is then applied to the valve region 302 using the valve actuator 700. This results in compression of the fluidic layer 300 at the valve region 302, which deforms the conduit 600 to a partially closed state (FIG. 22B). In the position shown in FIG. 22B, the conduit 600 is partially closed, meaning that the valve actuator 700 is in a partially engaged position.

Continued application of the force to the valve region 302 results in further compression of the fluidic layer 300 at the valve region 302, closing the conduit 600 (FIG. 22C) against the sealing layer 400, which is supported by the corresponding valve support region 524 of the second part 500. In the position shown in FIG. 22C, the conduit 600 is fully closed, meaning that the valve actuator 700 is in an engaged position.

Given that the fluidic layer 300 is formed of an elastomeric material, the valve region 302 returns to the undepressed configuration shown in FIG. 22A when the force applied by the valve actuator 700 is removed and the valve actuator 700 is retracted to the non-engaged position shown in FIG. 22A.

FIGS. 23A and 23B schematically illustrate the compression of the pneumatic ports 312 by a pneumatic actuator 710. As explained above, the ports 312 are formed of the same material as the fluidic layer 300 (i.e. an elastomeric layer). This means that, when a force is applied to a port 312, deformation of the protrusion 314 and annular rim 320 occurs. The compliance of the elastomeric material forms a seal with the pneumatic actuator 710. Each port 312 is therefore configured to provide a seal with a pneumatic interface (such as the pneumatic actuator), as a result of being formed of an elastomeric material. Also shown schematically in FIGS. 23A and 23B is a corresponding port support 516 of the second part 500.

To improve the tolerance stack between the cartridge 100 and the analyser device in which the cartridge 100 is received, the pneumatic actuator 710 should be actuated to a position slightly below the expected position of a pneumatic sealing surface. This means that the pneumatic ports 312 should be compressed, in order to ensure sealing between the pneumatic actuators 710 and the pneumatic ports 312.

FIGS. 23A and 23B also show the frustoconical (truncated cone) shape of the protrusions 314. The frustoconical shape of the protrusions 314 provides helps formation of the seal between the pneumatic port 312 and the pneumatic actuator 710. This is because the frustoconical shape results in a narrowing of the cross-section of the protrusion 314, with increasing height above the first surface 308. Put another way, the frustoconical shape results in less material at the top of the protrusion 314 than at the base of the protrusions, owing to the angled walls provided by the frustoconical shape. The reduced cross-section at the top of the protrusion 314 means that less material is required to be deformed by the pneumatic actuator 710, in order to provide a seal around the port 312. Deforming less material means that a lower amount of force needs to be applied to compress the pneumatic port 312.

To further reduce the amount of force required to compress the pneumatic port 312, the opening 316 through the port 312 may be provided with a diameter that increases with increasing height above the second surface 310. In other words, the diameter of the opening 316 is at a minimum at the second surface 310, and is at a maximum at the top of the protrusion 314. This further reduces the amount of material at the top of the protrusion 314, resulting in a lower force being required to deform the pneumatic port 312.

The annular rim 320 further reduces the amount of force required to compress the pneumatic port 312. This is because the annular rim 320 is defined by a region in which the annular cross-section of the protrusion is further reduced. Consequently, the annular rim 320 provides a further reduction in the amount of material at the top of the protrusion 314, meaning that the force required to deform the protrusion 314 is reduced.

The annular rim 320 has a shape defined by two properties: an interior angle between the interior of the annular rim 320 and the vertical (or a line parallel to a centreline through the opening 316); and an exterior angle between the exterior of the annular rim 320 and the vertical (or a line parallel to a centreline through the opening 316). The cross-section of the protrusion 314 also has a centre of mass. In the example shown in FIG. 23A, the interior angle of the annular rim 320 is greater than the exterior angle of the annular rim 320 (as shown schematically by the dashed lines in FIG. 23A). In addition, in the example shown in FIG. 23A, the distance between the centre of mass of the protrusion 314 and the centreline through the opening 316 is less than the distance between the top of the annular rim 320 and the centreline through the opening 316. In other words, the centre of mass of the protrusion 314 is located closer to the centre of the port 312 than the top of the annular rim 320 is.

These properties of the annular rim 320 and the protrusion 314 result in the annular rim 320 and protrusion 314 bending outwards (i.e. away from the centreline through the opening 316) when a force is applied to the annular rim 320 by a pneumatic actuator 710 (as shown in FIG. 23B). The outward bending of the annular rim 320 increases the contact area between the pneumatic port 312 and the pneumatic actuator 710, which improves the seal between the pneumatic actuator 710 and the pneumatic port 312.

FIGS. 24A and 24B show an alternative implementation of the pneumatic ports 312. In the example shown in FIGS. 24A and 24B, the interior angle of the annular rim 320 is less than the exterior angle of the annular rim 320 (as shown schematically by the dashed lines in FIG. 24A). In addition, in the example shown in FIG. 24A, the centre of mass of the cross-section of the protrusion 314 is located further from the centreline through the opening 316 than in the example shown in FIGS. 23A and 23B. In effect, this means that less material of the protrusion 314 lies inside a boundary defined by the annular rim 320. By reducing the amount of material of the protrusion 314 within the boundary defined by the annular rim 320 and implementing a smaller interior angle, the protrusion 314 and annular rim 320 bend inwards when a force is applied to the annular rim 320 by a pneumatic actuator 710 (as shown in FIG. 24B).

The inward bending of the annular rim 320 increases the contact area between the pneumatic port 312 and the pneumatic actuator 710 (as with the example shown in FIGS. 23A and 23B). However, the implementation shown in FIGS. 24A and 24B also reduces the diameter of the annular rim 320 when compressed by the pneumatic actuator 710. This means that the compressed annular rim 320 can be contained within the footprint of the pneumatic actuator 710, even if there is a degree of misalignment between the pneumatic actuator 710 and the pneumatic port 312 (as shown in FIG. 24B).

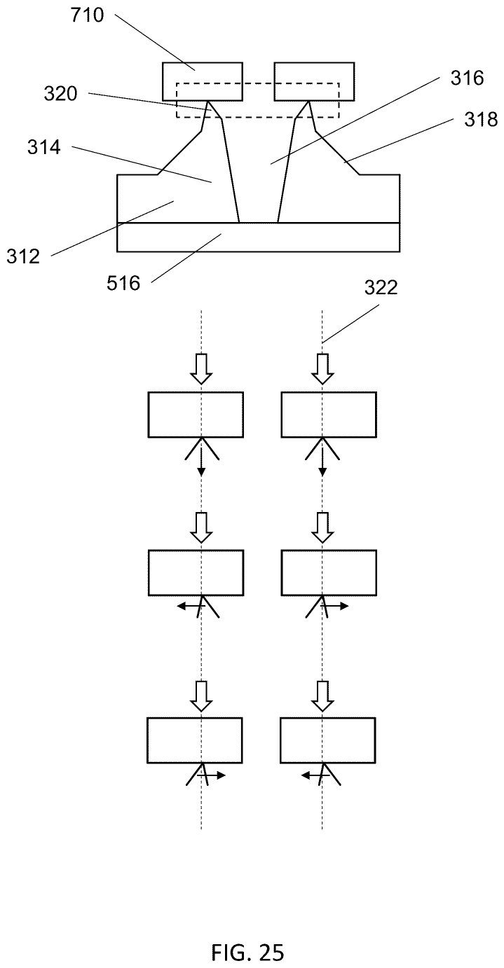

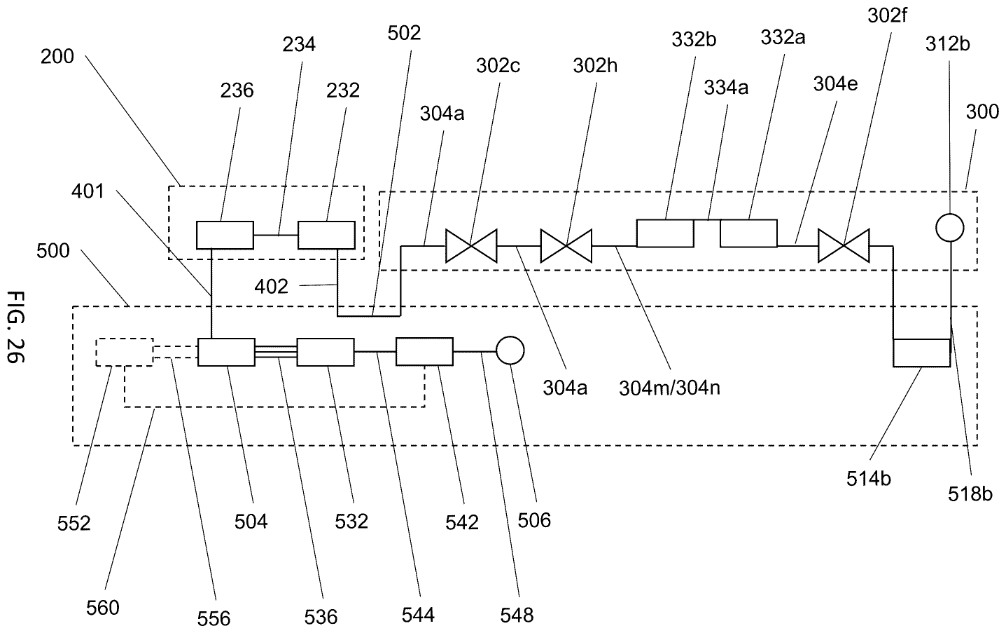

The effect of the interior and exterior angles of the annular rim 320 on compression of the pneumatic port 312 is illustrated schematically in FIG. 25. These schematic illustrations ignore effects associated with the centre of mass of the protrusion section, and instead show the effects of varying the shape of the annular rim 320.

In the top diagram in FIG. 25, the interior and exterior angles of the annular rim 320 are equal. This means that the bulk of material on either side of a vertical line 322 (i.e. a line parallel to the direction of applied force) through the top of the annular rim 320 is equal. When a force is applied to the annular rim 320, the equal bulk of material on either side of the line 322 results in the annular rim 320 being compressed without bending inwards or outwards.

In the middle diagram in FIG. 25, the interior angle of the annular rim 320 is greater than the exterior angle of the annular rim 320. This means that the bulk of material on the interior side of the line 322 exceeds the bulk of material on the exterior side of the line 322. When a force is applied to the annular rim 320, the lower bulk of material on the exterior side of the line 322 results in the annular rim 320 bending outwards (e.g. as in FIG. 23B).

In the bottom diagram in FIG. 25, the interior angle of the annular rim 320 is less than the exterior angle of the annular rim 320. This means that the bulk of material on the exterior side of the line 322 exceeds the bulk of material on the interior side of the line 322. When a force is applied to the annular rim 320, the lower bulk of material on the interior side of the line 322 results in the annular rim 320 bending inwards (e.g. as in FIG. 24B).

FIGS. 26 to 30 show fluidic circuits that may be implemented using the cartridge 100 described above. In the circuits shown in FIGS. 26 to 30, rectangles represent chambers, wells or liquid storage capsules, lines represent conduits or channels, valve regions are indicated using two adjacent triangles, and openings in the fluidic circuit (e.g. ports, vents) are represented by circles.

FIG. 26 is a first fluidic circuit showing the fluidic components used for aspiration of a liquid sample from the metering chamber 232 into one of the chambers 332. FIG. 26 schematically illustrates the first part 200, the second part 500, and the fluidic layer 300. The main fluidic components of the circuit are also shown in FIG. 26. For simplicity, the sealing layer 400 is not shown schematically in FIG. 26. FIG. 26 schematically shows which fluidic components belong to the fluidic layer 300, the first part 200 and the second part 500.

To aspirate a liquid sample from the metering chamber 232 into the second chamber 332b in the fluidic layer 300 (e.g. for dilution or mixing), a negative pressure may be applied to the second pneumatic port 312b. The sample is aspirated via channels 304a, 304n and 304m, meaning that valve regions 302c and 302h are not depressed (i.e. not actuated).

The sample is aspirated from the metering chamber 232 in the first part 200 via the following sequence of fluidic components: the metering chamber 232, the hole 402 in the sealing layer, the metering chamber outlet channel 502 in the second part 500, the first channel 304a in the fluidic layer 300 (i.e. with third valve region 302c undepressed), the fourteenth channel 304n in the fluidic layer 300 (i.e. with eighth valve region 302h undepressed), the thirteenth channel 304m in the fluidic layer 300, and the second chamber 332b in the fluidic layer 300.

To aspirate the sample in this way, a negative pressure is applied to the first chamber 332a via the following sequence of fluidic components: the second pneumatic port 312b, the second channel 518b in the second port support 516b, the second trough 514b in the second part 500, the fifth channel 304e in the fluidic layer 300 (with sixth valve region 302f undepressed), the first chamber 332a in the fluidic layer 300, the opening 334a between the first chamber 332a and second chamber 332b, and the second chamber 332b.

It will be appreciated that in order for the sample to move downstream from the metering chamber 232 to the second chamber 332b, there must be a vent upstream of the metering chamber 232. This is to prevent formation of a vacuum when liquid is moved downstream from the metering chamber 232.

As mentioned above, the vent is a permanent vent 506 in the second part 500, which is provided in the form of a hole in the second part 500 (as shown in FIG. 12). The metering chamber 232 is therefore vented via one of the following sequences of fluidic components: (i) the permanent vent 506, the vent channel 548, the third well 542, the first connector channel 544, the first plurality of grooves 536, the first well 504 (defining the sample waste chamber), the waste outlet 401 in the sealing layer 400, the sample adequacy control chamber 236, the connector channel 234 in the first part 200, and the metering chamber 232; or (ii) the permanent vent 506, the vent channel 548, the third well 542, the second connector channel 560, the second plurality of grooves 556, the first well 504, the waste outlet 401, the sample adequacy control chamber 236, the connector channel 234, and the metering chamber 232.

It is important to prevent escape of the liquid sample from the cartridge 100, in order to prevent contamination. Therefore, the liquid sample should be discouraged from flowing out of the permanent vent 506, even when the cartridge 100 is disturbed or shaken. To reduce the tendency for liquid sample to flow out of the permanent vent 506, a narrow vent channel 548 is employed, as shown in FIG. 12. Using a narrow cross-section for the vent channel 548 increases the hydraulic resistance of the vent channel 548, discouraging fluid flow through it.

To further discourage the flow of sample through the permanent vent 506, a second narrow channel (i.e. the first connector channel 544) is also implemented. The first connector channel 544 provides fluidic communication between the third well 542 (to which the vent channel 548 connects) and the second well 532. Accordingly, the liquid sample is faced with two narrow channels in series, each of which contributes to increasing the hydraulic resistance of the flow path to the permanent vent 506.

In order to reduce the likelihood of a liquid blockage, the plurality of grooves 536 is provided between the first well 504 and the second well 532. By more than one path for liquid flow between the first well 504 and the second well 532, the likelihood of a liquid blockage between the first well 504 and the second well 532 is reduced. For example, if the probability of liquid blocking one of the grooves is 1/x, then by providing two grooves, the probability of a liquid blockage is reduced to 1/x². Moreover, by providing three grooves, the probability is reduced to 1/x³.

Each of the plurality of grooves 536 also includes an angled base 538, sloping towards the first well 504. This means that, even if liquid flows into one of the grooves 536, the pressure required to clear liquid from the groove 536 is reduced. This is because the angled base 538 of the groove 536 causes liquid to flow towards the first well 504 under gravity.

Liquid flow into the plurality of grooves 536 is also discouraged because the base 538 of each groove 536 is disposed above the base of the first well 504, in use. This means that liquid is required to flow over a step between the base of the first well 504 and the base of the groove 538. Likewise, the base of the first connector channel 544 is provided above the base of the second well 532 in use, meaning that liquid is required to flow over a step between the second well 532 and the first connector channel 544. A similar step may be provided between the third well 542 and the vent channel 548.

In order to minimise the overall volume of the cartridge 100, the first well 504 may be relatively shallow (i.e. have low depth), resulting in a small cross-sectional area of the sample waste chamber. The low depth of the first well 504 may result in a plug of liquid within the sample waste chamber (i.e. a volume of liquid filling the cross-sectional area of the sample waste chamber). Such a plug of liquid in the sample waste chamber increases the pressure required to aspirate the liquid sample from the metering chamber 232.

In order to reduce the pressure required to aspirate the liquid sample from the metering chamber 232, an alternative flow path between the first well 504 and the permanent vent 506 may optionally be provided. The components of this optional alternative flow path are shown in dotted lines in FIG. 26. Specifically, the optional alternative flow path comprises the second plurality of grooves 556, the fourth well 552, and the second connector channel 560 connecting the fourth well 552 to the third well 542.

Providing the alternative flow path means that there are two flow paths between the first well 504 and the permanent vent 506: (i) a first flow path via the first plurality of grooves 536, the second well 532, the first connector channel 544, the third well 542, and the vent channel 548; and (ii) a second flow path via the second plurality of grooves 556, the fourth well 552, the second connector channel 560, the third well 542, and the vent channel 548.

The second flow path provides an alternative flow path in the event that there is a plug of liquid in the sample waste chamber defined by the first well 504 (i.e. between the waste outlet 401 and the first plurality of grooves 536), or in the event that all of the first plurality of grooves 536 are blocked. Likewise, the first flow path also acts an alternative flow path to the second flow path, in the event that there is a plug of liquid between the waste outlet 401 and the second plurality of grooves 556, or in the event that the second plurality of grooves 556 are blocked.

In order to discourage liquid flow through the permanent vent 506, the second connector channel 560 has a narrow cross-section, in order to increase its hydraulic resistance. As shown in FIG. 12, the second connector channel 560 is longer than the first connector channel 544, which further increases the hydraulic resistance of the second connector channel 560 relative to the first connector channel 544.

The second plurality of grooves 556 is provided to reduce the likelihood of a liquid blockage in the second connector channel 560. Again, by providing more than one path for liquid flow between the first well 504 and the fourth well 552, the likelihood of a liquid blockage between the first well 504 and the fourth well 552 is reduced. The angled base 558 of the grooves 556 also reduces the pressure required to clear liquid from the grooves 556 in the event of a blockage, because the angled base 558 encourages liquid flow into the first well 504 under gravity.

The base 558 of the grooves 556 is located above the base 530 of the first well 504 in use, meaning that liquid is required to overcome a step between the base 530 of the first well 504 and the base 558 of each groove 556, which further discourages liquid flow into the grooves 556.

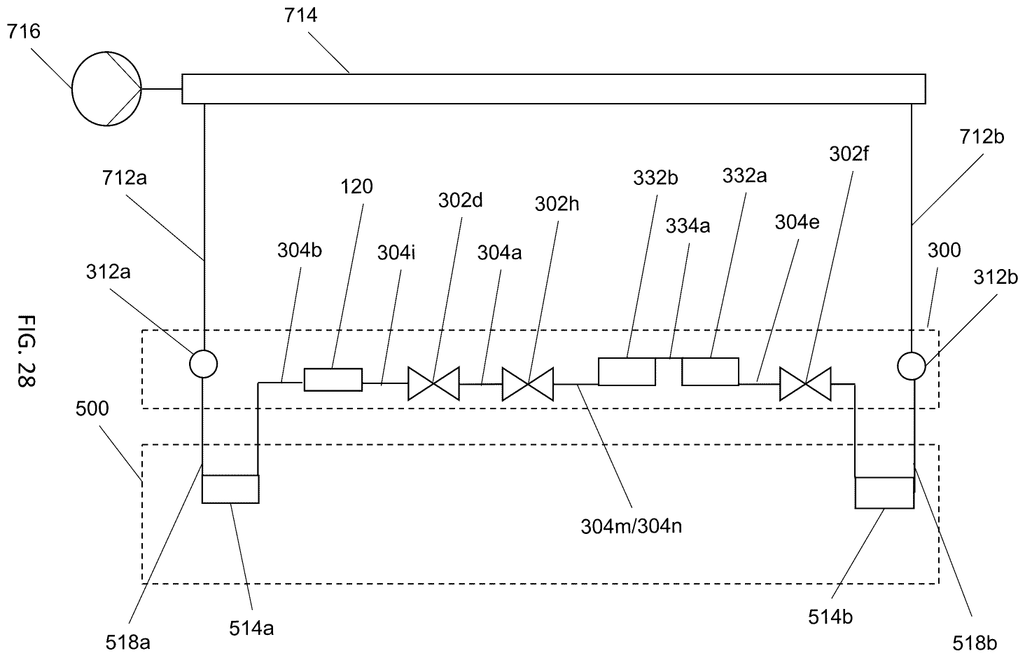

The fluidic circuits illustrated in FIGS. 27 and 28 show a pump 716 connected to a pump manifold 714. A plurality of pneumatic supply conduits 712 are connected to the pump manifold 714. The pump 716, pump manifold 714, and pneumatic supply conduits 712 are all components of a pneumatic pressure supply system included in an analyser device in which the cartridge 100 is received.

The pump manifold 714 includes a number of valves that control the application of pressure through the pneumatic supply conduits 712. Specifically, the valves in the manifold 714 permit a positive or negative pressure to be applied to each of the pneumatic supply conduits 712, permit each of the pneumatic supply conduits 712 to be open to atmospheric pressure (i.e. vented), or permit each of the pneumatic supply conduits 712 to close (i.e. block) a corresponding pneumatic port 312. Venting of the pneumatic supply conduits 712 may also be achieved using a vent in the pump manifold 714. The pneumatic pressure supply system may include three pneumatic supply conduits 712, corresponding to the three pneumatic ports 312 of the cartridge 100.

FIGS. 27 and 28 schematically show which fluidic components belong to the fluidic layer 300 and which fluidic components belong to the second part 500.

The fluidic circuits illustrated in FIGS. 27 and 28 show how the movement of liquid in a fluidic network can be controlled by using multiple pneumatic ports. By using multiple pneumatic ports, the need for permanent vents in the cartridge 100 is reduced (aside from the permanent vent 506 used for aspiration of the sample). Accordingly, the potential for liquids to escape from the cartridge 100 is reduced. Specifically, the fluidic circuit may be vented via a waste chamber 508 in the second part 500 (e.g. as illustrated in FIG. 27) or via a mixing chamber in the fluidic layer 300 (e.g. as illustrated in FIG. 28). In the examples shown in FIGS. 27 and 28, a first one of the pneumatic ports 312 (i.e. the first pneumatic port 312a) is in fluidic communication with a conduit 600 (e.g. the conduit defined by the first channel 304a), while a second one of the pneumatic ports 312 (i.e. the second pneumatic port 312b) is in fluidic communication with a chamber (e.g. a measurement chamber 610, or one of the chambers 332 in the projection 330).

FIG. 27 is a fluidic circuit that schematically illustrates dispense of a liquid reagent from a liquid storage capsule 120 to a measurement chamber 610. To dispense liquid reagent to the measurement chamber 610, a positive pressure is applied to the first pneumatic port 312a via a first pneumatic supply conduit 712a, while the second pneumatic port 312b is vented using a second pneumatic supply conduit 712b. The positive pressure is applied after the liquid storage capsule 120 has been punctured (e.g. using the actuatable portion 240 of the first part 200).

Application of a positive pressure via the first pneumatic port 312a results in a positive pressure being applied to the liquid in the liquid storage capsule 120 via the following sequence of fluidic components: the channel 518a in the first port support 516a in the second part 500, the first trough 514a in the second part 500, and the second channel 304b in the fluidic layer 300.

The liquid storage capsule 120 is in fluidic communication with the measurement chamber 610 via the following sequence of fluidic components: the ninth channel 304i in the fluidic layer 300 (with fourth valve region 302d undepressed), and the first channel 304a in the fluidic layer 300. As described above, the measurement chamber 610 may be defined in part by apertures 142 in a flow cell strip 140 accessed through vias 404 in the sealing layer 400, or may be defined in part by apertures 454 in an alternative sealing layer 450.

A build-up of positive pressure in the fluidic circuit is prevented by venting the measurement chamber 610 via the following sequence of fluidic components: the fifteenth channel 304o in the fluidic layer 300 (with twelfth valve region 302l undepressed), the second waste chamber 508b in the second part 500, the transverse channel 512 in the second part 500, the longitudinal channel 522 in the second part 500, the second trough 514b in the second part, the channel 518b in the second pump support 516b of the second part 500, and the second pneumatic port 312b.

FIG. 28 is a fluidic circuit that schematically illustrates dispense of a liquid reagent from a liquid storage capsule 120 to the second chamber 332b in the fluidic layer 330 (which may, for example, be used as a mixing chamber). To dispense liquid reagent to the second chamber 332b, a positive pressure is applied to the first pneumatic port 312a via a first pneumatic supply conduit 712a, while the second pneumatic port 312b is vented using a second pneumatic supply conduit 712b. The positive pressure is applied after the liquid storage capsule 120 has been punctured (e.g. using the actuatable portion 240 of the first part 200).

Application of a positive pressure via the first pneumatic port 312a results in a positive pressure being applied to the liquid in the liquid storage capsule 120 via the following sequence of fluidic components: the channel 518a in the first port support 516a in the second part 500, the first trough 514a in the second part 500, and the second channel 304b in the fluidic layer 300.

The liquid storage capsule 120 is in fluidic communication with the second chamber 332b via the following sequence of fluidic components: the ninth channel 304i in the fluidic layer 300 (with fourth valve region 302d undepressed), the first channel 304a in the fluidic layer 300, and the thirteenth and fourteenth channels 304m/304n in the fluidic layer 300 (with eighth valve region 302h undepressed).

A build-up of positive pressure in the fluidic circuit is prevented by venting the second chamber 332b via the following sequence of fluidic components: the opening 334a connecting the first chamber 332a to the second chamber 332b, the first chamber 332a, the fifth channel 304e in the fluidic layer (with sixth valve region 302f undepressed), the second trough 514b in the second part 500, the channel 518b in the second pump support 516b of the second part 500, and the second pneumatic port 312b.

FIGS. 27 and 28 both illustrate how liquid can be moved out of a liquid storage capsule 120 into another component of the fluidic network by using multiple pneumatic ports 312. It will be appreciated that the pneumatic ports 312 can similarly be used to transfer liquid from the chambers 332 to other fluidic components. For example, the ports 312 may be used to transfer liquid from one of the chambers 332 to a measurement chamber 610 (e.g. after liquid has been moved from a liquid storage capsule 120 to the second chamber 332b, as shown in FIG. 28). As another example, the ports 312 may be used to transfer liquid back and forth between the second chamber 332b and the third chamber 332c. This is achieved by applying a positive (or negative) pressure via a first one of the ports 312, and by venting another one of the ports 312.

Specifically, the fluidic layer 300 described above allows at least the fluidic operations described in the following paragraphs to be carried out.

A liquid may be dispensed into a chamber, such as a waste chamber 508, a measurement chamber 610, or a mixing chamber 332. This may be achieved by supplying a positive pressure to a first one of the pneumatic ports 312 (e.g. the first pneumatic port 312a or the third pneumatic port 312c), while a second one of the pneumatic ports 312 is vented (e.g. the second pneumatic port 312b or the third pneumatic port 312c).

For example, referring to FIG. 17B, a diluent may be dispensed from a liquid storage capsule 120 to the third chamber 332c (used in this example as a mixing chamber). Specifically, a positive pressure is applied to a liquid storage capsule 120 disposed over openings 350c and 350d by applying a positive pressure via the first pneumatic port 312a. The positive pressure is applied via second channel 304b. With valve regions 302d, 302h and 302k undepressed (and all other valve regions 302 depressed), the diluent flows through channels 304i, 304a, 304n and 304m to third chamber 332c. The third pneumatic port 312c is vented, meaning that the third chamber 332c is vented via opening 334b, fourth chamber 332d, seventh channel 304g, and the third pneumatic port 312c.

As another example, a solution may be dispensed from the third chamber 332c to a measurement chamber 610. Specifically, a positive pressure is applied to the liquid in the third chamber 332c by applying a positive pressure via the third pneumatic port 312c. The positive pressure is applied via seventh channel 304g with eleventh valve region 302k undepressed. With valve regions 302i, 302j and 302k undepressed (and all other valve regions 302 depressed), the solution flows through thirteenth channel 304m, second chamber 332b, and nineteenth channel 304s, and into the measurement chamber 610 connected to the seventeenth channel 304q and the nineteenth channel 304s. The second pneumatic port 312b is vented, meaning that this measurement chamber 610 is vented via the seventeenth channel 304q, the eighteenth channel 304r, the first waste chamber 508a, channels 512 and 522, and the second pneumatic port 312b. Continued positive pressure forces the solution out of the measurement chamber 610 through channels 304q and 304r and into the first waste chamber 508a, which is vented by the second pneumatic port 312b.

A sample may be aspirated from the metering chamber 232 into a measurement chamber 610. Specifically, a negative pressure is applied to the second pneumatic port 312b, with valve regions 302c and 302l undepressed (and all other valve regions 302 depressed). The negative pressure is applied to the sample in the metering chamber 232 via the following sequence of fluidic components: channels 512 and 522 in the second part, the second waste chamber 508b, the fifteenth channel 304o, the measurement chamber 610 connected to channels 304a and 304o, and the first channel 304a. It will be recalled that the first channel 304a is in fluidic communication with the sample in the metering chamber 232, which is in turn in fluidic communication with the permanent vent 506.

Accordingly, the negative pressure applied via the second pneumatic port 312b aspirates the sample to the measurement chamber 610 in fluidic communication with channels 304a and 304o.

A sample may also be aspirated into the third chamber 332c (e.g. to meter the sample as discussed in relation to FIGS. 17A and 17B). Specifically, a negative pressure is applied to the third pneumatic port 312c, with valve regions 302c, 302h and 302k undepressed (and all other valve regions 302 depressed). The negative pressure is applied to the sample via seventh channel 304g, fourth chamber 332d, opening 334b, third chamber 332c, and channels 304m, 304n and 304a. The negative pressure applied via the third pneumatic port 312c therefore aspirates the sample from the metering chamber 232 (vented by the permanent vent 506) to the third chamber 332c.

In addition, a solution may be mixed between chambers 332b and 332c (used in this example as mixing chambers). This may be achieved by aspirating the solution from the second chamber 332b to the third chamber 332c and subsequently dispensing the solution to the third chamber 332c to the second chamber 332b. These steps may then be repeated in order to further mix the solution.

To aspirate the solution from the second chamber 332b to the third chamber 332c, a negative pressure may be applied to the third pneumatic port 312c with the second pneumatic port 312b vented, and with valve regions 302f and 302k undepressed (and all other valve regions depressed). The negative pressure is applied to the solution in the second chamber 332b via seventh channel 304g, fourth chamber 332d, opening 334b, third chamber 332c, and thirteenth channel 304m. The second chamber 332b is vented via fifth channel 304e and the second pneumatic port 312b. To dispense the solution from third chamber 332c to second chamber 332b, a positive pressure may then be applied to the third pneumatic port 312c with the second pneumatic port 312b vented, and with the same combination of valve regions 302 depressed.

Further, any solution in a measurement chamber 610 may be cleared using air supplied via one of the pneumatic ports 312. Specifically, any solution in the measurement chamber 610 in fluidic communication with channels 304q and 304s and in the measurement chamber 610 in fluidic communication with channels 304p and 304q may be cleared by applying a positive pressure via the first pneumatic port 312a with the second pneumatic port 312b vented. The flow cells are cleared with valve regions 302b, 302i and 302l undepressed (and all other valve regions depressed).

Specifically, the positive pneumatic pressure provides air flow through fourth channel 304d, nineteenth channel 304s, the measurement chamber 610 in fluidic communication with channels 304s and 304q, seventeenth channel 304q, the measurement chamber 610 in fluidic communication with channels 304p and 304q, sixteenth channel 304p, the second waste chamber 508b, channels 512 and 522, and the second pneumatic port 312b. This allows the two measurement chambers 610 to be cleared.

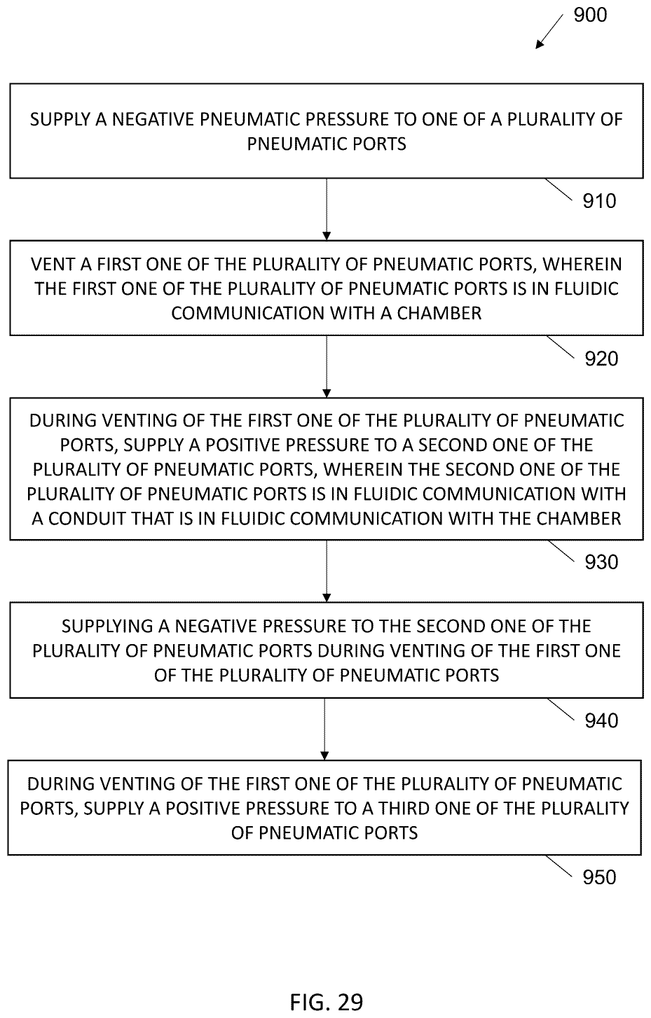

FIG. 29 is a flowchart of a method 900 of moving liquid in a liquid handling device (e.g. cartridge 100) comprising a fluidic network comprising a plurality of conduits 600 and a chamber (e.g. measurement chambers 610, chambers 332, waste chambers 508). The liquid handling device comprises a plurality of pneumatic ports 312 in fluidic communication with the fluidic network.

The method 900 is applicable to various stages of various fluidic workflows that may be implemented with the fluidic layer 300 described above. Listed below are examples of liquid movement that may be achieved using the fluidic layer 300 and the method 900. It will be appreciated that the steps of the flowchart described below may be carried in any order (and not necessarily the order described below), depending on the fluidic workflow being implemented.

At 910, the method optionally may comprise supplying a negative pneumatic pressure to one of the plurality of pneumatic ports 312, to aspirate liquid from a sample inlet chamber (e.g. metering chamber 232) to the fluidic network.

For example, a negative pressure may be supplied to the second pneumatic port 312b, which is in fluidic communication with the measurement chamber 610 in fluidic communication with channels 304a and 304o via channel 304o (with twelfth valve region 302l undepressed) and fluidic components in the second part 500. This measurement chamber 610 is in fluidic communication with the sample inlet chamber via first channel 304a with third valve region 302c undepressed. The negative pressure supplied to the second pneumatic port 312b aspirates liquid into the measurement chamber 610.

As another example, a negative pressure may be supplied to the third pneumatic port 312c, which is in fluidic communication with the third chamber 332c via seventh channel 304g (with eleventh valve region 302k undepressed). The third chamber 332c is in fluidic communication with the sample inlet chamber via channels 304m, 304n and 304a, with valve regions 302c and 302h undepressed). The negative pressure supplied to the third pneumatic port 312c aspirates liquid into the third chamber 332c.

At 920, a first one of the plurality of pneumatic ports 312 is vented. The first one of the plurality of pneumatic ports 312 is in fluidic communication with a chamber.

At 930, during venting of the first one of the plurality of pneumatic ports 312, a positive pressure is supplied to a second one of the plurality of pneumatic ports 312. The second one of the plurality of pneumatic ports 312 is in fluidic communication with a conduit 600 that is in fluidic communication with the chamber. Supplying the positive pressure to the second one of the plurality of pneumatic ports during venting of the first one of the pneumatic ports 312 dispenses liquid from the conduit 600 to the chamber.

For example, the chamber may be the third chamber 332c, the third pneumatic port 312c may be in fluidic communication with the third chamber 332c via undepressed eleventh valve region 302k, and the third pneumatic port 312c may be vented. In this example, the first pneumatic port 312a may be in fluidic communication with the conduit 600 defined by ninth channel 304i via undepressed fourth valve region 302d, the ninth channel 304i may be in fluidic communication with the third chamber 332c via undepressed eighth valve region 302h, and a positive pressure may be applied to the first pneumatic port 312a. This dispenses liquid from a liquid storage capsule 120 to the third chamber 332c.

As another example, the chamber may be a measurement chamber 610 (i.e. in fluidic communication with channels 304q and 304s), the second pneumatic port 312b may be in fluidic communication with the measurement chamber 610 via undepressed tenth valve region 302j and fluidic components (waste chamber 508a, channels 512, 522) in the second part 500, and the second pneumatic port 312b may be vented. In this example, the third pneumatic port 312c may be in fluidic communication with the conduit 600 defined by seventh channel 304g via undepressed eleventh valve region 302k, the seventh channel 304g may be in fluidic communication with the measurement chamber 610 via undepressed ninth valve region 302i, and a positive pressure may be applied to the third pneumatic port 312c. This dispenses liquid from a chamber 332b/332c to the measurement chamber 610 in fluidic communication with channels 304q and 304s. In this example, the method may further comprise continuing to apply a positive pressure to the third pneumatic port 312c with the second pneumatic port 312b vented, to move liquid from the measurement chamber 610 to the waste chamber 508a.

As a yet further example, the chamber may be the second chamber 332b, the second pneumatic port 312b may be in fluidic communication with the second chamber 332b via undepressed sixth valve region 302f, and the second pneumatic port 312b may be vented. In this example, the third pneumatic port 312c may be in fluidic communication with the conduit 600 defined by thirteenth channel 304m via undepressed eleventh valve region 302k, and a positive pressure may be supplied via the third pneumatic port 312c. This dispenses liquid from the third chamber 332c through the thirteenth channel 304m to the second chamber 332b. In this example, the second chamber 332b acts as a first mixing chamber, and the third chamber 332c acts as a second mixing chamber. Accordingly, the positive pressure from the third pneumatic port 312c is applied to any liquid in the third chamber 332c, meaning that liquid is dispensed from the third chamber 332c to the second chamber 332b. As the second chamber 332b acts as a first mixing chamber and the third chamber 332c acts as a second mixing chamber, this means that liquid is dispensed from the first mixing chamber to the second mixing chamber.

At 940, if the chamber is the second chamber 332b being used as a mixing chamber, the method may optionally further comprise, after dispense of liquid from the third chamber 332c to the second chamber 332b, supplying a negative pressure to the second one of the plurality of pneumatic ports 312 during venting of the first one of the plurality of pneumatic ports 312, to aspirate liquid from the second chamber 332b to the third chamber 332c. Accordingly, at 940, liquid is aspirated from the first mixing chamber to the second mixing chamber.

For example, a negative pressure may be supplied to the third pneumatic port 312c with the second pneumatic port 312b vented and valve regions 302f and 302k undepressed, in order to aspirate liquid from the second chamber 332b to the third chamber 332c.

At 950, the method may optionally further comprise, during venting of the first one of the plurality of pneumatic ports 312, supplying a positive pressure to a third one of the plurality of pneumatic ports 312. A negative pressure may subsequently, or alternatively, be supplied to the third one of the plurality of pneumatic ports 312.

For example, 920 and 930 may involve the movement of liquid out of one of the liquid storage capsules 120b using a positive pressure from the third pneumatic port 312c with the second pneumatic port 312b vented. The liquid from the liquid storage capsule 120b may be moved to a measurement chamber 610 (e.g. via eleventh channel 304k or twelfth channel 304l (depending on the capsule 120b), fourth channel 304d and nineteenth channel 304s).

Then, at 950, the method may comprise clearing the measurement chamber(s) 610 by supplying a positive pressure to the first pneumatic port 312a, with the second pneumatic port 312b vented. This supplies air to the measurement chamber(s) 610 via fourth channel 304d, to clear the fluidic circuit through the measurement chamber(s).

As another example, 920 and 930 may comprise clearing the measurement chamber 610 using a positive pressure from the first pneumatic port 312a with the second pneumatic port 312b vented. The liquid from the measurement chamber 610 is moved to a waste chamber 508.

Then, at 950, the method may comprise dispensing liquid from one of the liquid storage capsules 120b to the measurement chamber 610 by supplying a positive pressure to the third pneumatic port 312c, with the second pneumatic port 312b vented. This pushes liquid from the liquid storage capsule 120b to the measurement chamber 610 (e.g. via eleventh channel 304k or twelfth channel 304l (depending on the capsule 120b), fourth channel 304d and nineteenth channel 304s).

The skilled person will appreciate that the method 900 described above is applicable to additional fluidic workflows that may be implemented using the fluidic layer 300, beyond those described in the above examples. Accordingly, the method 900 is not limited to the specific examples described in the above examples.

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

As used herein, the term “channel” refers to a groove provided in a surface, with an open cross-section (i.e. the cross-section is not sealed). As used herein, the term “conduit” refers to (i) a channel that has been sealed (e.g. by a sealing layer), thereby providing a closed cross-section; or (ii) a hole or tunnel extending at least partially through a body.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

1. A liquid handling device, comprising:
a rigid layer comprising a first well and a second well;
a vent arranged to provide a fluidic connection to an exterior of the liquid handling device, wherein the second well is in fluidic communication with the vent; and
a plurality of grooves extending between the first well and the second well, wherein each of the plurality of grooves provides a fluidic connection between the first well and the second well.

2. A liquid handling device according to claim 1, wherein one or more of the plurality of grooves is disposed above a base of the first well.

3. A liquid handling device according to claim 2, wherein the depth of the first well is greater than the maximum depth of the one or more of the plurality of grooves.

4. A liquid handling device according to any of claims 1 to 3, wherein the one or more of the plurality of grooves is disposed above a base of the second well.

5. A liquid handling device according to claim 4, wherein the depth of the second well is greater than the maximum depth of the one or more of the plurality of grooves.

6. A liquid handling device according to any of claims 1 to 5, wherein one or more of the plurality of grooves comprises:
a first end adjacent to the first well; and
a second end adjacent to the second well, wherein the second end is disposed above the first end.

7. A liquid handling device according to claim 6, wherein the depth of the first end is greater than the depth of the second end.

8. A liquid handling device according to claim 6 or claim 7, wherein the one or more of the plurality of grooves comprises an angled base extending between the first end and the second end.

9. A liquid handling device according to any of claims 1 to 8, further comprising:
a third well in fluidic communication with the second well and the vent, wherein the second well is in fluidic communication with the vent via the third well; and
a connector channel extending between the second well and the third well.

10. A liquid handling device according to claim 9, wherein the connector channel is disposed above a base of the second well.

11. A liquid handling device according to claim 9 or claim 10, wherein the depth of the second well is greater than the depth of the connector channel.

12. A liquid handling device according to any of claims 9 to 11, further comprising a vent channel extending from the third well, wherein the third well is in fluidic communication with the vent via the vent channel.

13. A liquid handling device according to claim 12, wherein the vent channel comprises:
a first end in fluidic communication with the third well; and
a second end in fluidic communication with the vent, wherein the vent comprises a hole in the rigid layer.

14. A liquid handling device according to claim 13, wherein:
the vent channel extends from the third well in a first direction;
the hole extends in a second direction through the rigid layer to an exterior surface of the rigid layer; and
the second direction is different to the first direction.

15. A liquid handling device according to claim 14, wherein the second direction is perpendicular to the first direction.

16. A liquid handling device according to any of claims 9 to 11, further comprising a vent channel extending between the third well and the vent.

17. A liquid handling device according to claim 16, wherein the vent channel comprises:
a first end in fluidic communication with the third well; and
a second end in fluidic communication with the vent, wherein the vent comprises a hole in the rigid layer at the second end of the vent channel.

18. A liquid handling device according to any of claims 1 to 17, wherein the plurality of grooves is a first plurality of grooves, and wherein the liquid handling device further comprises:
a fourth well in fluidic communication with the first well; and
a second plurality of grooves extending between the fourth well and the first well, wherein each of the second plurality of grooves provides a fluidic connection between the fourth well and the first well.

19. A liquid handling device according to claim 18 when dependent on claim 9, wherein the connector channel is a first connector channel, and wherein the liquid handling device further comprises:
a second connector channel extending from the fourth well, wherein fourth well is in fluidic communication with the vent via the second connector channel.

20. A liquid handling device according to claim 18 when dependent on claim 9, wherein the connector channel is a first connector channel, and wherein the liquid handling device further comprises:
a second connector channel extending between the fourth well and the third well.

21. A liquid handling device according to any of claims 1 to 20, wherein the liquid handling device is a diagnostic cartridge.

22. A liquid handling device according to claim 21, wherein the diagnostic cartridge is a microfluidic cartridge.
